(19) United States
(12) Patent Application Publication
(10) Pub. No.: US 2014/0222553 A1
(43) Pub. Date: Aug. 7, 2014

(54) Dynamic Website Campaign Builder for Merchandising

(71) Applicant: William Bowman, Arlington, MA (US)

(72) Inventor: William Bowman, Arlington, MA (US)

(21) Appl. No.: 14/176,039

(22) Filed: Feb. 7, 2014

Related U.S. Application Data
(60) Provisional application No. 61/762,297, filed on Feb. 7, 2013.

(51) Int. Cl. G06Q 30/02

(52) U.S. Cl. CPC G06Q 30/0276
USPC 705/14.45; 705/14.72; 705/14.41

(57) ABSTRACT

Dynamic website Campaign builder software for enabling merchandising via the Internet. The Campaign builder software has an application programming interface for display on programming computing devices with display screens to permit building a Campaign. Plural Campaign templates are retained in electronic memory, and an insertion mechanism, such as a Destination Script or an iFrame, permits insertion of assets into the Campaign template to create Campaigns. A saving mechanism permits selective saving of Campaigns, and a publishing mechanism permits selective publication of Campaigns, including with fixed width and responsive design templates. A recipient user interface is operative on recipient computing devices with display screens to permit viewing and usage of published Campaigns. Campaigns are saved to content delivery network (CDN) Media Cloud Server storage for rapid CDN publishing. A linking mechanism permits a linking of Campaigns to an Analytic program for harvesting and analysis of user interaction and Ecommerce data.

### FIELD OF THE INVENTION

The present invention relates generally to electronic commerce. More particularly, disclosed herein is a dynamic website Campaign builder for merchandising on websites and Social Media Sites.

### BACKGROUND OF THE INVENTION

Ecommerce platforms of the prior art focus on transactions and fulfillment. However, they lack content management and responsive merchandising. Historically, Ecommerce platforms often dictate valuable merchandising opportunities into a lower priority with an inadequate customer experience. Over time, it is discovered that well performing Ecommerce platforms result in plateaued revenue, only focusing on transactions, not addressing missed customer engagement merchandising opportunities.

The present invention was created in direct response to the pain points experienced by the inventor while working with Ecommerce retailers over the past fifteen years. While the inventor has worked with a variety of platforms that have provided outstanding functionality for transaction processing and fulfillment, clients often struggled to use the platforms for more sophisticated merchandising, promotions, and content management. The inventor worked with clients to overcome these challenges and soon appreciated that the need for simplified Campaign creation and management was widespread and that clients often struggled to find the budget to meet this need with consulting resources.

In view of the foregoing, the inventor recognized the need for a website Campaign builder capable of delivering on the promise of rapid, relevant marketing for retailers in a tool specifically designed for retail workflow. The inventor recognized the further need for a dynamic Campaign builder capable of enabling retailers to rapidly create and publish merchandising and promotional Campaigns that are both visually compelling and infused with rich media. Still further, the inventor recognized that it would be ideal for such a dynamic Campaign builder to be platform agnostic and easily integrated into any Ecommerce platform.

### SUMMARY OF THE INVENTION

With a knowledge of the present state of the art, the present inventor set forth with the basic object of creating a dynamic website Campaign builder for merchandising on websites and Social Media Sites, such as that offered under the trademark Facebook by Facebook, Inc. of California, USA.

A further object of embodiments of the invention is to provide a website Campaign builder capable of delivering rapid, relevant marketing for retailers in a tool specifically designed for retail workflow.

Manifestations of the invention have the still further object of providing a dynamic Campaign builder capable of enabling retailers to rapidly create and publish merchandising and promotional Campaigns that are both visually compelling and infused with rich media.

Yet another object of embodiments of the invention is to provide a dynamic Campaign builder that is platform agnostic and easily integrated into any website, Social Media Site, or other Ecommerce platform.

An additional object of embodiments of the invention is to provide retail customers with the ability to create merchandising Campaigns dynamically, potentially independent from developers.

Yet another object of embodiments of the invention is to provide an application that uniquely tracks customer engagement and displays Campaigns with valuable consumer insights from data analysis systems, such as the data analysis system offered under the trademark Google Analytics by Google, Inc. of California, USA.

Another object of embodiments of the invention is to provide a dynamic website Campaign builder that provide enhanced customer engagement opportunities through responsive content, responsive design management and rich media merchandising.

These and further objects and advantages of the present invention will become obvious not only to one who reviews the present specification and drawings but also to those who have an opportunity to experience an embodiment of the dynamic website Campaign builder disclosed herein in operation. However, it will be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

In one embodiment, the Campaign builder may be characterized as Dynamic website Campaign builder software for enabling merchandising via the Internet. The Campaign builder software can have an application programming interface for display on programming computing devices with a display screen to permit building of a Campaign by use of the programming computing devices. At least one Campaign template is retained in electronic memory, and an insertion mechanism is operative by use of the application programming interface to permit insertion of assets into the Campaign template to create a Campaign. A saving mechanism is operative by use of the application programming interface to permit selective saving of Campaigns in electronic memory, and a publishing mechanism is operative by use of the application programming interface to permit selective publication of Campaigns. A recipient user interface is operative on recipient computing devices with display screens. The recipient user interface can be displayed on the recipient computing devices to permit viewing and usage of published Campaigns.

The insertion mechanism can, for example, comprise a Destination Script or an inline frame (iFrame). At least portions of Campaigns can be saved to electronic cloud storage in response to selective saving by operation of the saving mechanism to permit rapid publishing and revisions to Campaigns. The electronic cloud storage can, for example, be a content delivery network (CDN) Media Cloud Server for rapid content delivery network (CDN) publishing.

In certain practices of the invention, a linking mechanism operative by use of the application programming interface can permit a linking of Campaigns to an Analytic program for harvesting and analysis of user interaction and Ecommerce data. In such embodiments, an insights mechanism operative by use of the application programming interface can permit review, analysis, and action upon the user interaction and Ecommerce data. The user interaction and Ecommerce data could comprise Total Clicks and Projected Revenue. In certain embodiments, the data could additionally or alternatively comprise Total Clicks with % of Total and Total, Unique Clicks with % of Total and Total with % of Total and Total, Visits with % of Total and Total, Click Revenue with % of Total and Total, Average Order Value with Site Average and Total, and Conversion Rate with Site Average and Total.

The publishing mechanism can permit users to select from immediate publication or time-delayed publication. Moreover, a destination selection mechanism can be operative by use of the application programming interface to permit a selection of destinations for Campaigns with those possible destinations potentially including home pages, landing pages, and social media site tabs.

Preferably, a plurality of Campaign templates will be retained in electronic memory to permit varied Campaigns to be created. Furthermore, embodiments of the Campaign builder software are contemplated wherein the Campaign templates comprise JavaScript Object Notation (JSON) files that declare position placements and width and height. The Campaign templates can, for example, have Positions of retained assets comprising Heroes with Hero sliders and Promotions without sliders. Still further, Campaign templates can have digital wireframe technology that dynamically defines sizes within the Campaign template, and the insertion mechanism can include insertion options for images, image maps, links, and videos.

To permit optimal Campaign development and editing, the saving mechanism can permit selective saving of multiple Snapshots of Campaigns and multiple Versions of Campaigns. Where plural Campaign templates are retained in electronic memory, the Campaign templates can be selectively previewed. It is contemplated still further that, each Campaign template can provide a visual indication of whether the Campaign template has been published. In particular applications of the software, the user interface can provide a code retrieval mechanism for each published Campaign template.

The dynamic website Campaign builder disclosed herein empowers retailers to rise above resource limitations, regardless of skillset. Users of the Campaign builder can experience enhanced customer engagement with higher quality, more frequent Campaigns. They can improve the consistency of customer experiences by leveraging the same, on-brand media assets across all digital touch points, including websites, tablets, mobile devices, and social media sites. Further, using the dynamic website Campaign builder disclosed herein, users can increase conversion rates through rapid Campaign iteration based on actual success metrics. As used herein, iteration facilitates the identification of trends and customer insights that can drive new promotional opportunities. Internal workflow is improved by allowing merchandisers and designers to publish Campaigns without developer assistance, which concomitantly frees developers to work on more complex projects.

By enabling the publishing of Campaigns without developer assistance, the Campaign builder allows retailers to capitalize on a wide range of opportunities that may have seemed daunting in the past. Users can launch multiple Campaigns and leverage existing media assets without being limited by budgetary issues or an agency's lead times. Further, rushed timelines can be prevented to avoid the release of substandard Campaigns, such as Campaigns that are missing key tagging and rich media functionality. Users can respond to their own and customers' needs with unlimited Campaigns, instead of being constrained by platform or development resources. Placement of the Injection Script and other capabilities taught herein into a user's platform permits the launching of any Campaign into any Destination. Consequently, users can, for example, capitalize on seasonal marketing opportunities without creating organizational angst by time publishing unlimited versions of homepages or landing pages well in advance of events, such as holiday weekends, sales, and other events.

One will appreciate that the foregoing discussion broadly outlines the more important goals and features of the invention to enable a better understanding of the detailed description that follows and to instill a better appreciation of the inventor's contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF DRAWINGS

In the accompanying drawing figures:

FIG. 1A is a flowchart depicting the basic operation of the Campaign builder disclosed herein;

FIG. 1B is a schematic depiction of the configuration of the Campaign builder disclosed herein;

FIG. 2 is a flowchart depicting the linking of Campaigns to an Analytics program to enable performance Insights;

FIG. 3 is a screenshot of a user interface for the dynamic website Campaign builder;

FIG. 4 is a screenshot of a user interface for the dynamic website Campaign builder showing Primary Navigation and the Campaign Category table of contents under the Saved tab;

FIG. 5 is a screenshot of a user interface for the dynamic website Campaign builder showing the Primary Navigation and the Campaign Category table of contents with the Scheduled tab 32 selected;

FIGS. 6A and 6B are screenshots of a user interface for the dynamic website Campaign builder showing the Primary Navigation and the Campaign Category table of contents with the Published tab grid;

FIG. 7 is a screenshot of a user interface for the dynamic website Campaign builder showing the Primary Navigation and the Campaign Category table of contents Archived tab 36 grid;

FIGS. 8A through 8E are screenshots of a user interface for the dynamic website Campaign builder showing a Dynamic Live Preview Popup opened within the Campaign Category table of contents ‘All’ tab grid;

FIG. 9 is a screenshot of a user interface for the dynamic website Campaign builder showing a ‘Get Code’ popup for a Campaign or Destination as triggered within the Campaign Category table of contents ‘All’ tab 28 grid;

FIG. 10 is a screenshot of a user interface for the dynamic website Campaign builder showing the ‘Delete’ popup functionality when a user clicks ‘Delete’ under the ‘Edit’ button;

FIG. 11 is a screenshot of a user interface for the dynamic website Campaign builder showing the ‘Save As’ popup;

FIG. 12 is a screenshot of a user interface for the dynamic website Campaign builder showing the Primary Navigation and the Destination Category table of contents;

FIG. 13 is a screenshot of a user interface for the dynamic website Campaign builder showing the Settings tab selected to cause the graphic user interface of the computing device to display the Settings screen;

FIG. 14 is a screenshot of a user interface for the dynamic website Campaign builder showing the Settings—Client Update screen;

FIG. 15 is a screenshot of a user interface for the dynamic website Campaign builder showing the Settings—Template Update screen;

FIG. 16 is a screenshot of a user interface for the dynamic website Campaign builder showing the Settings—Responsive Design Update screen;

FIG. 17 is a screenshot of a user interface for the dynamic website Campaign builder showing the Settings—Color Update screen;

FIG. 18 is a screenshot of a user interface for the dynamic website Campaign builder showing the Settings—Type Update screen;

FIG. 19 is a screenshot of a user interface for the dynamic website Campaign builder showing the Settings—Default Update screen;

FIGS. 20A through 20C are screenshots of a user interface for the dynamic website Campaign builder cooperating to show the Settings—Messages Update screen;

FIGS. 21A and 21B are screenshots of a user interface for the dynamic website Campaign builder showing the online Documentation screen(s) for being displayed on a computer display of a computing device;

FIG. 22 is a screenshot of a user interface for the dynamic website Campaign builder showing the Create New Campaign screen as triggered by a selection of the New Campaign tab in the Primary Navigation menu;

FIGS. 23A through 23U are screenshots of a user interface for the dynamic website Campaign builder showing the Campaign Edit, Build Campaign Screen as selected by the Build Campaign tab in use;

FIG. 24 is a screenshot of a user interface for the dynamic website Campaign builder in the process of deleting Hero Promos with a delete popup;

FIG. 25 is a screenshot of a user interface for the dynamic website Campaign builder shows the Campaign Edit, Snapshots Tab selected;

FIG. 26 is a screenshot of a user interface for the dynamic website Campaign builder showing the Campaign Edit, Versions Tab;

FIG. 27 is a screenshot of a user interface for the dynamic website Campaign builder showing the Campaign Edit, Chart Tab under the Active Insights Tab;

FIG. 28 is a screenshot of a user interface for the dynamic website Campaign builder showing the Campaign Edit, Detail Tab under the Active Insights Tab;

FIGS. 29A and 29B are screenshots of a user interface for the dynamic website Campaign builder showing the Destinations Settings Tab screen;

FIG. 30A through 30C are screenshots of a user interface for the dynamic website Campaign builder showing the screen operative under the Destinations Versions Tab;

FIG. 31 is a screenshot of a user interface for the dynamic website Campaign builder showing the screen operative under the Destinations Code Tab;

FIG. 32 is a further screenshot of a user interface for the dynamic website Campaign builder showing the Destination's Chart Tab under the Active Insights Tab;

FIG. 33 is a screenshot of the user interface for the dynamic website Campaign builder showing the Destination's, Detail Tab under the Active Insights Tab;

FIGS. 34A through 34F are screenshots of a user interface for the dynamic website Campaign builder showing a Friendly URL template, Campaign and Destination; and

FIGS. 35A and 35B are screenshots of a user interface for the dynamic website Campaign builder showing the Publish popup.

### DETAILED DESCRIPTION OF PREFERRED EMBODIMENTS

The dynamic website Campaign builder disclosed herein is subject to a wide variety of embodiments. However, to ensure that one skilled in the art will be able to understand and, in appropriate cases, practice the present invention, certain preferred embodiments of the broader invention revealed herein are described below and shown in the accompanying drawing figures.

The dynamic website Campaign builder disclosed herein enables merchandising via the Internet on website and Social Media Sites, such as that operative under the registered trademark Facebook. The dynamic website Campaign builder empowers retail customers with the ability to dynamically create merchandising Campaigns. Using the dynamic website Campaign builder, a Campaign can easily be integrated into any website by placing the Campaign builder's Destination Script or an inline frame (iFrame) built according to the Campaign builder that permits the inclusion of external objects including other HTML documents on a website. This integration system calls the present application's robust code, hosted on a world-class Media CDN Cloud Server.

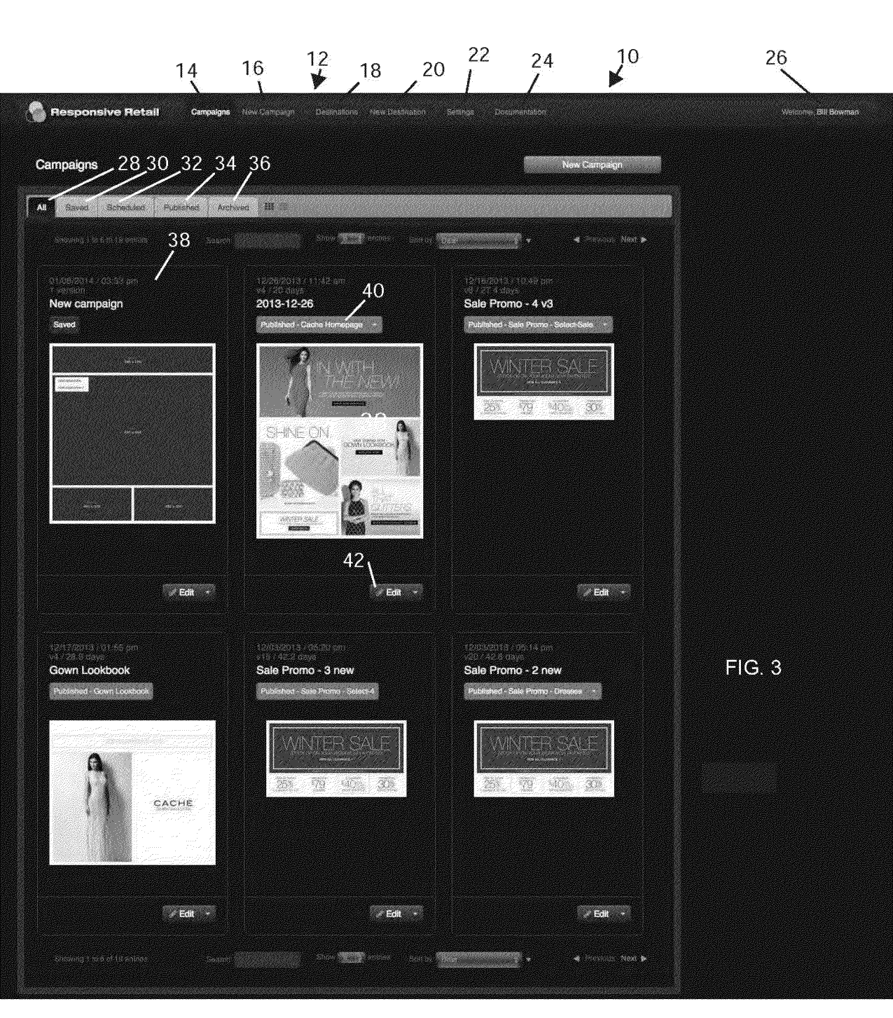

FIGS. 3 through 35B include screenshots of the user interface operative on a computing device for the dynamic website Campaign builder disclosed herein and application programming interfaces of the frontend code for a dynamic website Campaign builder according to the invention.

As disclosed herein, Campaigns are based on drag-and-drop positions displaying rich media feeds, sliders, galleries, navigation styles, and promotions. The application uniquely tracks customer engagement and displays Campaigns with valuable consumer insights, which can be derived from proprietary analysis programs, such as Google Analytics.

While typical Ecommerce platforms focus on transactions and fulfillment, they lack content management and responsive merchandising. Historically, Ecommerce platforms often relegate valuable merchandising opportunities to a lower priority with an inadequate customer experience. Over time, it is often discovered that well performing Ecommerce platforms result in plateaued revenue, only focusing on transactions, not addressing missed customer engagement opportunities. The present Campaign builder can propel plateauing revenue into untapped sales by providing responsive content management, responsive design, and rich, relevant media merchandising.

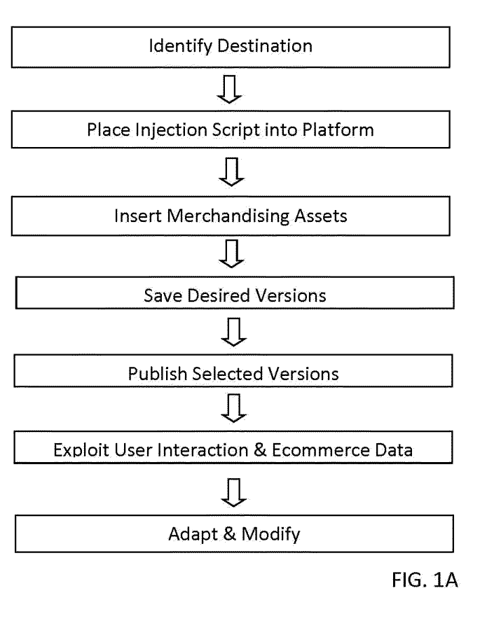

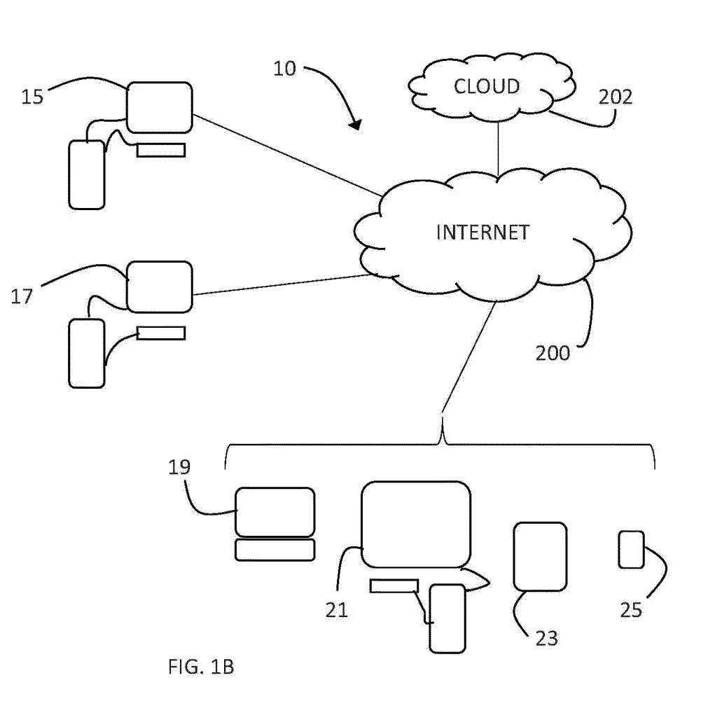

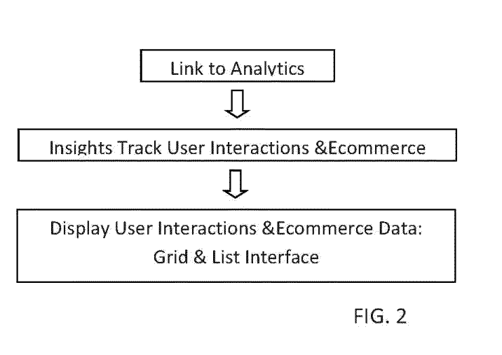

By using the Campaign builder disclosed herein, users can augment their websites and Social Media platforms with rich media Campaigns that have no integration defects and that track end-user behavior with robust insights for all Campaigns. In one practice of the invention, a customer can begin as suggested in FIGS. 1A and 1B and as further shown in FIG. 2 by linking their website, social media site, or other online site to an Analytics program operating under the disclosed Campaign builder 10 that analyzes web traffic. In one manifestation of the invention, by way of example and not limitation, a user with a computing device 15 connected to the Internet 200 can link to the Analytics program offered under the trademark Google Analytics by providing their Google Analytics ID, pointing a subdomain of their site to a server, such as a Cloud server 202, operative under the present invention (i.e. http://promotions.customer.com & https://promotions.customer.com), add an application programming interface (API) account operating under the present invention, such as a Google API account, as a user to their Analytics account, and provide the width of their website.

As depicted in FIG. 1B, the Campaign builder 10 can be operative via software and data retained, for instance, in electronic memory on the client computing device 15, a host server computing device 17, a cloud server 202, or, additionally or alternatively, some other electronic storage medium. As taught herein, Campaigns produced with the Campaign builder 10 can ultimately be displayed and used as by viewing and ordering merchandise on any recipient computing device, such as but not limited to large display devices 21, such as tower computers, default displays, portrait tablets 23, laptops 19, mobile phones 25, phones 25 to tablets 23, and substantially any other computing device with a display screen. The several screenshots shown and described herein can be displayed for Campaign creation and Campaign usage on the display screens of any of the computing devices 15, 17, 19, 21, 23, and 25.

With the Analytics program linked to the site, an Insights procedure according to the present system can dynamically track user interactions and ecommerce data for all Destinations and Campaigns created hereunder including, by way of example and not limitation: Projected Revenue, Total Clicks with % of Total and Total, Unique Clicks with % of Total and Total with % of Total and Total, Visits with % of Total and Total, Click Revenue with % of Total and Total, Average Order Value with Site Average and Total, Conversion Rate with Site Average and Total, Transaction with Site Average and Total and Per Visit Value with Site Average and Total. Some, all, and potentially further user interaction and Ecommerce data can then be displayed, such as through a Grid and List interface, through dynamic bar charts and tables.

The dynamic website Campaign builder presents an easy-to-use, drag-and-drop user interface, with a custom workflow, tailored to merchandise-rich media website Campaigns in accordance with how retailers think about merchandising. The Campaign builder is platform agnostic and will work with any platform. Users can inject an insertion mechanism, such as a Destination script or iFrame, into their website and publish any Campaign according to the invention to it.

As disclosed herein, the Campaign builder is a responsive design content management system that allows users to edit unique device size images per device within a unique, custom, and editable template system and administrative interface. Users can, for instance, upload the largest device size image, and the Campaign builder will build all unique image sizes. The Campaign builder alerts the user of any ratio or image size problems and empowers the user to upload unique images per device size that are more appropriate and readable for the respective device.

The Campaign builder has a Template system that inherits all of the Campaign builder's functionality. Templates are reduced to simple JavaScript Object Notation (JSON) files that declare position placements and width and height as well as whether the position is a Hero or Promo, both discussed further below, and if the Template is Fixed Width or Responsive Design ready. The Campaign builder includes unlimited JSON Campaign templates, including Landing Pages, Tab Templates for social media sites, such as Facebook, Category Templates, Responsive Design Templates, and Friendly URL Templates.

Custom code for the Campaign builder allows for rapid content delivery network (CDN) publishing on a CDN Media Cloud Server operating under the present invention. The Campaign builder augments all file names with version numbers and manages all relationships between versioned files and assets. When publishing new files or iterating changes, customer Campaigns as taught herein can immediately publish to the CDN Media Cloud Server.

Users can iterate and create unlimited numbers of Snapshots and Versions of Campaigns that can be published or time published (i.e. scheduled) at any time. Users can place the Campaign builder's Destination script once into their website and then push publish unlimited rich media Campaigns to that placed Destination Script.

As taught herein, the Campaign builder permits unlimited landing pages through fixed width and responsive design templates that can be published to any Destination and any Device thereby permitting merchandising freedom heretofore unrealized. Accordingly, Destinations can include, by way of example and not limitation, home pages, landing pages, category pages, social media site tabs, and Look books. Recipient devices can include large displays, default displays, portrait tablets, phones to tablets, and mobile phones, and substantially any other display device.

Campaigns created under the invention can be presented, approved, and published. Merchandisers and designers can leverage the unlimited number of pages in the Campaign builder to create, save, and iterate multiple Campaigns. Designers can use this functionality to create a wide range of comparison pages. Pages can be saved as what can be referred to as Snapshots. Snapshots can be published once, but potentially used across multiple Destinations.

Embodiments of the Campaign builder can permit the creation of page designs by drag and drop page creation. The Campaign builder has digital wireframe technology that dynamically defines all sizes of a given Campaign, pulled from the JSON templates, thereby allowing merchandisers and designers to easily publish across Destinations without requiring developer assistance. Standard landing pages thus no longer limit a user's ability to convert on promotions. Publishing custom landing pages for email Campaigns or promotions is simple with the Campaign builder disclosed herein, and business users can easily drag and drop promotions and rearrange them within any Campaign in any order.

The Campaign builder can further be applied to tabs of social media sites, such as Facebook, to provide a user's followers with an experience that is consistent with brand, website, and other Destinations. As a result, users can, for instance, leverage the Campaigns and media that showcase on a website on social media sites and other Destinations. Social media tabs and pages can thus use the same media assets and engage followers in a highly visual experience.

Pursuant to the invention, templates are built with Positions that allow users to customize the placement and look and feel of Campaigns. There are two types of Positions: Heroes and Promotions, each potentially including images, image maps, links, and videos. Heroes are larger promotions that can be created into three different types of sliders: Hero sliders with typographical navigation, Hero sliders with element navigation, and Hero sliders with custom thumbnail carousels. Promotions are smaller, non-slider, Positions that are supportive to Heroes.

The Campaign builder provides a dynamic Responsive Design system where users can upload images once and the Campaign builder's Media Server constructs all needed image sizes for all devices including, but not limited to, large displays, default displays, portrait tablets, phones to tablets, and phones.

By use of the Campaign builder, campaigns can be customized based on the recipient device. Rather than a one-size fits all display, any image can be customized for display on any device. For instance, where a user finds a large Hero Promotion attractive on Large Displays but wants smaller devices to utilize an alternate Hero that is more readable, the Campaign builder can customize the image for the smaller display device.

The Campaign builder can track key performance indicators (KPI) without a need for coding by linking to an Analytic program, such as Google Analytics as described above and hereafter. With that, the Campaign builder taught herein not only allows for rapid Campaign publishing, but it also tracks each Campaign's performance efficiently and accurately. By exploitation of data harvested and analyzed by the Analytic program, the Campaign builder provides an Active Insights tool that shows simplified, visual analysis of published Campaigns including, but not necessarily limited to, the following metrics: Total Clicks, Unique Clicks, Visits, Revenue, Average Order Value, Conversion Rate, Transactions, and Per Visit Value. The Campaign builder also supports the process of analyzing results by allowing users to sort Campaigns, Versions, and Destinations dynamically, such as by top clicks and revenue.

The Campaign builder allows users to easily integrate videos, such as videos published on user-video sites such as that offered under the trademark YouTube by Google, Inc., into Campaigns across some or all Destinations. To do so, a user can insert a video share link into a Campaign. Then, animations and transitions can optionally be added to create a compelling video experience for customers that is directly integrated into merchandising.

Still further, the Campaign builder enables rapid iteration of Campaigns, and every Campaign can be saved as multiple Snapshots and published, potentially as multiple Versions, to any Destination. Campaigns and Versions can be analyzed and sorted using the Analytics program based on results, such as by unique clicks or revenue. Accordingly, users can keep track of what works and adapt future Campaigns accordingly.

Campaigns can be retained in electronic memory so that users can restore any Version of a Campaign or use existing Campaigns to create a new Campaign and further accelerate the publishing process. Moreover, the Campaign builder enables the creation and storage of multiple Campaign compositions, referred to herein as Snapshots, that allow one to review, consider, and obtain approval of campaign versions prior to publication.

Embodiments of the Campaign builder's code can revolutionize content delivery network (CDN) publishing. In particular, retailers receive all of the benefits of a CDN but do not need to wait for caches to clear when iterating and publishing Campaigns rapidly. The Campaign builder harnesses the power of a CDN hosted on a Cloud, such as on the Cloud Files offered under the trademark RackSpace by RackSpace US, Inc. of San Antonio, Tex. When a merchandiser creates a Campaign under the Campaign builder, it is instantly published to the CDN allowing the delivery of rich media experiences that operate fast on the respective website, social media page, or other site.

Furthermore, the Campaign builder allows for time publishing of Campaigns. Rather than being forced to sequence Campaigns, users can multi-time publish any Version of a Campaign to any Destination. This simplifies the workflow for both designers and merchandisers and allows for enhanced promotion flexibility, especially during critical seasonal merchandising windows.

Looking again to FIG. 1, a user designing and implementing a Campaign can first create the Destination and then place the Campaign builder's Injection Script into the user's existing platform to be used in future publishing. Merchandising Assets can then be dragged and dropped or otherwise inserted into the Campaign through the Injection Script. Advantageously, the user can save as many versions of the Campaign as may be desired for later review, editing, approval, and, where appropriate, publishing. Selected versions of the Campaign can then be published, whether immediately, by time-delayed publishing, seasonally, or otherwise. Once one or more versions of a Campaign are published, the user can exploit the link to the Analytics program and the user interaction and Ecommerce data provided thereby to track and compare Destinations, Campaigns, and Campaign Versions without the cost or complexity of A/B split testing. Based on the acquired user interaction and Ecommerce data, on new Campaign developments, on seasonal, sale, and other factors, Campaigns can be adapted and modified. Merchandisers and designers can rapidly respond to trends and publish rich media Campaigns, typically without involving developers or information technology professionals. Campaigns can be quickly and conveniently updated and modified and quickly iterated based on, among other things, practices and techniques that have been proven to be effective based on the Analytic results.

The Campaign builder is adaptive to any platform. For instance, the Campaign builder is applicable to mobile applications to permit, among other things, customer's needs to swipe through a merchandiser's catalog or look books on their mobile devices when they want and where they want. Standalone mobile sites can be created with friendly URLs, such as promotions. [CustomerBrand].com/holiday-2013. Furthermore, customers with mobile solutions can conveniently and effectively publish Campaigns built according to the present invention in a swipe enabled format directly to a pre-existing mobile solution. Where a user has video content to be published, the Campaign builder permits promotions to be set to click and flip, revealing desktop, tablet, and mobile friendly videos.

The Campaign builder disclosed herein will thus allow customer to create unlimited merchandising Campaigns through the drag-and-drop interface, to be time-published, versioned and tagged for Analytics with custom analytical programming for Analytic event tracking code. Published content will leverage the Campaign builder's custom integration with, for example, a world-class Media CDN Cloud Server.

A more particular understanding of the Campaign builder disclosed herein will be had by reference to the computer screenshots included as FIGS. 3 to 35B. Turning first to FIG. 3, a screenshot of an application programming user interface for the dynamic website Campaign builder 10 is shown. The application programming user interface, which may alternatively be referred to simply as a user interface hereinafter with it being understood that it is an application programming user interface, has Primary Navigation 12 at the top thereof with the Campaigns tab 14 selected. Within the Campaign Category table of contents, the All tab 28 is selected so that all Campaigns are shown in a grid. The Primary Navigation 12 includes the following button links: Campaigns 14, New Campaign 16, Destinations 18, New Destination 20, Settings 22, and Documentation 24. A welcome, User Name, message 26 has a dropdown for logout. Clicking Campaigns 14 takes the user to the Campaigns with the All tab 28 open. Clicking New Campaign 16 allows the user to make a new Campaign. Clicking 18 Destinations takes the user to a Destinations view. Clicking New Destinations 20 allows the user to make a new Destination. Clicking Settings 22 allows administrators to change all application settings while allowing users to add, modify and delete application Colors and Type. Clicking Documentation 24 navigates the user to an online help guide and manual.

The All tab 28 is for all Campaign types including Saved, Scheduled, Published and Archived Campaigns. Users can view Campaigns by grid or list views. At the top of each Campaign Thumbnail 38 is the date and time of creation, the version number and how many days the Campaign has been live. The user can click any thumbnail 38 for a dynamic live preview popup per Campaign for both fixed width and Responsive Design Campaigns. Responsive Design Campaign previews include the following devices and sizes: Large Display, Default, Portrait Tablets, Phones to Tablets and Phones.

The Campaign builder 10 dynamically converts all links in a Preview to open in another tab from Preview so the user can verify link accuracy and not leave the application. When the Campaign is published, links are dynamically restored to the user's set targets. The Campaign builder 10 constantly maintains dual link states, one for Preview and one for Published Campaigns. Beneath each Campaign thumbnail 38 is a custom badging system that by color and drop down denotes whether the Campaign is published to one or more destinations or iFrame. For Published Campaigns, a badge 40 is shown with type denoting Published and the Destination Name. A badge 40 presented as a dropdown denotes a Campaign published to multiple Destinations shown in a list beneath the badge. Where a Campaign is simply saved, a badge 40 with type denotes Published or Saved. A Campaign scheduled for publishing has a badge 40 with type denoting Scheduled for Date 00.00.00 and time @00:00 pm to a Destination or iFrame.

Beneath the Campaign thumbnail 38 and badge 40 system in the lower right corner of each Campaign is an Edit button 42 with a dropdown. The Edit button 42 within the All tab 28 includes Edit, Preview, Get Code, Save As, Archive and Delete. Edit allows the user to edit the Campaign. Preview allows the user to open the dynamic and live Campaign preview. Get Code provides the Destination script, allowing the user to copy and place it into their desired website platform to publish Campaigns to it, the Destination Link, and the View Destination Link. Save as allows the user to save the Campaign as another Campaign. Archive allows the user to store the Campaign and remove it from being active. Delete allows the user to delete the Campaign.

The tools above and duplicated below the grid and list of Campaign thumbnails 38 allow users to see the total number of Campaigns, Search and sort all Campaigns by Name, Date, Days Live and Campaign Name. The user can sort any and all resulting in ascending or descending order by, for example, clicking a triangle to the right of a Sort by dropdown. The user can also page through previous and next Campaigns in groups of six or by All by selecting View All. Search is predictive and allows the user to start typing what they are looking for and the Campaign builder 10 will instantly start to show results disclosed herein.

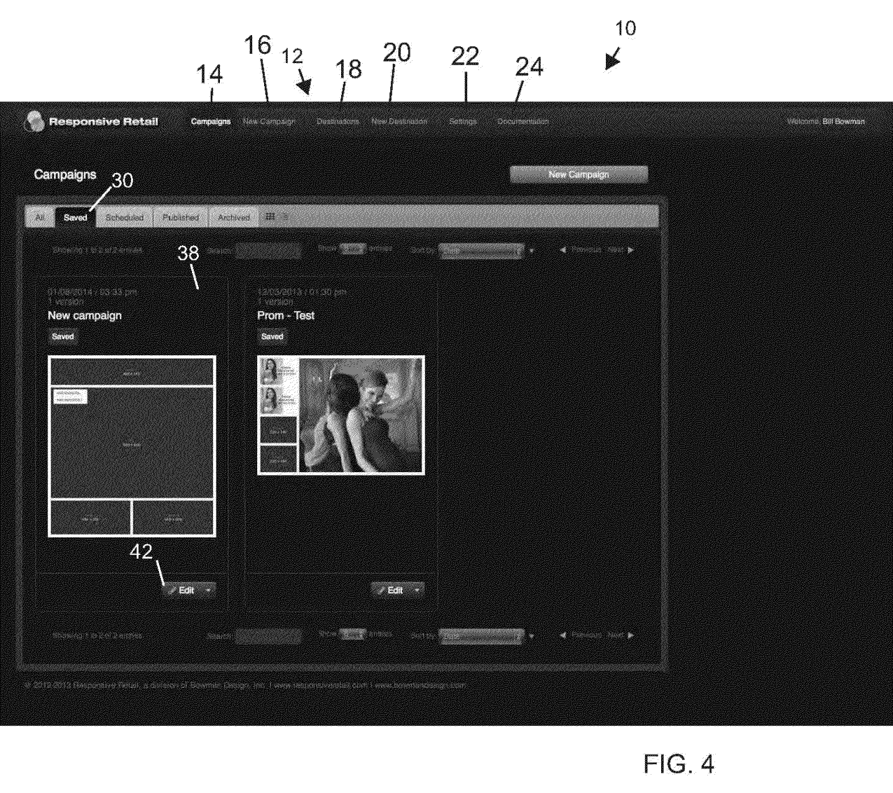

FIG. 4 is a screenshot of a user interface for the dynamic website Campaign builder 10 showing the Primary Navigation 12 atop and the Campaign Category 14 table of contents under the Saved tab 30. The Saved tab 30 shows unpublished, saved Campaigns thumbnails 38. It contains all of the same features as in FIG. 3. However, the Edit button 42 varies. The Edit button 42 within the Saved tab 30 includes options to Edit, Preview, Save As, Archive, and Delete. Edit allows the user to edit the Campaign. Preview allows the user to open the dynamic and live Campaign preview. Save as allows the user to save the Campaign as another Campaign. Archive allows the user to store the Campaign and remove it from being active. Delete allows the user to delete the Campaign.

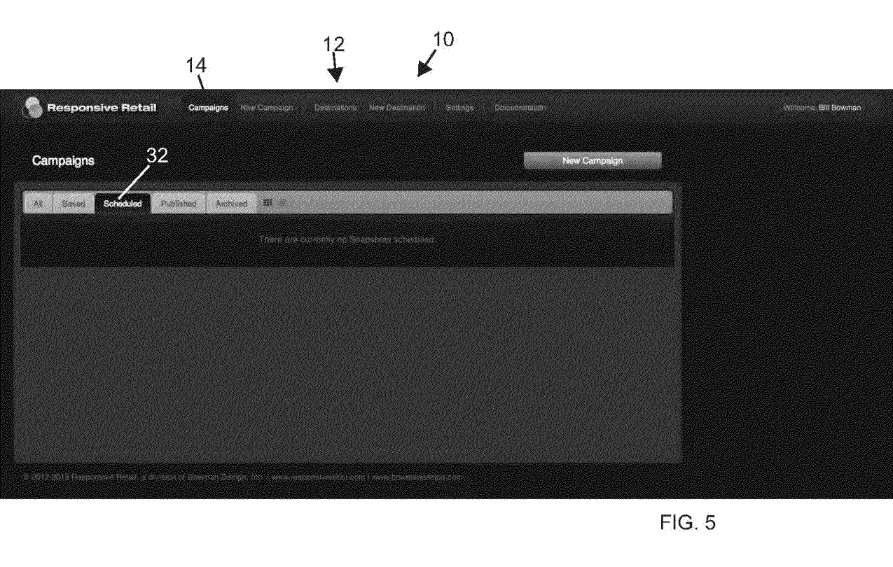

FIG. 5 is a screenshot of a user interface for the dynamic website Campaign builder 10 showing the Primary Navigation 12 atop and the Campaign Category 14 table of contents with the Scheduled tab 32 selected. The Scheduled tab 32 shows Campaigns that are in the publish queue to go live. It contains all of the same features as in FIG. 3. However, the function of the Edit button 42 (not shown in FIG. 5) varies. The Edit button 42 within the Scheduled tab 32 includes Edit, Preview, Get Code and Unscheduled options. Edit allows the user to edit the selected Campaign. Preview allows the user to open the dynamic and live Campaign preview. Get Code provides the Destination script of the Campaign builder 10, allowing the user to copy and place it into their desired website platform to publish Campaigns to it, the Destination Link, and the View Destination Link. Unscheduled allows the user to remove the Campaign from the scheduled publishing queue, while the Campaign remains saved as disclosed herein.

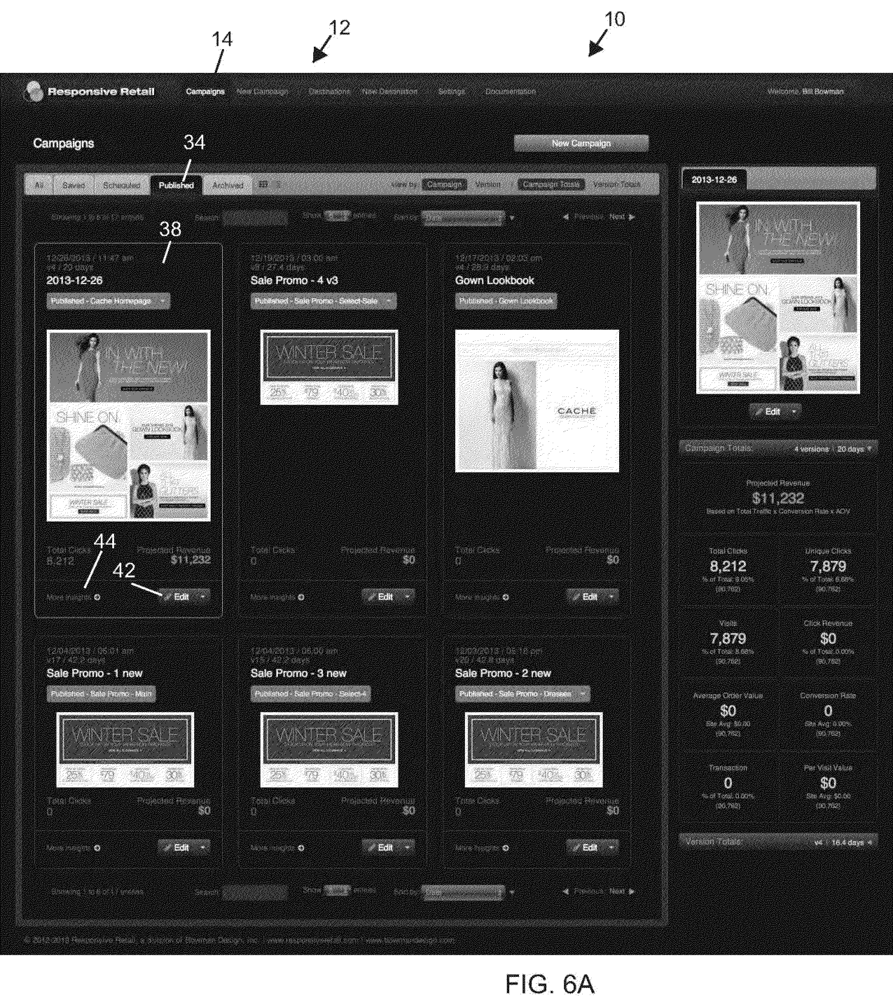

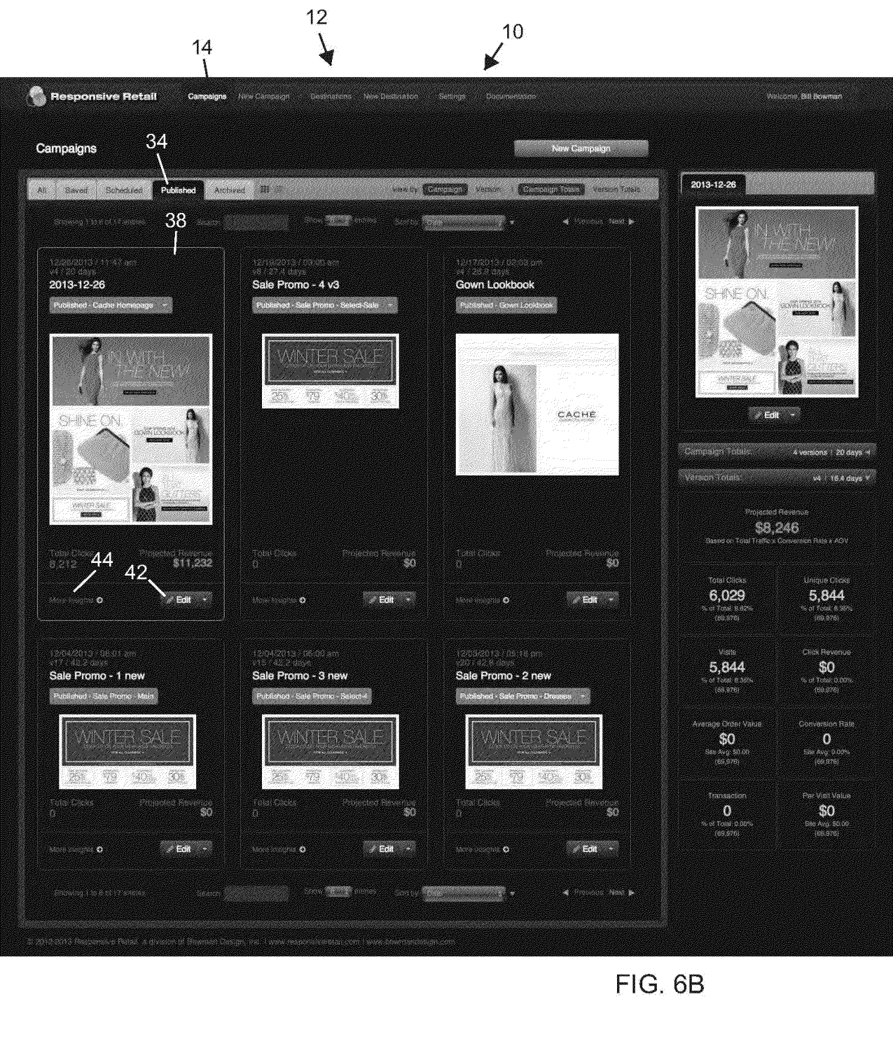

FIGS. 6A and 6B are screenshots of an application programming user interface for the dynamic website Campaign builder 10 showing the Primary Navigation 12 atop and the Campaign Category 14 table of contents with the Published tab 34 grid. The Published tab 34 is for published Campaigns, published to either a Destination or iFrame. The Published tab 34 contains all of the same features as in FIG. 3. However, the Published tab 34 also includes tools above and below the grid of Campaign thumbnails 38, as well as a list view, allowing users to see the total number of Campaigns, Search and Sort all Campaigns by Date, Days Live, Destination Name, Total Clicks, and Projected Revenue. The user can sort any and all results in ascending or descending order by clicking a triangle to the right of a Sort by dropdown. The user can also page through previous and next Campaign thumbnails 38 in groups of six or by All by selecting View All.

The Edit buttons 42 within the Published tab 34 vary from the other tab views. The Edit button 42 within the Published tab 34 includes Edit, Preview, Get Code, Save As, Archive and Delete. Edit allows the user to edit the Campaign. Preview allows the user to open the dynamic and live Campaign preview. Get Code provides the Destination script for the Campaign builder 10, allowing the user to copy and place it into their desired website platform to publish Campaigns to it, the Destination Link, and the View Destination Link. Save as allows the user to save the Campaign as another Campaign. Archive allows the user to store the Campaign and remove it from being active. Delete allows the user to delete the Campaign.

As FIGS. 6A and 6B also show, the Published tab 34 further includes Campaign Insights within each Campaign thumbnail 38. The Campaign insights are first shown beneath each thumbnail as Total Clicks and Projected Revenue. Campaign insights are custom coded as events tracked by the Analytics program. For instance, in one practice of the invention, the Campaign insights are Google Events that are pushed and tracked into Google Analytics. Projected Revenue can be derived by Total clicks multiplied by Conversion Rate multiplied Average Order Value. To the left of the Edit button 42, the user can click a More Insights button 44, which allows the user to view additional Campaign Totals or latest Version Totals. While Campaigns totals tabulate all Versions within a single Campaign, Version Totals show only the latest Version's Totals so that the results of particular Campaign versions can be evaluated.

When the user clicks More Insights 44, Campaign and Version Totals show in the right pane tool bar and can, for example, include the following detailed Insights: Projected Revenue, Total Clicks with % of Total and Total, Unique Clicks with % of Total and Total with % of Total and Total, Visits with % of Total and Total, Click Revenue with % of Total and Total, Average Order Value with Site Average and Total, Conversion Rate with Site Average and Total, Transaction with Site Average and Total and Per Visit Value with Site Average and Total. A large Campaign thumbnail 38 is depicted above the detailed Insights so that the user can click to open a dynamic live preview of the Campaign. Beneath the Campaign Thumbnail 38 is another Preview button containing the same functionality as the Preview button in the grid and list documented above. The Published tab 34 grid view also includes multiple View By facets. The facets include View By Campaign or Version totals. Within the View By Campaign Totals, the user can sort by Campaign Totals or the most recent Version of the Campaigns. Within the View By Version Totals, this shows all Campaign versions in the grid, and the user can sort by all Version totals. The user can sort any and all results in ascending or descending order.

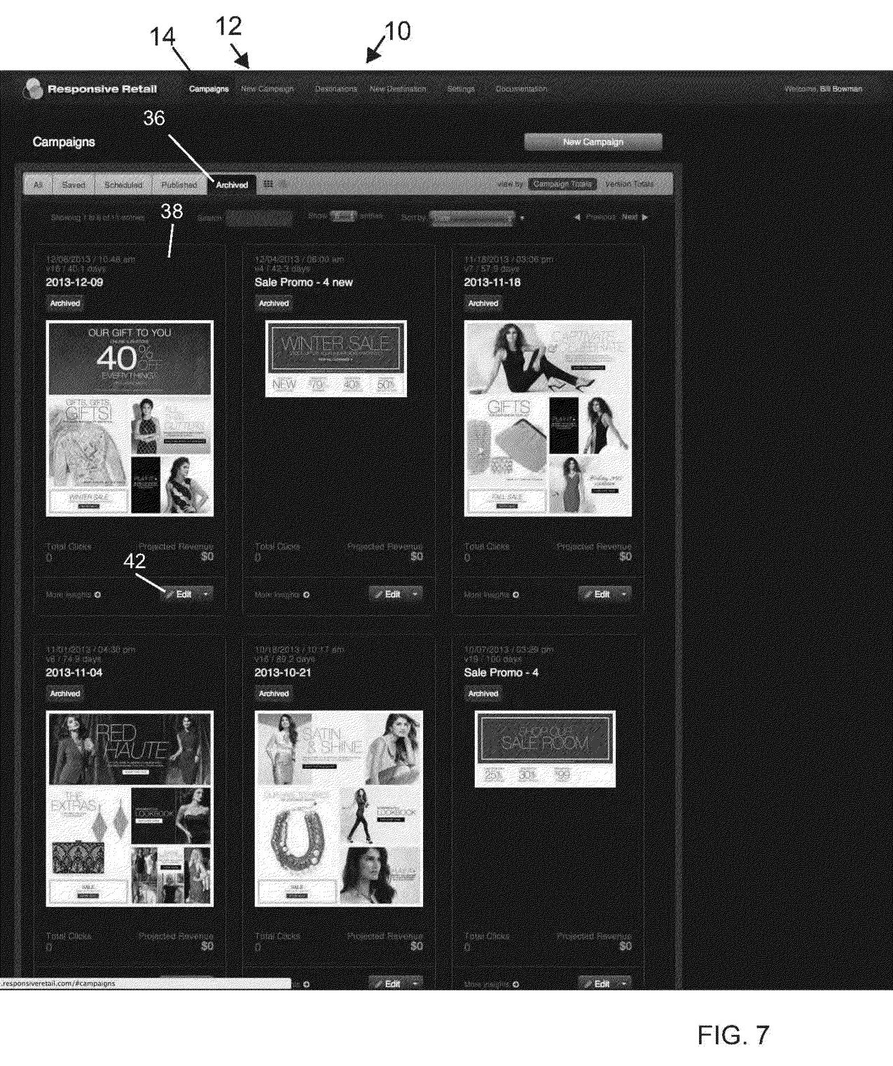

Turning to FIG. 7, one sees a screenshot of a user interface for the dynamic website Campaign builder 10 showing the Primary Navigation 12 atop and the Campaign Category table of contents Archived tab 36 grid. The Archived tab 36 is for users to store inactive Campaigns, hence archive old Campaigns. It contains all of the same features as in FIGS. 6A and 6B, including Insights. However, the Edit button 42 varies. The Edit button within the Archived tab 36 includes Edit, Preview, Unarchive, Archive, and Delete. Edit allows the user to edit the Campaign. Preview allows the user to open the dynamic and live Campaign preview. Unarchive allows the user to move the Archived Campaign to a Saved state in the All and Saved tabs 28 and 30. Archive allows the user to store the Campaign and remove it from being active. Delete allows the user to delete the Campaign. The Archived tab 36 grid view also includes View By facets. The facets include View By Campaign or Version totals. Within the View By Campaign Totals, the user can sort by Campaign Totals or the most recent Version of the Campaigns. The user can sort any and all results in ascending or descending order.

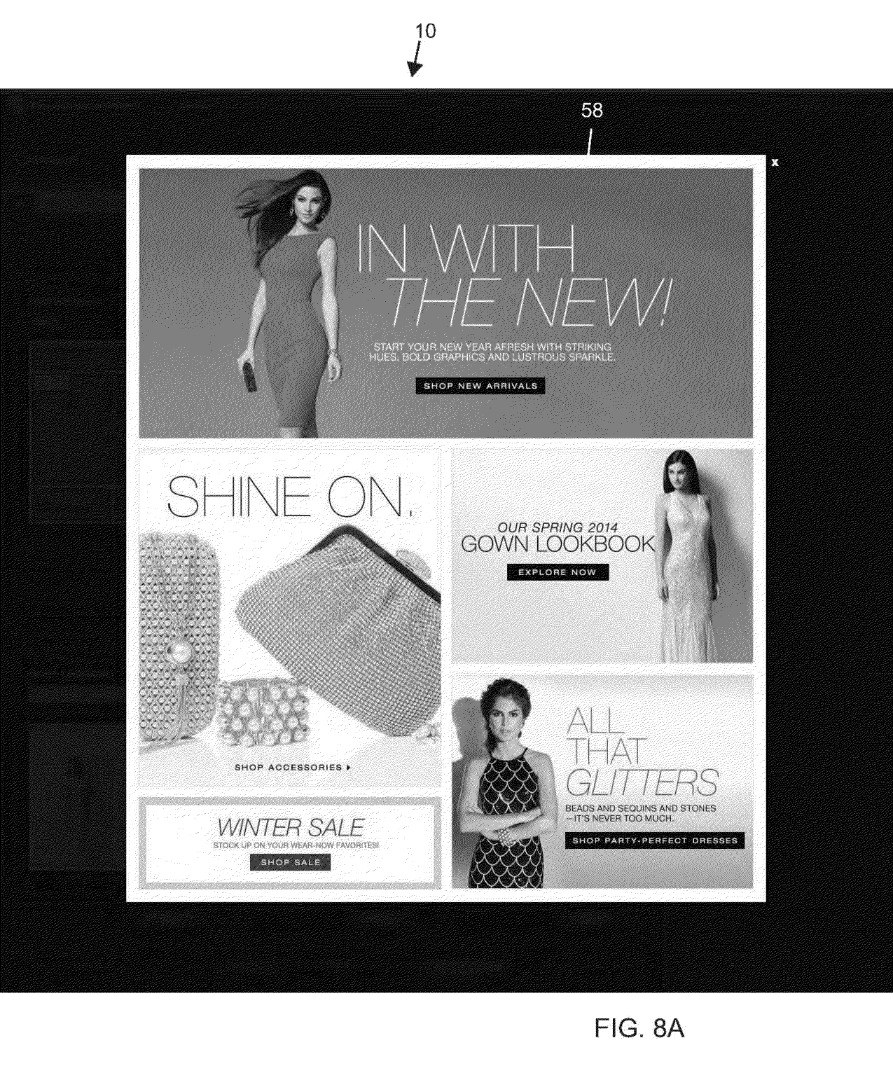

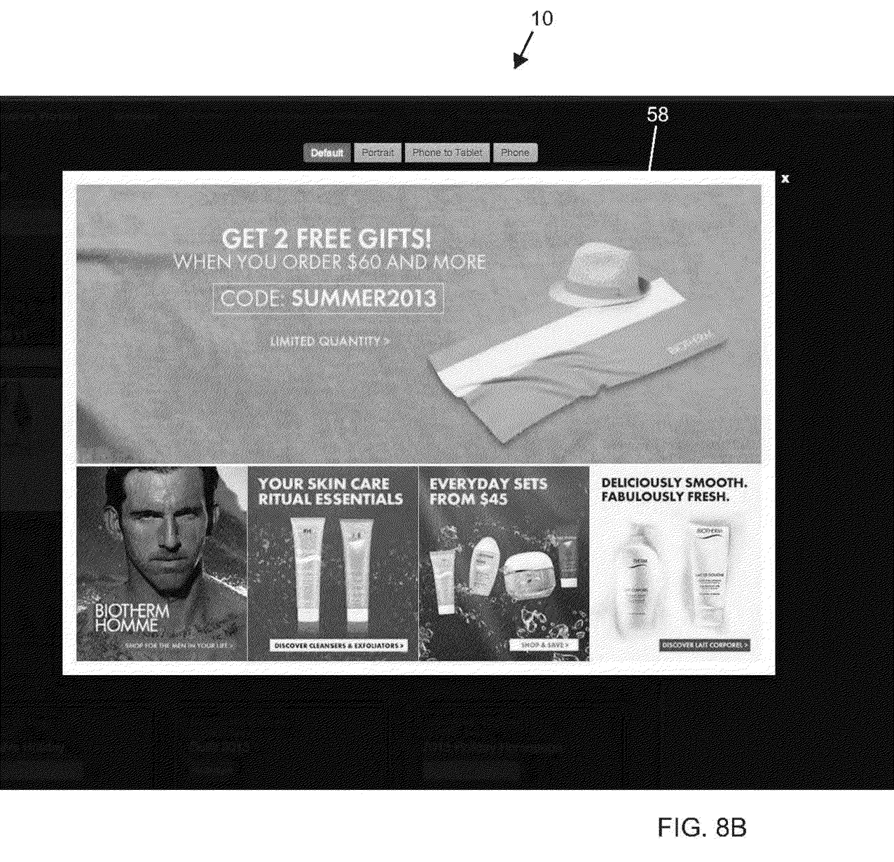

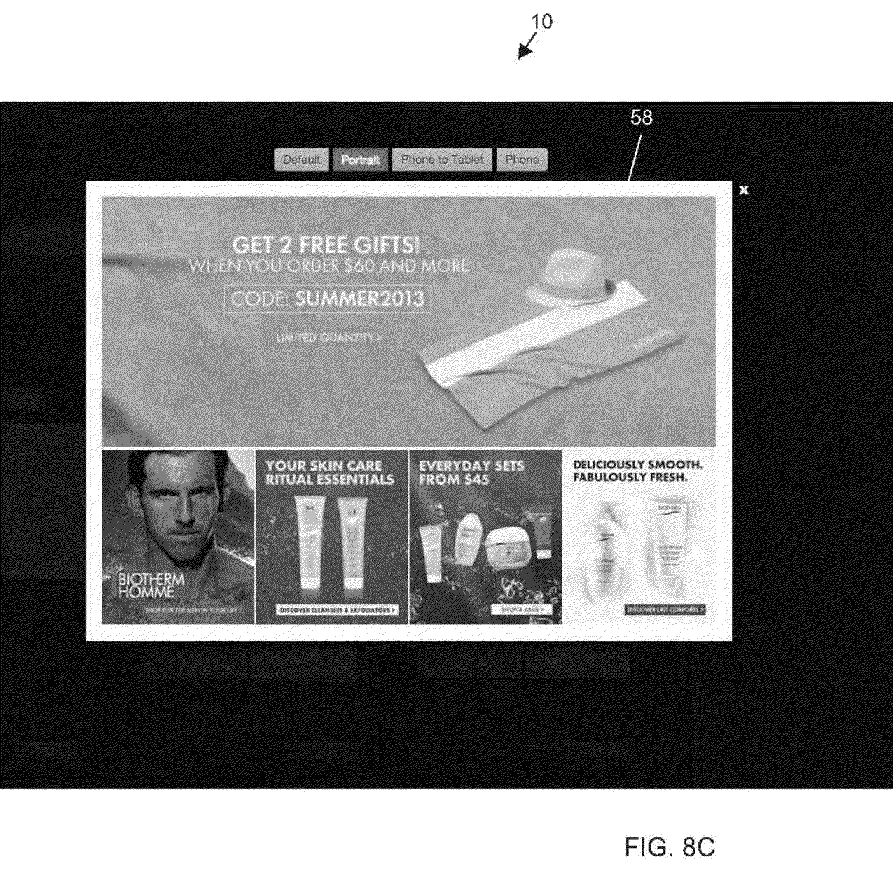

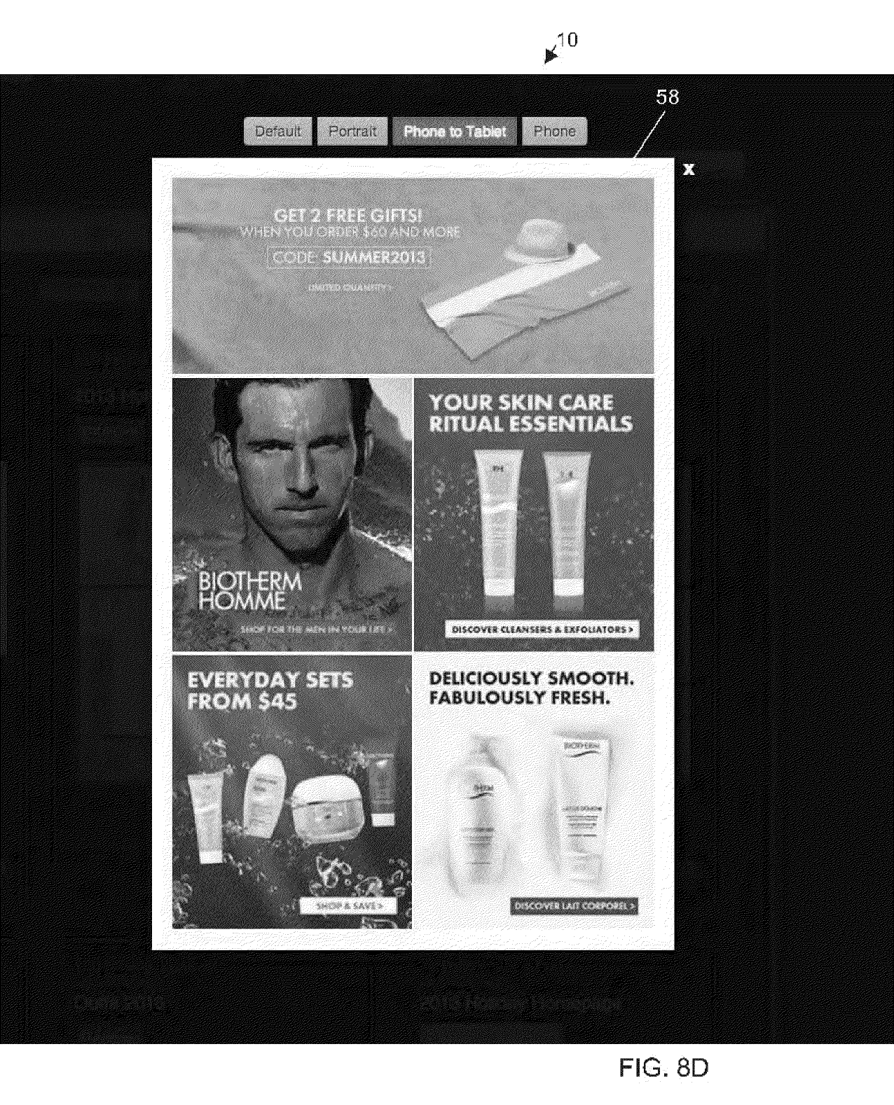

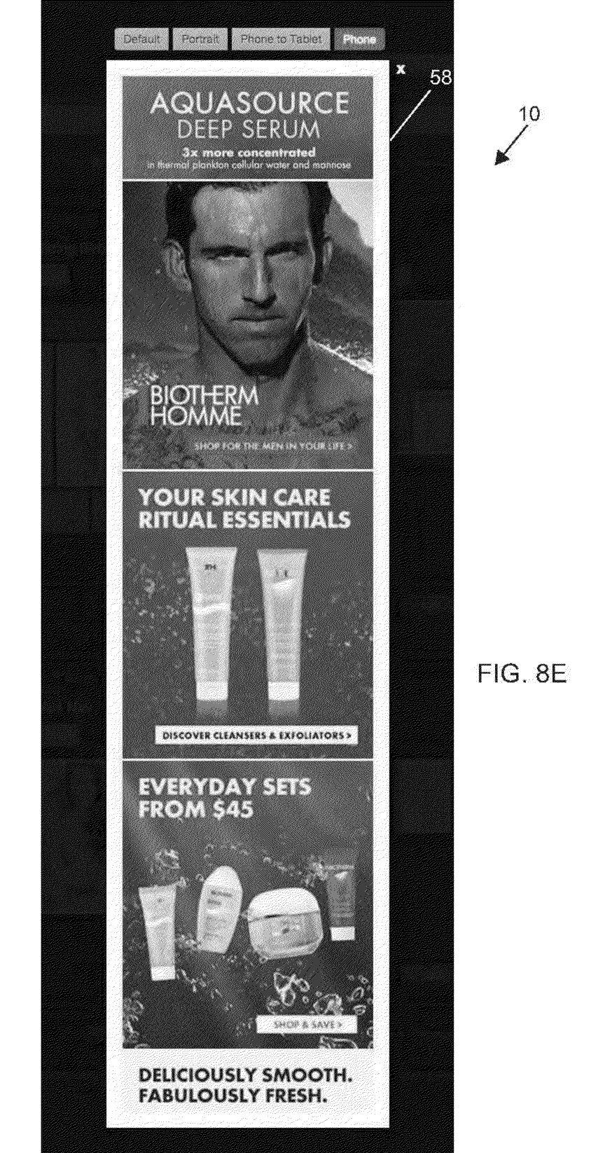

FIGS. 8A through 8E are screenshots of a user interface for the dynamic website Campaign builder 10 showing a Dynamic Live Preview Popup 58 as would appear as a recipient user interface on a recipient computing device 19, 21, 23, or 25 as in FIG. 1B. The Dynamic Live Preview Popup 58 is opened within the Campaign Category 14 table of contents ‘All’ tab 28 grid as illustrated previously. The Dynamic Live Preview Popup 58 provides examples in FIGS. 8A through 8E of both a fixed width template and Responsive Design template Preview Popups 58 for acting as recipient user interfaces. The Responsive Design template Preview Popup 58 is shown to include the following options for device sizes: Large Display, Default, Portrait Tablets, Phones to Tablets and Phones. Both the fixed width and Responsive Design template Preview Popups 58 show live Campaigns that allow the user to preview and check placed links and inserted videos.

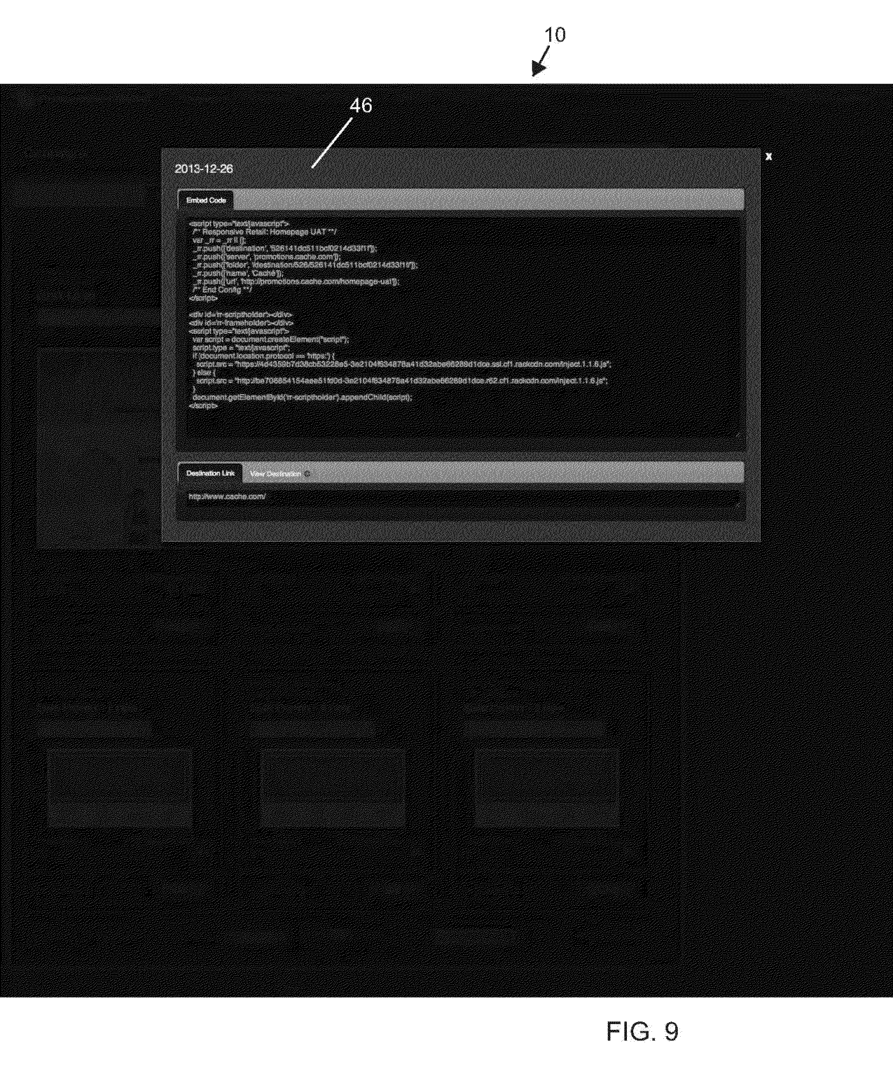

FIG. 9 is a screenshot of a user interface for the dynamic website Campaign builder 10 showing a ‘Get Code’ popup 46 for a Campaign or Destination as triggered within the Campaign Category 14 table of contents ‘All’ tab 28 grid shown and described previously. The ‘Get Code’ popup 46 provides the Destination script, allowing the user to copy and place it into their desired website platform to publish Campaigns to it, the Destination Link, and the View Destination Link.

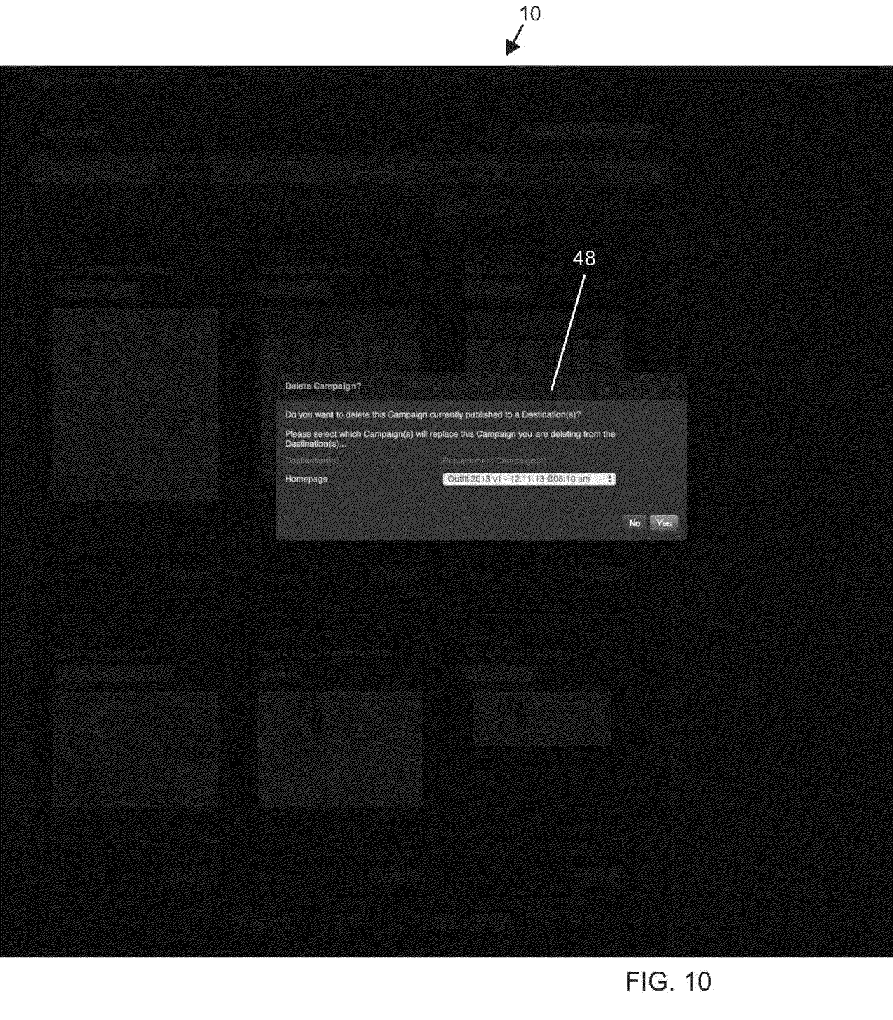

FIG. 10 is a screenshot of a user interface for the dynamic website Campaign builder 10 showing the ‘Delete’ popup 48 functionality when a user clicks ‘Delete’ under the ‘Edit’ button 42. The ‘Delete’ popup 48 allows the user to select available replacement Campaign versions when deleting a Campaign that is actively published to a Destination. This is helpful as a Campaign can be published to multiple Destinations. When a Campaign is published to multiple Destinations and the user wants to delete it, each active Destination is shown as a dropdown in the ‘Delete’ popup 48, allowing the user to select available replacement Campaigns for all actively published versions.

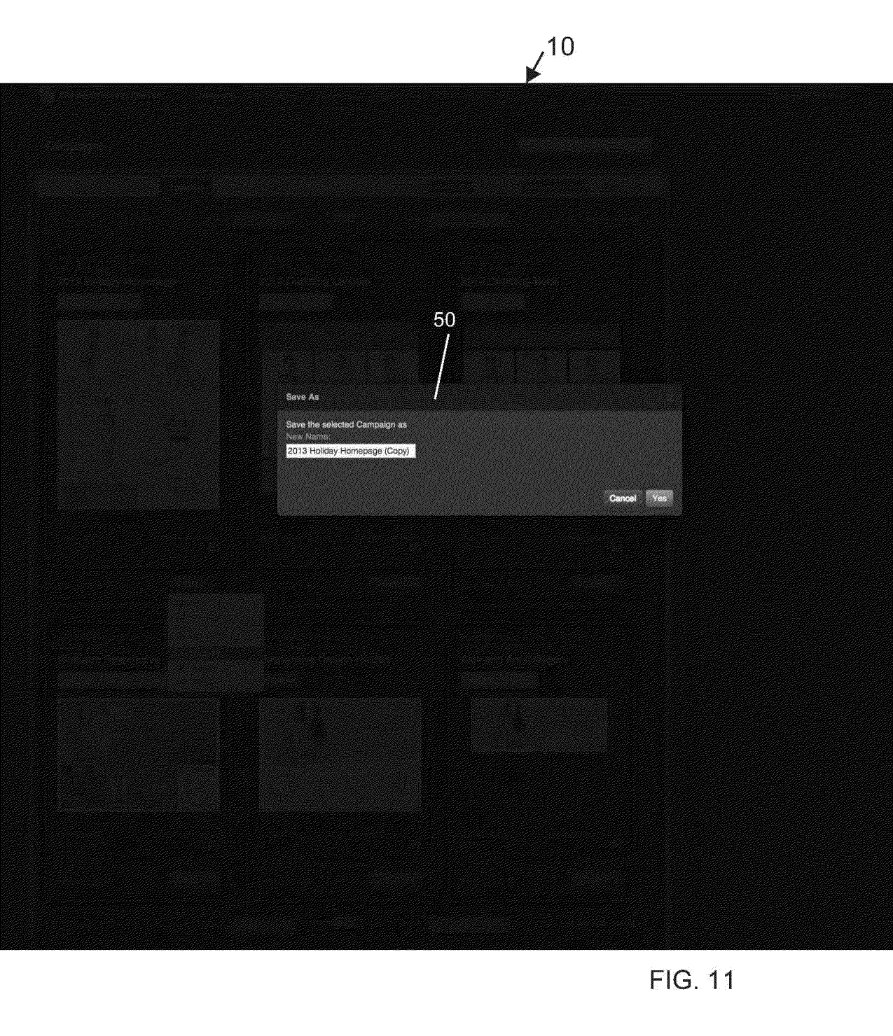

FIG. 11 is a screenshot of a user interface for the dynamic website Campaign builder 10 showing the ‘Save As’ popup 50. The ‘Save As’ popup 50 functionality allows users to copy Saved Campaigns as New Campaigns without having to redo all of the Campaign creation work.

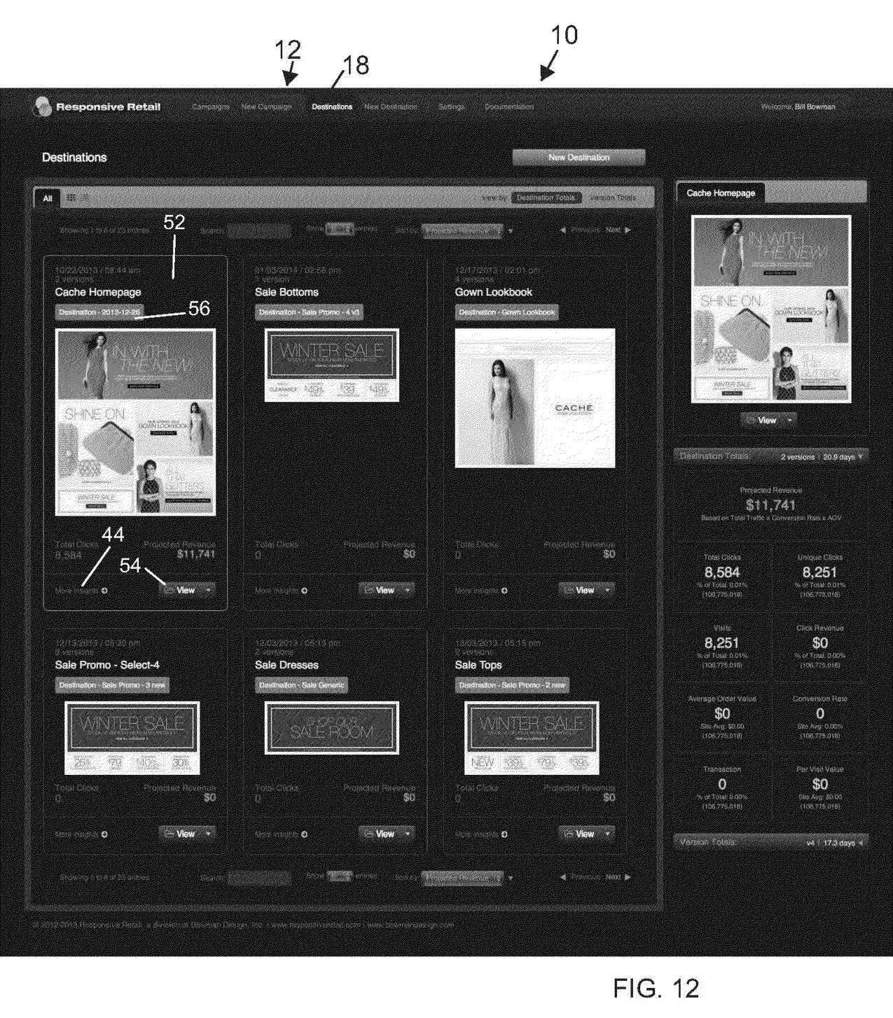

FIG. 12 is a screenshot of a user interface for the dynamic website Campaign builder 10 showing the Primary Navigation 12 atop and the Destination Category 18 table of contents. Users can click Destinations 18 in the Primary Navigation 12 to view Destinations by grid or list views. A grid icon at the right of the tabs represents the grid view, and the list view is represented as a bulleted list icon to the right of the grid view icon. Grid view can be the default view. At the top of each Destination thumbnail 52 is the date and time of creation and the version number. The user can click any thumbnail 52 for a dynamic live preview popup 58 as shown previously per Campaign for both fixed width and Responsive Design Campaigns. Responsive Design Campaign previews include the following devices and sizes: Large Display, Default, Portrait Tablets, Phones to Tablets, and Phones.

Beneath each Destination thumbnail 52 is a custom badging system that, by color and drop down, denotes the most recent Campaign published to that Destination. For instance, a green badge 56 with white type can denote Published and can indicate the most recent Campaign Name published to that Destination Name. When a Destination has no actively published Campaigns, a gray badge 56 with white type denoting ‘Saved’ can be shown. Beneath the Destination thumbnail 52 and badging system in the lower right corner of each Campaign is a ‘View’ button and dropdown 54. The ‘View’ button 54 within the ‘All’ tab includes ‘View’, ‘Preview’, ‘Get Code’ and ‘Delete’. ‘View’ allows the user to edit the Destination and all Campaigns published to that Destination. ‘Preview’ allows the user to open the dynamic and live Campaign preview that is actively published to that Destination. ‘Get Code’ provides the Campaign builder Destination script, allowing the user to copy and place it into their desired website platform to publish Campaigns to it, the Destination Link, and the View Destination Link. ‘Delete’ allows the user to delete the Destination.

Tools above and duplicated below the grid and list allow users to see the total number of Destinations, search and sort all Destinations by Date, Days Live, Destination Name, Total Clicks and Projected Revenue. The user can sort any and all resulting in ascending or descending order by clicking a triangle to the right of the ‘Sort by’ dropdown. The user can also page through previous and next Campaigns in groups of six or by All by selecting ‘View All’. The Destinations 18 category also includes Destination and Campaign Insights. Campaign Insights are shown beneath each thumbnail 52 as Total Clicks and Projected Revenue. Insights are custom coded as Analytic Events also pushed and tracked in the Analytics program. Projected Revenue is derived by Total clicks multiplied by Conversion Rate multiplied by Average Order Value.

To the left of the ‘View’ button 54, the user can click ‘More Insights’ 44 which allows the user to view Campaign or Latest Version Insight Totals. While Campaigns totals tabulate all Versions within a single Campaign, Version Totals show only the latest Version's Totals. Within each Campaign and Version Totals, a right pane tool bar can include, for example, the following Insights: Projected Revenue, Total Clicks, Unique Clicks, Visits, Click Revenue, Average Order Value, Conversion Rate, Transaction and Per Visit Value. Above the Insights shows a large thumbnail of the Campaign that the user can click to open a dynamic live preview popup 58 of the Campaign. The ‘Destination’ category grid view also includes multiple ‘View by’ facets. The facets include view by Campaign or Version totals. Within the view by Campaign Totals, the user can sort by Campaign Totals or the most recent Version of the Campaign. Within the view by Version Totals, all Campaign versions in the grid are shown, and the user can sort by all Version totals. The user can sort any and all results in ascending or descending order. Subsequent ‘Destination’ and ‘View’ screens and the ‘New Destination’ button in the primary navigation are describe further below.

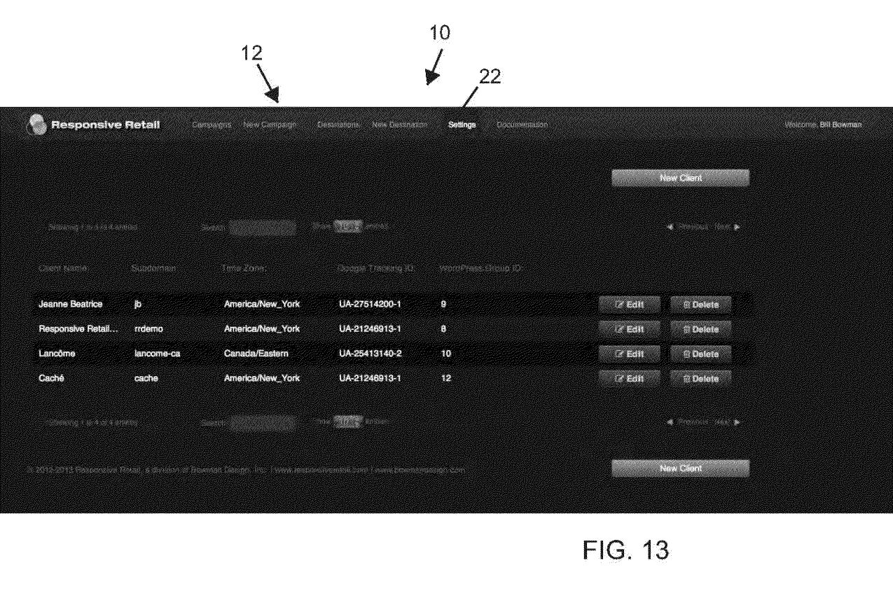

Looking to FIG. 13, one sees a screenshot of a user interface for the dynamic website Campaign builder 10 showing the Settings tab 22 selected to cause the graphic user interface of the computing device to display the Settings screen. Within this screen, administrators can add, modify, and delete client Settings. Clients can only add, modify and delete Color and Type Settings. Settings are defined as key dynamic variables that are stored in a Database, such as an open source database. The variables include needed information for hosting setup and configuration as well as variables that enable and disable functionality like Color and Type. Within the table index includes the Client's Name, Subdomain (i.e. client-name.responsiveretail.com), Time Zone, user identifications (Google Tracking ID and WordPress GroupID in this instance), an Edit button, and a Delete button. It will be understood that the tools above and duplicated below the grid and list allow users to see the total number of Clients, search and page through previous and next pages of Clients in groups of ten or by ‘All’ by selecting ‘View All’. When the admin clicks the ‘Edit’ button, they can add and edit Settings for Client information, Templates, Responsive Design, Color, Type, Defaults, and Messages.

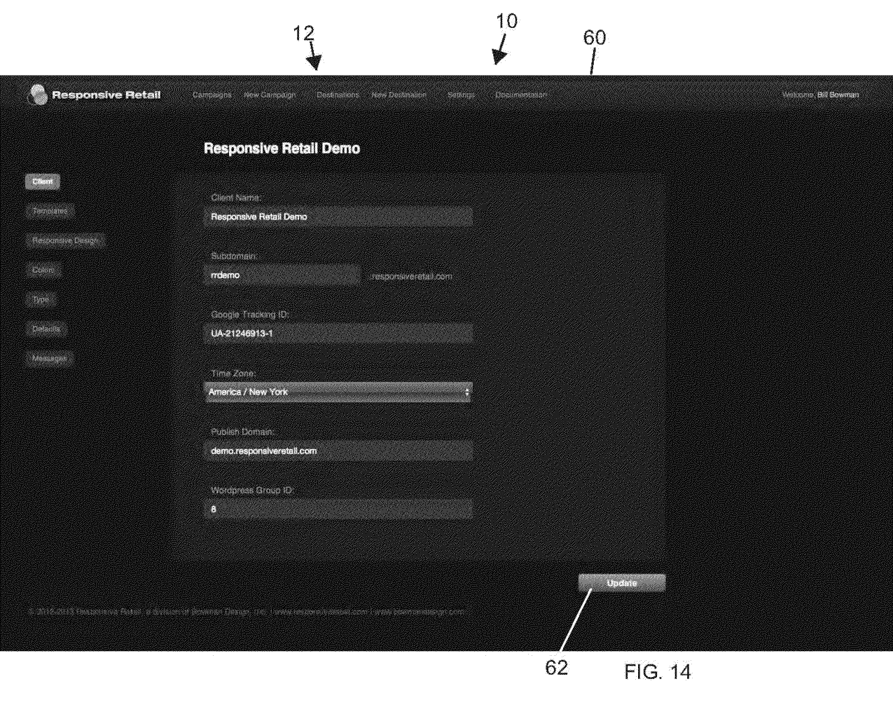

A screenshot of a user interface for the dynamic website Campaign builder 10 showing the Settings—Client Update screen 60 is provided in FIG. 14. On this screen 60, the administrator can add and edit the Client Name, Subdomain, user identifications (Google Tracking ID and WordPress GroupID in this instance), Time Zone, and Publish Domain. Clicking the ‘Update’ button 62 applies and saves the Settings to the database. The WordPress GroupID connects the Campaign builder 10 application to the marketing website, providing managed, role-based access to administrators to allow customers to login to the Campaign builder 10 application from the Internet.

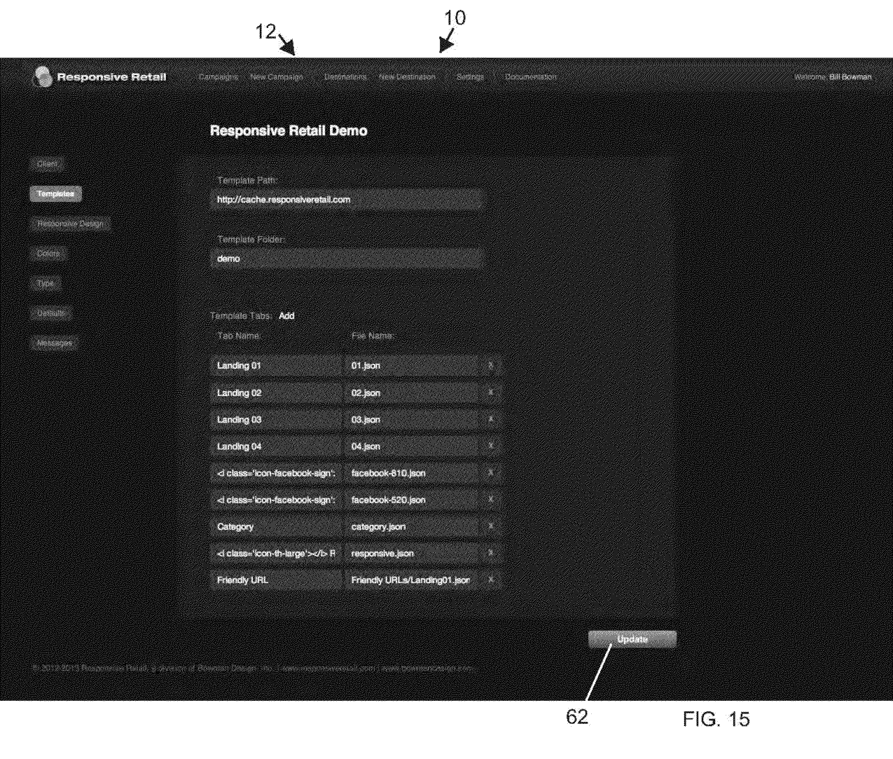

FIG. 15 provides a screenshot of a user interface for the dynamic website Campaign builder 10 showing the Settings—Template Update screen 64. On this screen 64, the administrator can add and edit Template Path and Template Folder and dynamically add any number of Template Tabs, including Tab Names and Template File Names to the customer's usage of the Campaign builder 10. All Campaign builder 10 functionality is independent and separate from the Templates, and all functionality can be applied to any of the Templates and Template Positions that are coded in custom JSON as a template structure. The JSON templates simply declare whether the template is fixed width or responsive design, how many positions there are, whether the positions are Hero Sliders or Single Instance Promotions, and their placement and width and height. Clicking the ‘Update’ button 62 applies and saves the Settings to the database.

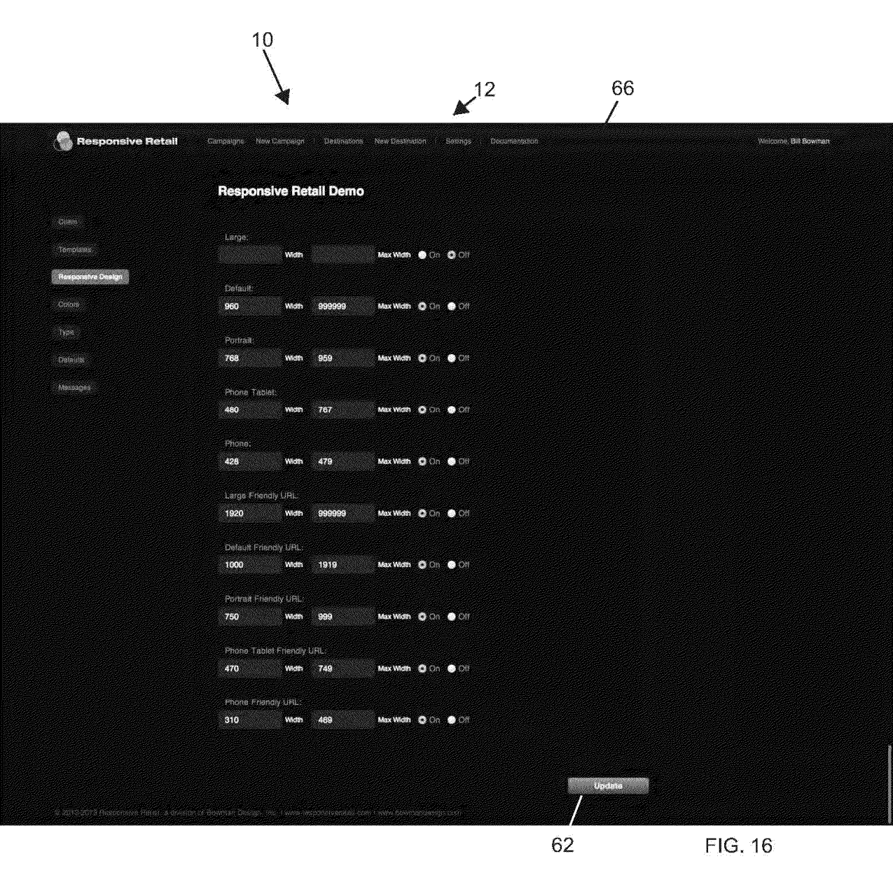

Looking to FIG. 16, one sees a screenshot of a user interface for the dynamic website Campaign builder 10 showing the Settings—Responsive Design Update screen 66. On this screen 66, the administrator can add and edit Responsive Design pivot Widths and Max Widths for both Responsive Design Templates and Responsive Design Friendly URL Templates. Responsive Design Templates are for Campaigns to be published to and within another website. Friendly URL Templates are standalone Campaigns with their own Friendly URL that the retailer/user can send their customers directly to for browsing the Campaign. Pivots are the widths that change the size of the Campaign per device size. The Campaign builder 10 disclosed herein has made this process dynamic and editable. Clicking the ‘Update’ button 62 applies and saves the Settings to memory within the database.

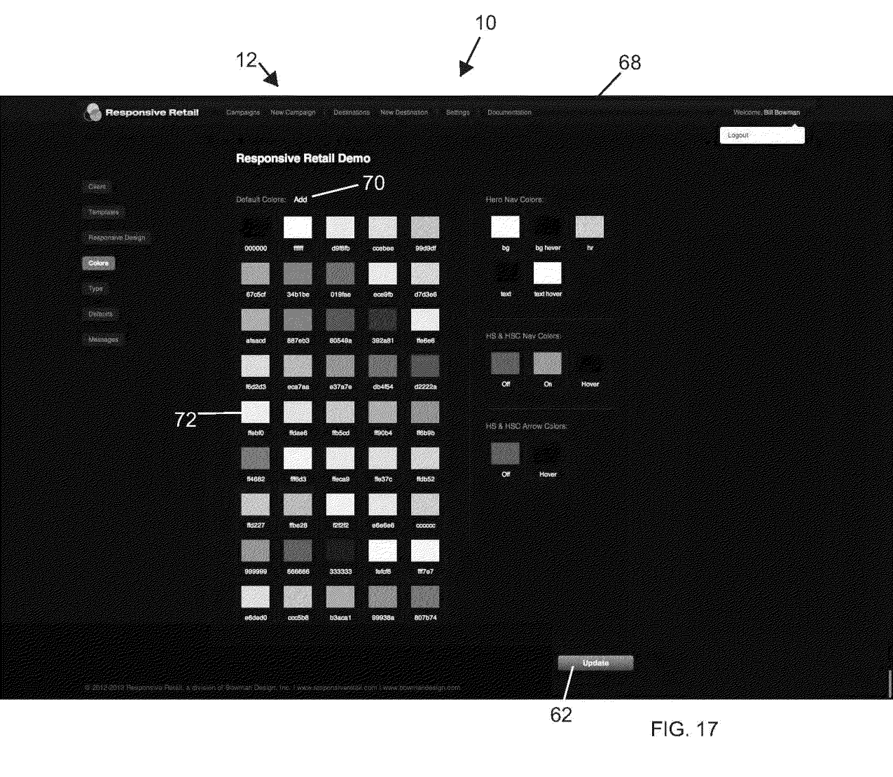

In FIG. 17, a screenshot is provided of a user interface for the dynamic website Campaign builder 10 showing the Settings—Color Update screen 68. On this screen 68, both the administrator and users can add, modify and delete any number of colors to a library, which colors are then available within the administrator's color dropdown and become default colors to the Hero Navigation Colors, Hero Slider {HS} and Hero Slider with Carousel {HSC} Navigation and Arrow Colors. Clicking ‘Add’ 70 at the top right will add a color to be edited to the bottom of the color boxes 72. Clicking any color box 72 launches a color edit screen with a larger color box to select the shade of the color and a color slider to select the color. RGB, HSB and Hex color values are also available for color selection and editing. Once the user clicks the bottom right color wheel, the color is applied. If the user hovers over any color, an ‘X’ shows up in the top right corner of the color box 72, allowing the user to delete the color. The defaults for Hero Nav, HS and HSC are on the right of this screen next to the larger color library to the left for the administrative color drop down. Clicking the ‘Update’ button 62 applies and saves the Settings to the database as disclosed herein.

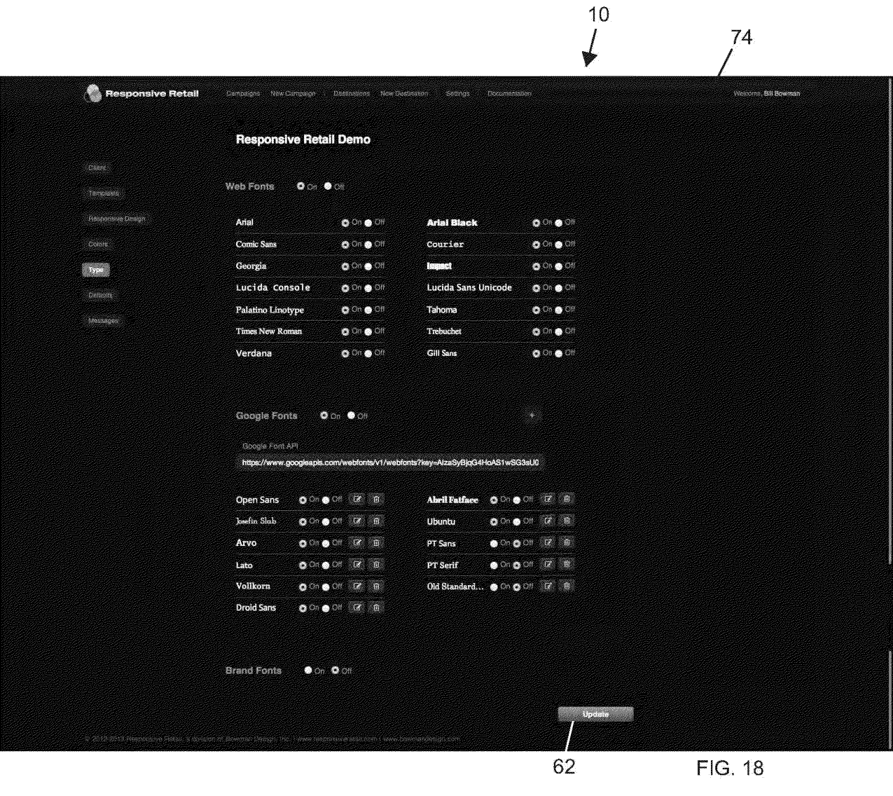

With further reference to FIG. 18, one sees a screenshot of a user interface for the dynamic website Campaign builder 10 showing the Settings—Type Update screen 74. On this screen 74, there are three types of fonts that can be edited: Web, Google, and Brand Fonts. All font names are visually displayed in that font so the user can see what they look like. The user can turn Web Fonts on or off. Under Google fonts, the user can set their Google font API key, turn fonts on or off, and add, edit or delete any number or all Google fonts. Brand Fonts are only able to be edited by the Administrator and require a customization per each client. Brand Fonts connect directly to an external font library, such as that found at the website Fonts.com, and afford a customer the usage of any or all of the library's catalogue. Clicking the ‘Update’ button 62 applies and saves the Settings to the database as disclosed herein.

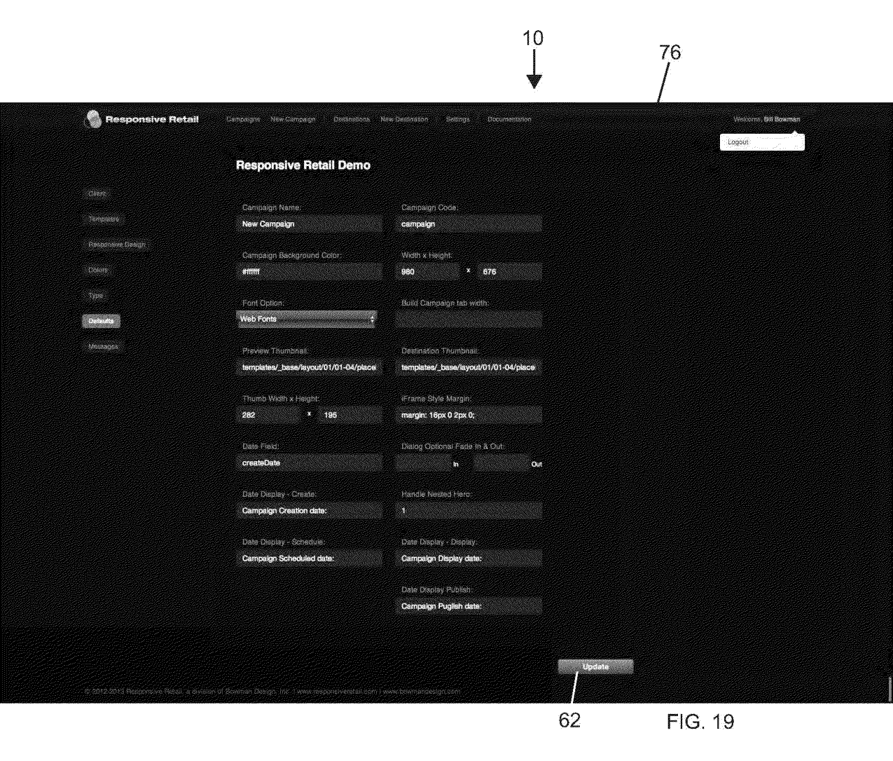

In FIG. 19, one sees a screenshot of a user interface for the dynamic website Campaign builder 10 showing the Settings—Default Update screen 76. This screen 76 allows the administrator to configure all of the Campaign builder's default settings including Campaign Name, Campaign Code, Campaign Background Color, Width×Height, Fonts Options, Build Campaign Tab Width, Preview Thumbnail, Destination Thumbnail, Thumb Width×Height, iFrame Style Margin, Date Field, Dialog Optional Fade In & Out, Date Display—Create, Handle Nested Hero, Date Display—Schedule. Date Display—Display. Date Display Publish. Clicking the ‘Update’ button 62 applies and saves the Settings to the database.

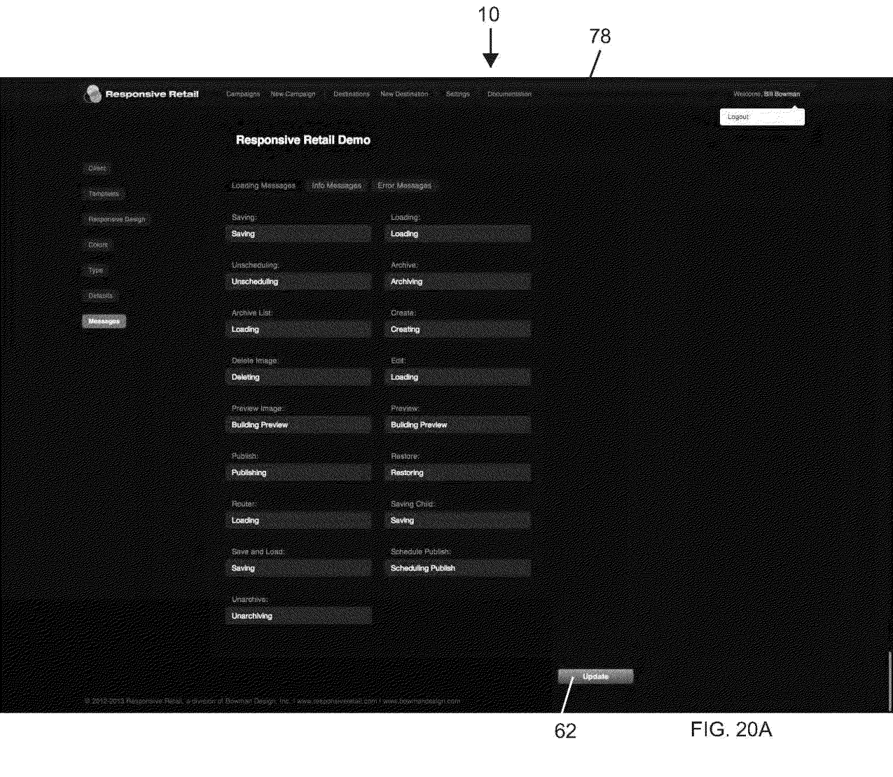

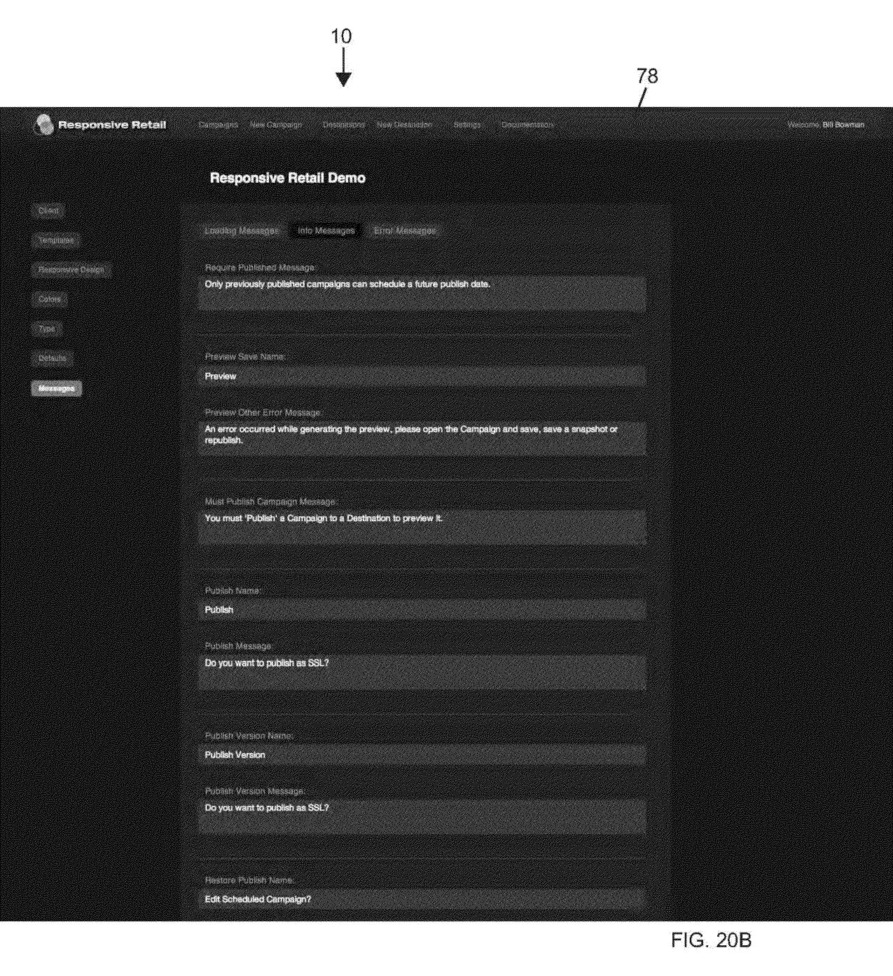

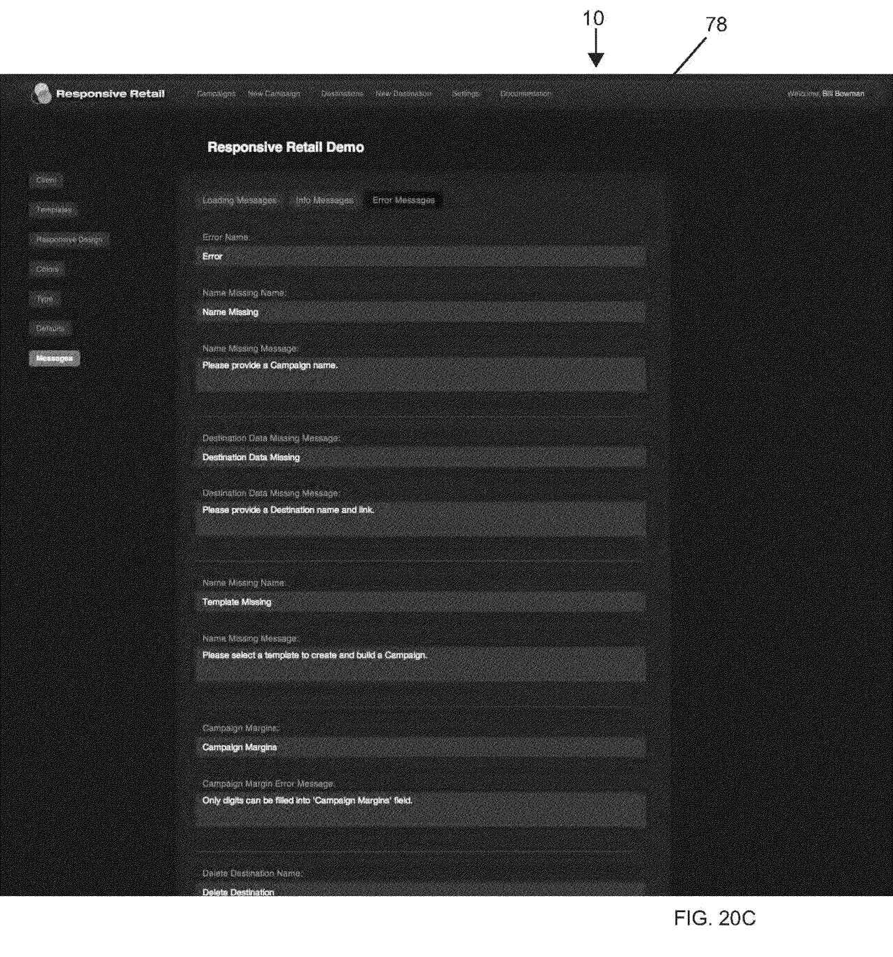

FIGS. 20A through 20C are screenshots of a user interface for the dynamic website Campaign builder 10 cooperating to show the Settings—Messages Update screen 78. This screen 78 allows the administrator to edit all Loading, Info and Error Messages displayed to the user throughout the Campaign builder 10 when in use. Clicking the ‘Update’ button 62 applies and saves the Settings to the database disclosed herein.

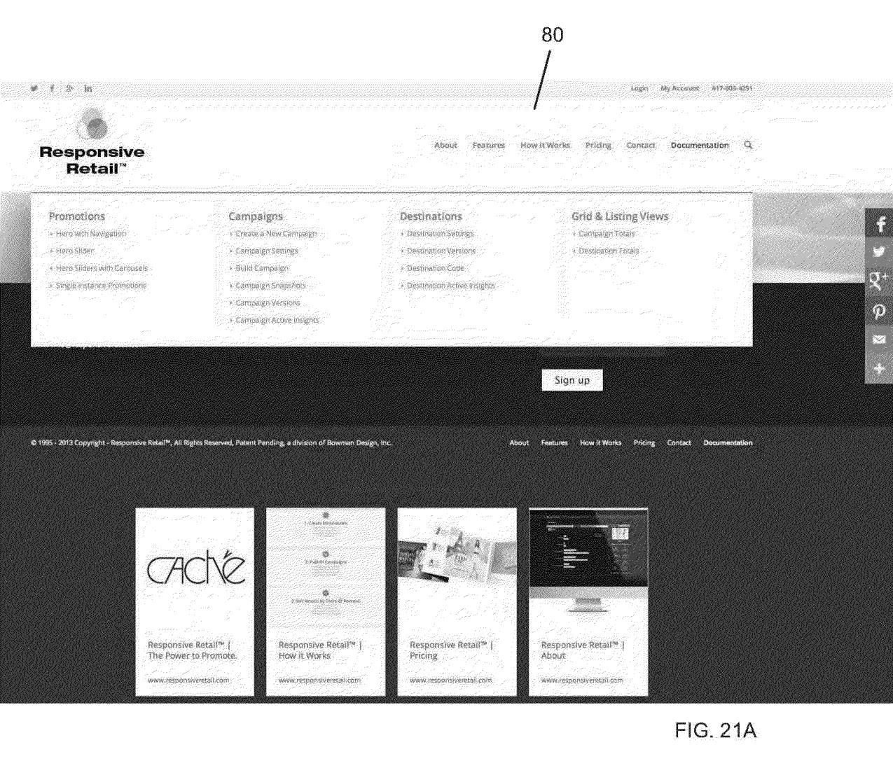

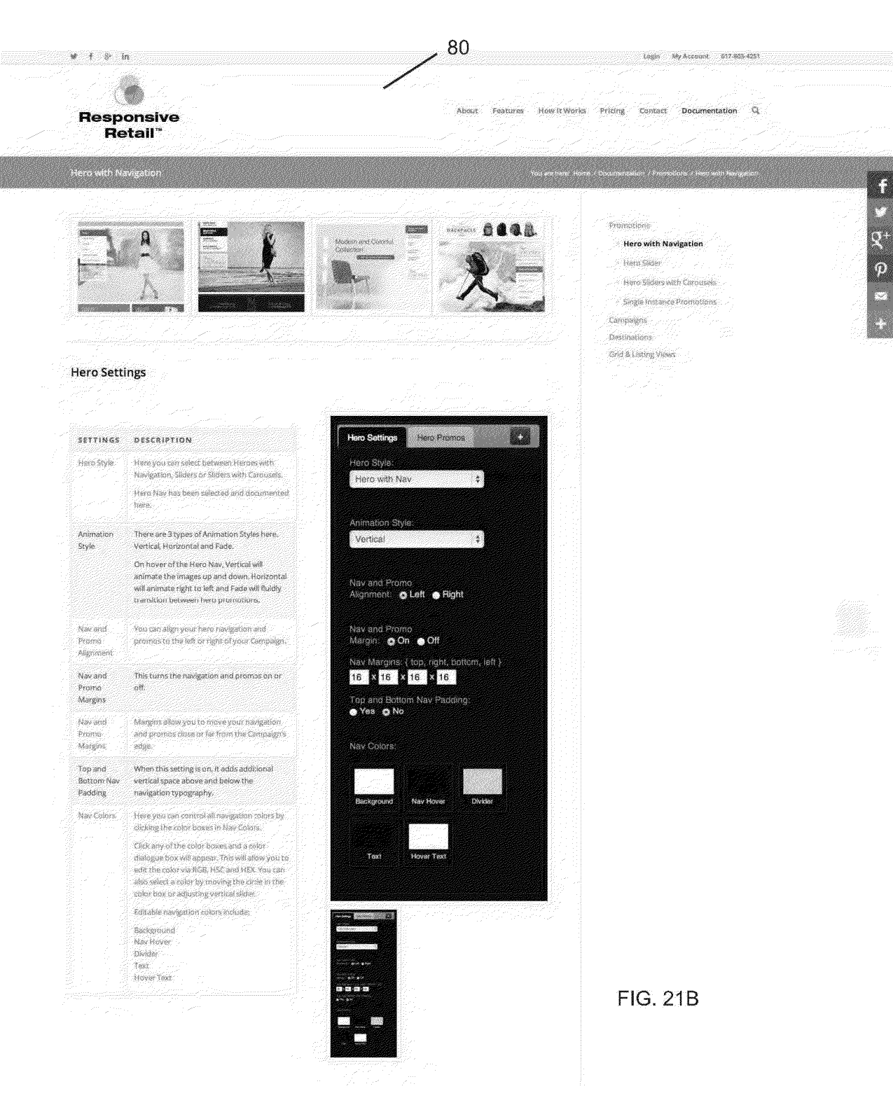

FIGS. 21A and 21B are screenshots of a user interface for the dynamic website Campaign builder 10 showing the online Documentation screen(s) 80 for being displayed on a computer display of a computing device. Within these screens 80, the user can read how-to directions along with definitions of all functionality of the Campaign builder 10 disclosed herein.

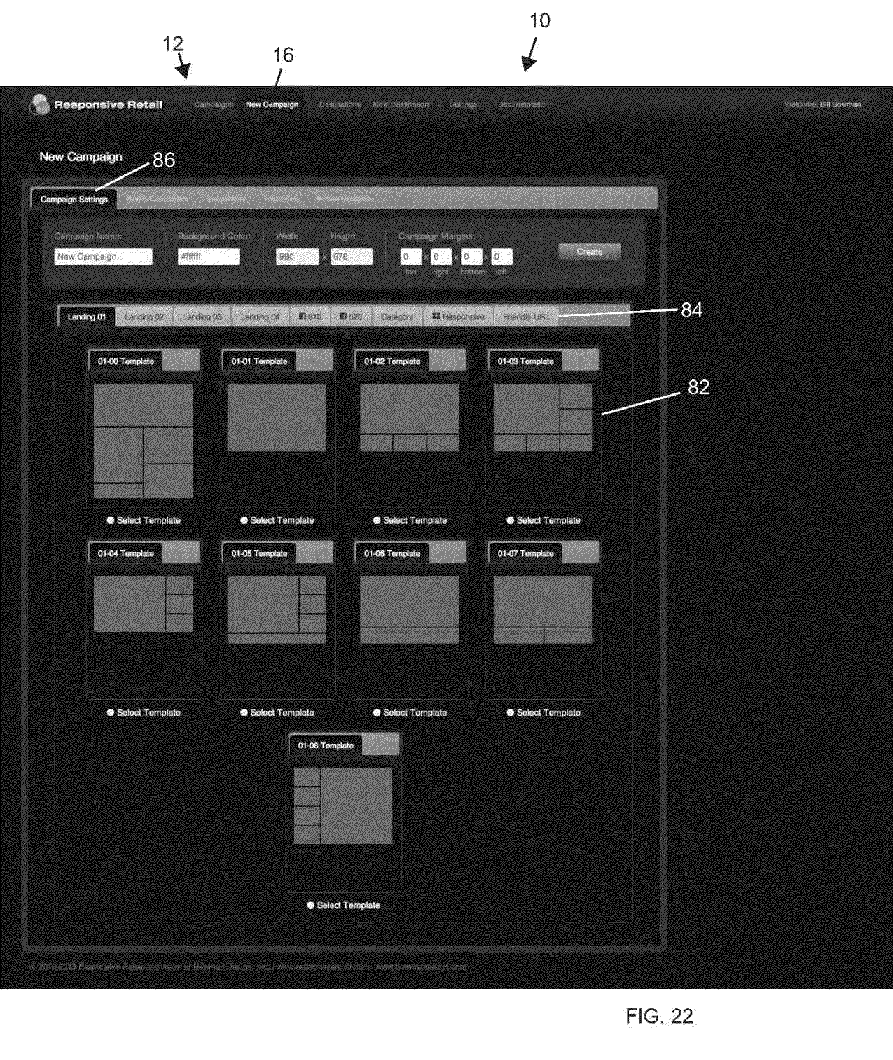

A screenshot of a user interface for the dynamic website Campaign builder 10 showing the Create New Campaign screen as triggered by a selection of the New Campaign tab 16 in the Primary Navigation menu 12 is shown in FIG. 22. Here, the user can create a new campaign setting under the campaign settings tab 86 by entering the Campaign Name and the Background Color with Width×Height determined by the template 82 selected. Next, the user can set the Campaign's Top, Right, Bottom and Left margins, and Campaign settings can continue to be edited, post-Campaign creation, except for the selection of the template 82 itself. The user can select a template 82 from a variety of schematically depicted templates 82, and the template 82 can be customized per client and could include, for example, the following template tabs 84: Landing 01, Landing 02, Landing 03, Landing 04, Facebook 810, Facebook 520, Category, Responsive and Friendly URL Templates. Each template tab 84 can contain unlimited numbers of templates 82. The templates 82 of the Campaign builder 10 are built with Positions that can be customized, creating unique placements and look and feel of the user's Campaigns. The Campaign builder 10 can declare, within the templates 82, whether it is a fixed width or responsive design, how many positions, their placements, position widths and whether the positions are Heroes or Single Instance Promotions. As noted previously, there are two types of Positions, which are referred to herein as Heroes and Single Instance Promotions.

Heroes and Promotions can include images, image maps, sliders, links, event tracking tags, such as Google event tracking tags, CSS transform animations, and videos. As used herein, heroes are larger promotions that can contain multiple promotions and can, for example, be created into three different styles of sliders, namely, Hero sliders with typographical navigation, Hero sliders with element navigation like shapes and arrows, and Hero sliders with custom thumbnail carousels, navigation, and arrows. Single Instance Promotions are smaller, non-slider, Positions that are supportive to Heroes. Sliders are slide shows of multiple promotions. After the user enters all options and selects a template 82 by clicking the radio button beneath the desired template 82 as in FIG. 22, the application takes the user to the ‘Build Campaign’ tab to construct the template 82 into a Campaign as disclosed herein.

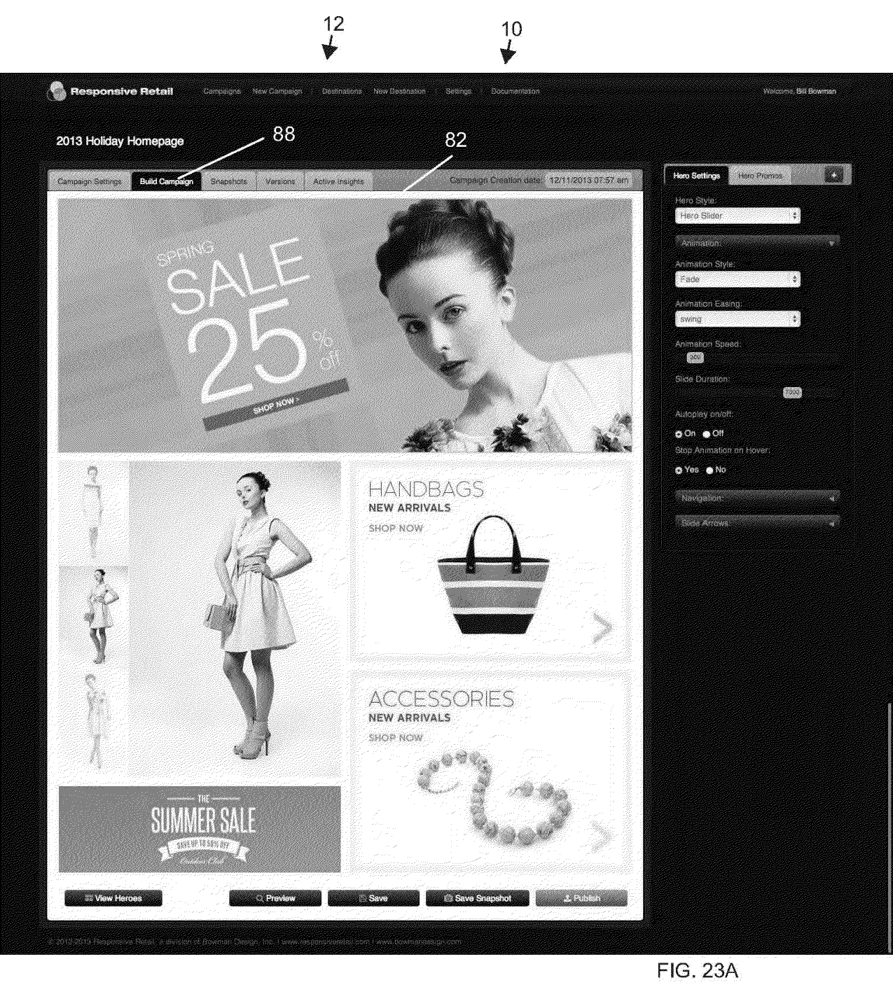

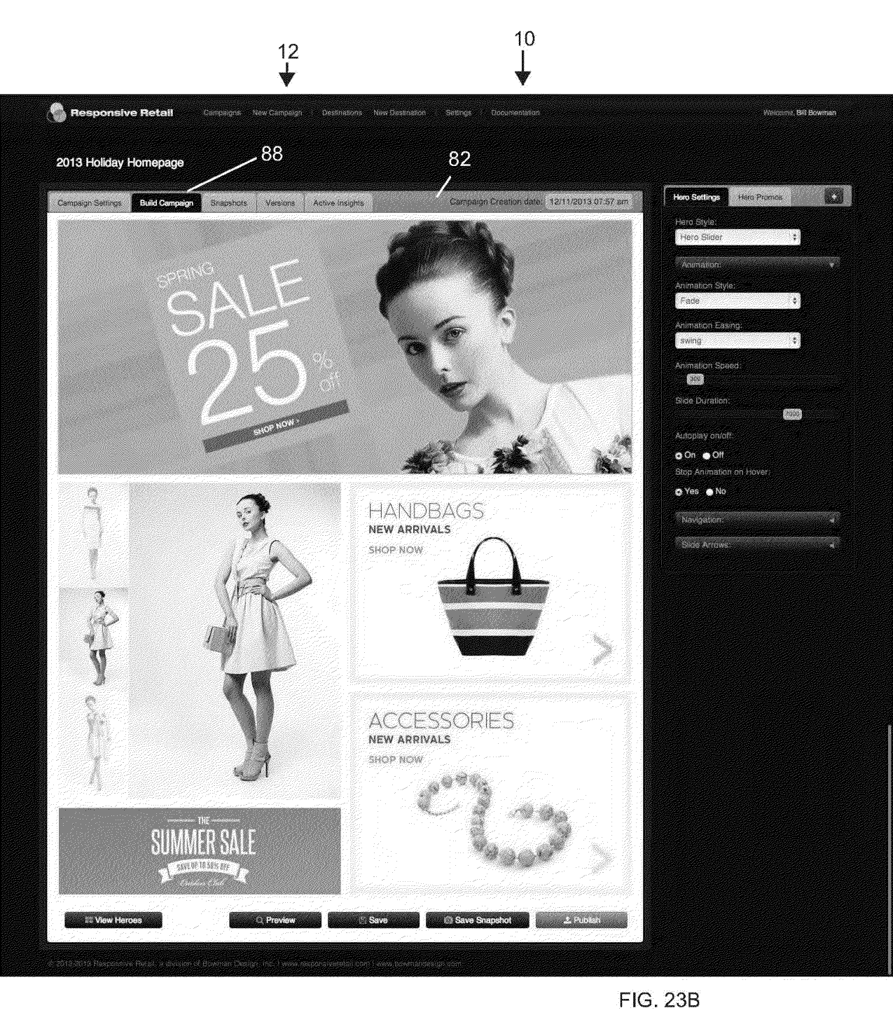

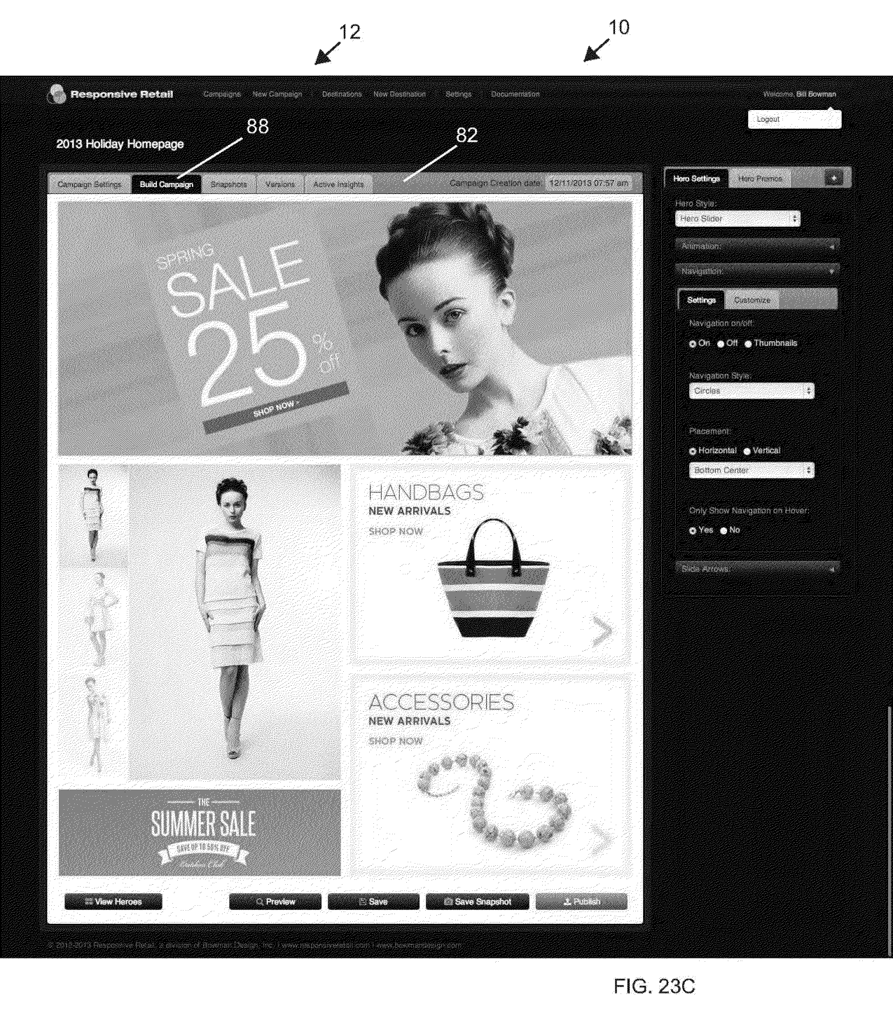

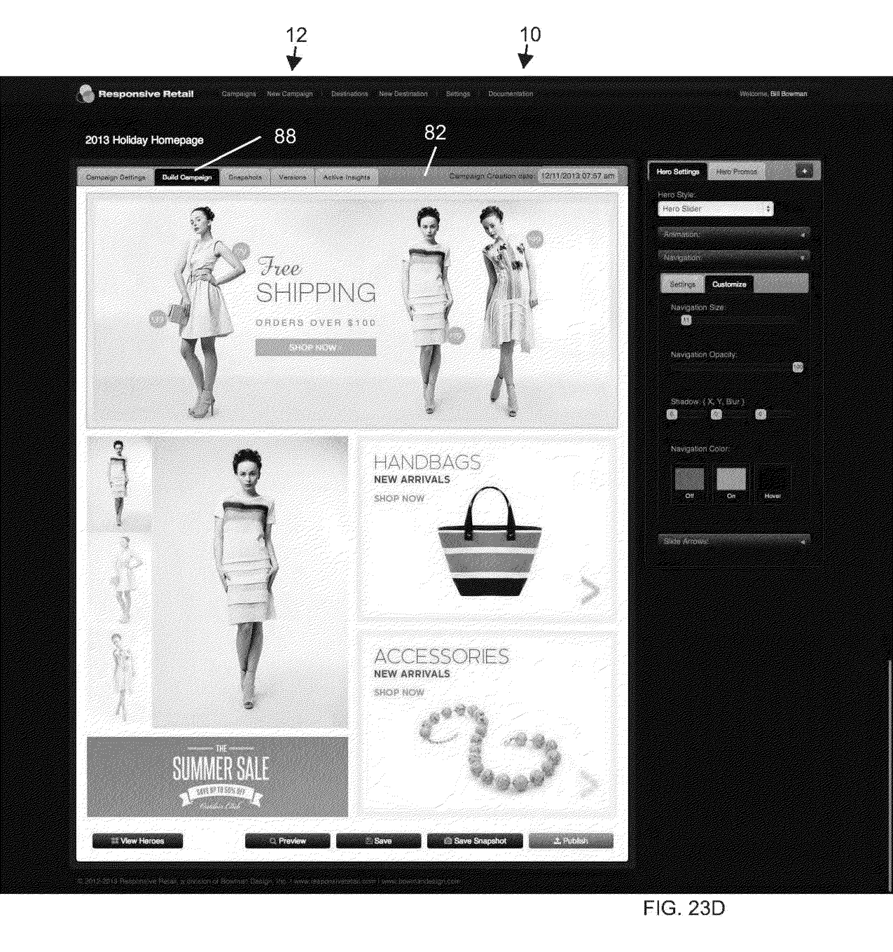

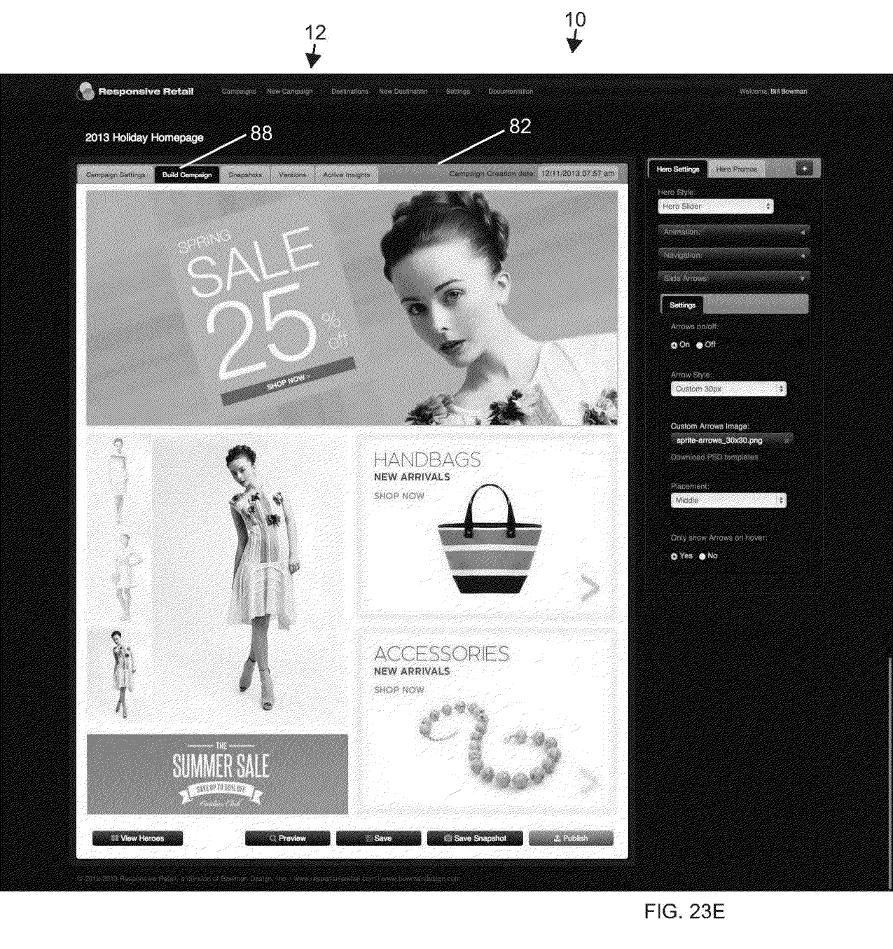

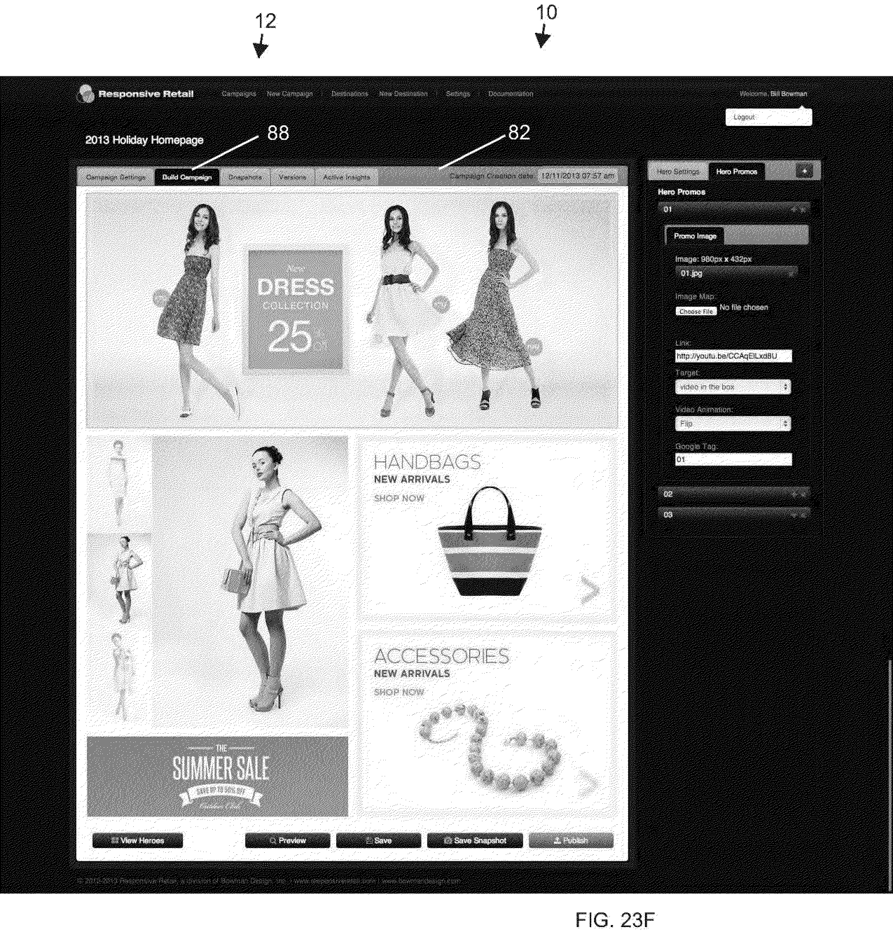

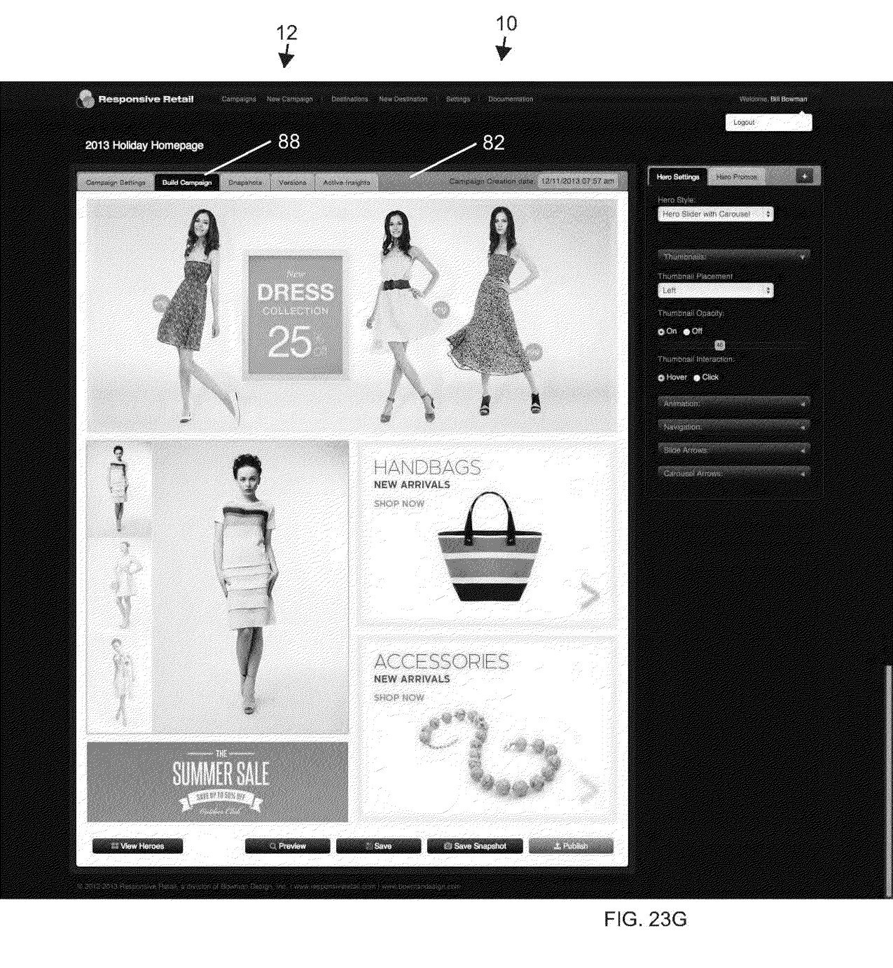

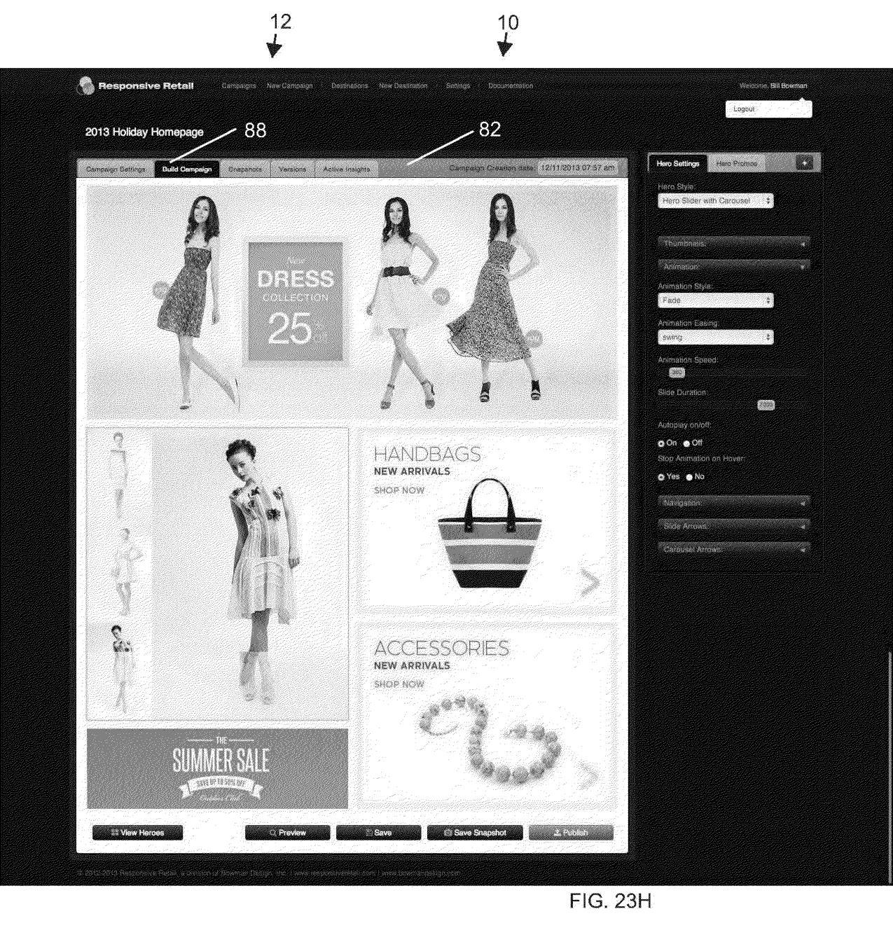

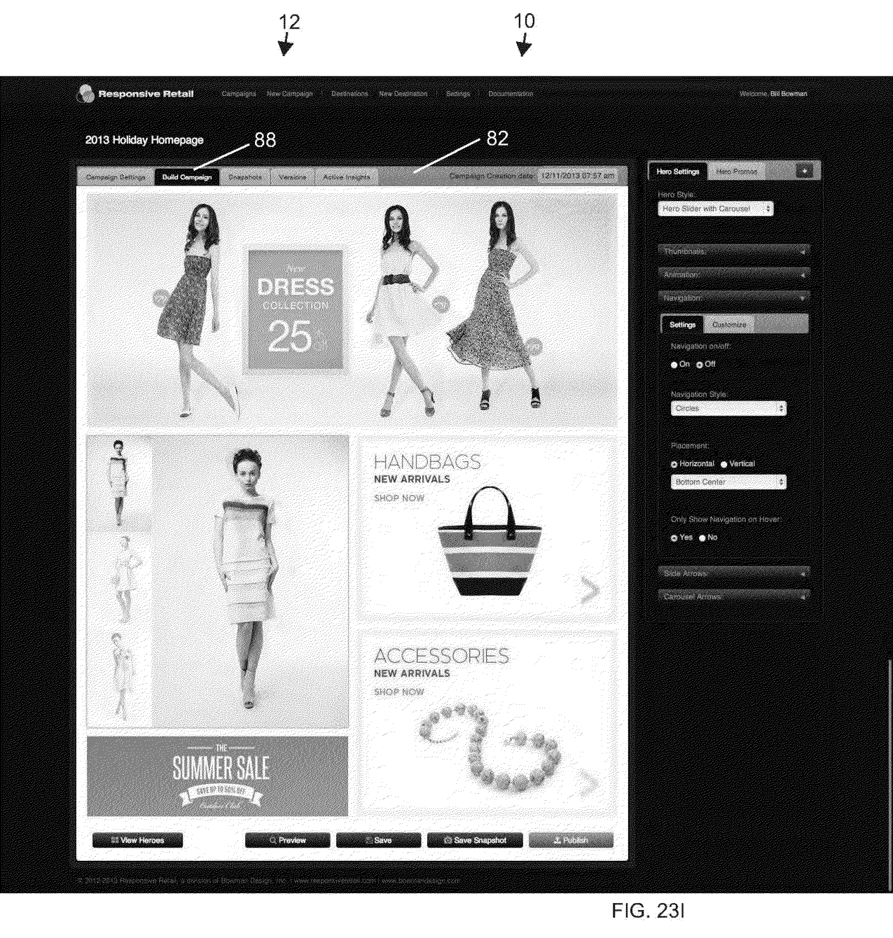

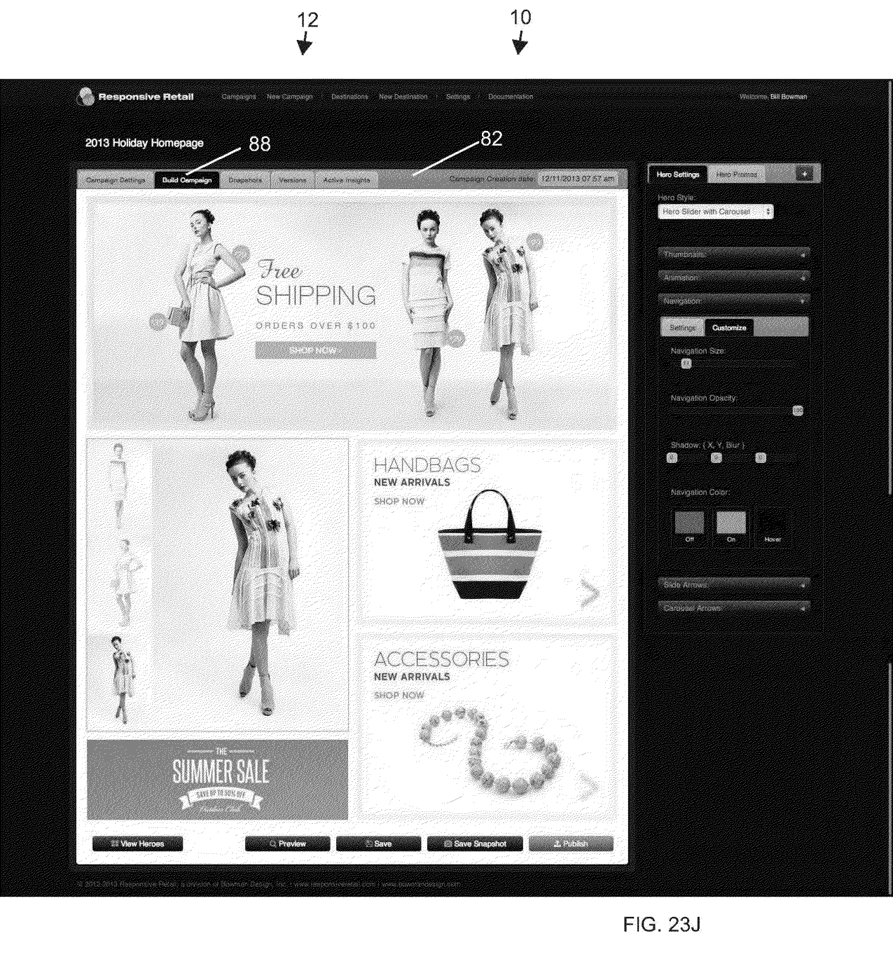

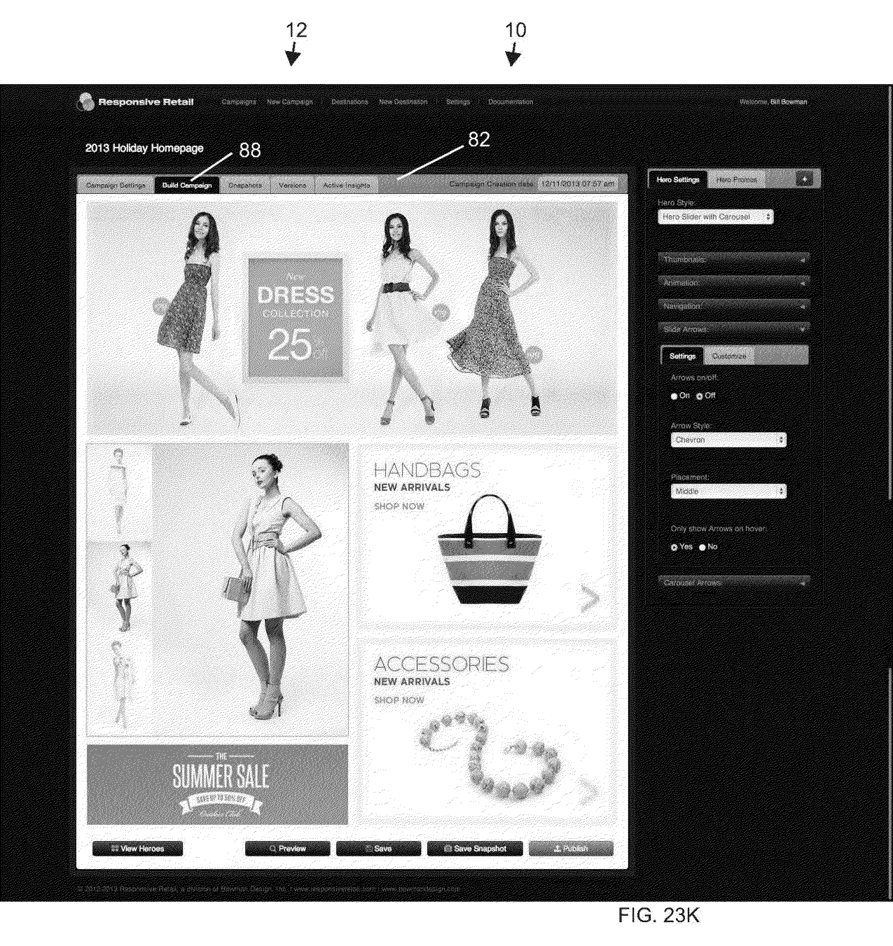

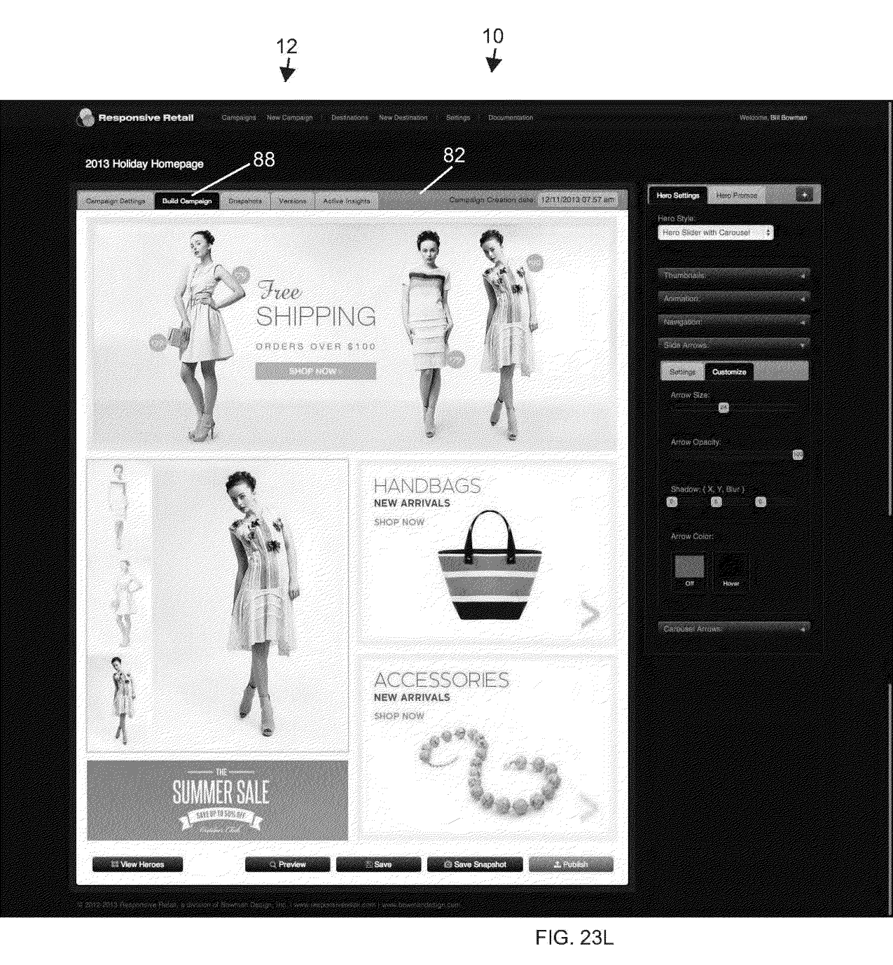

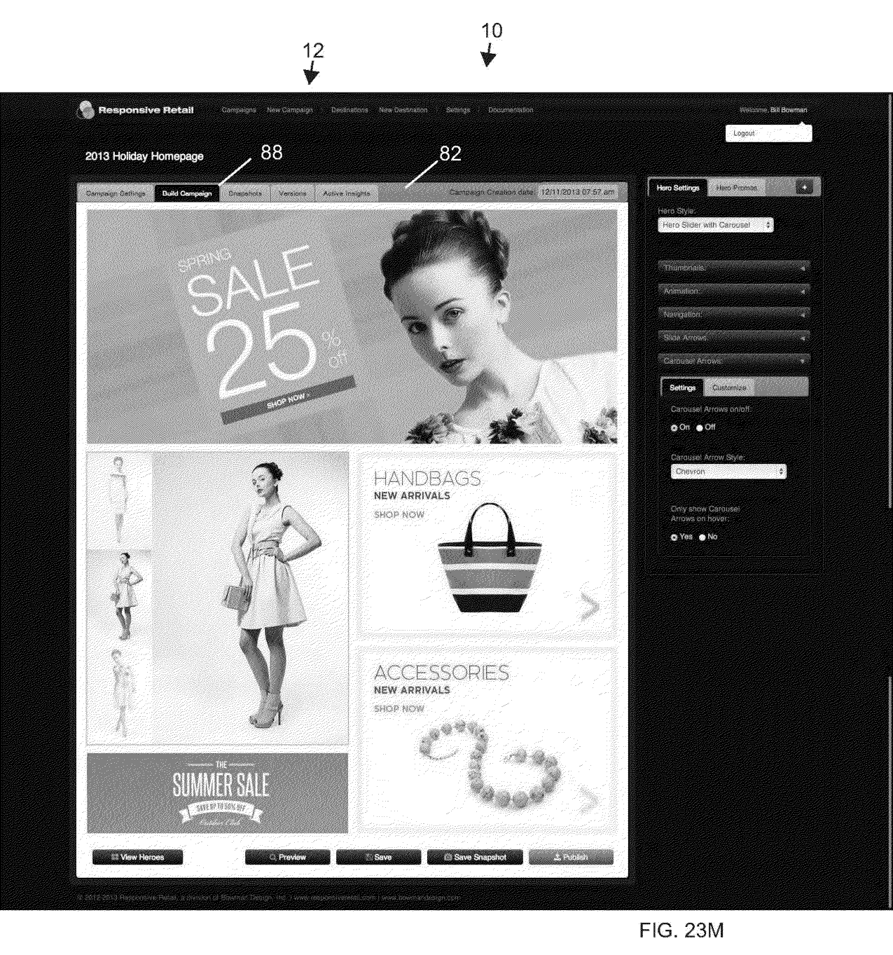

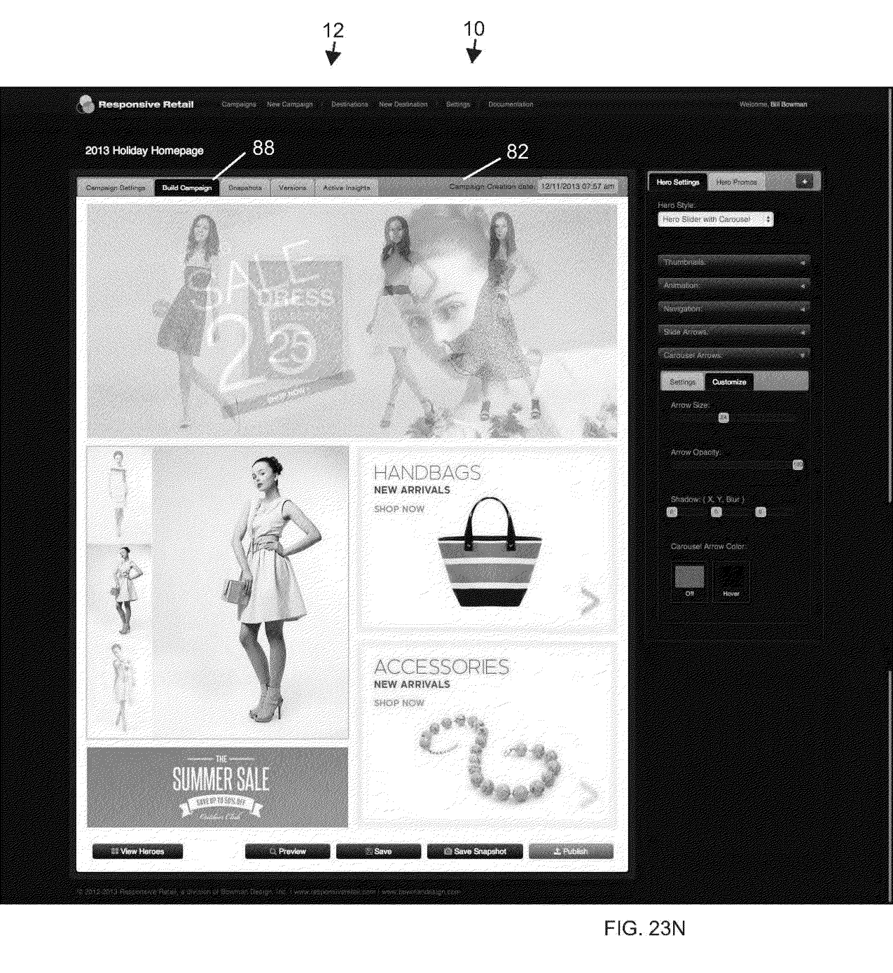

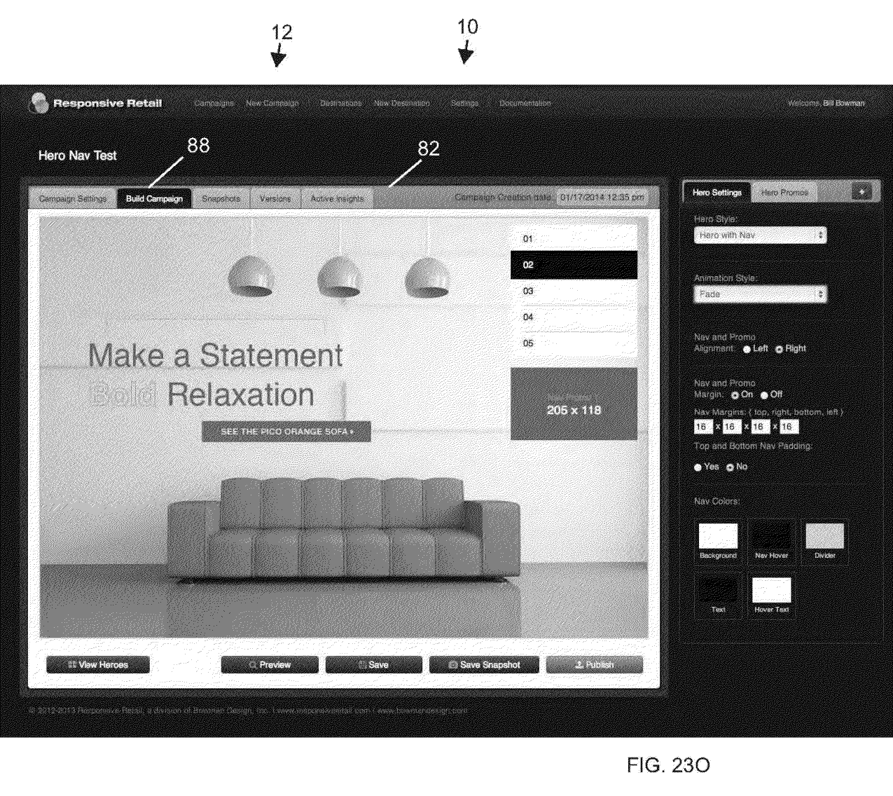

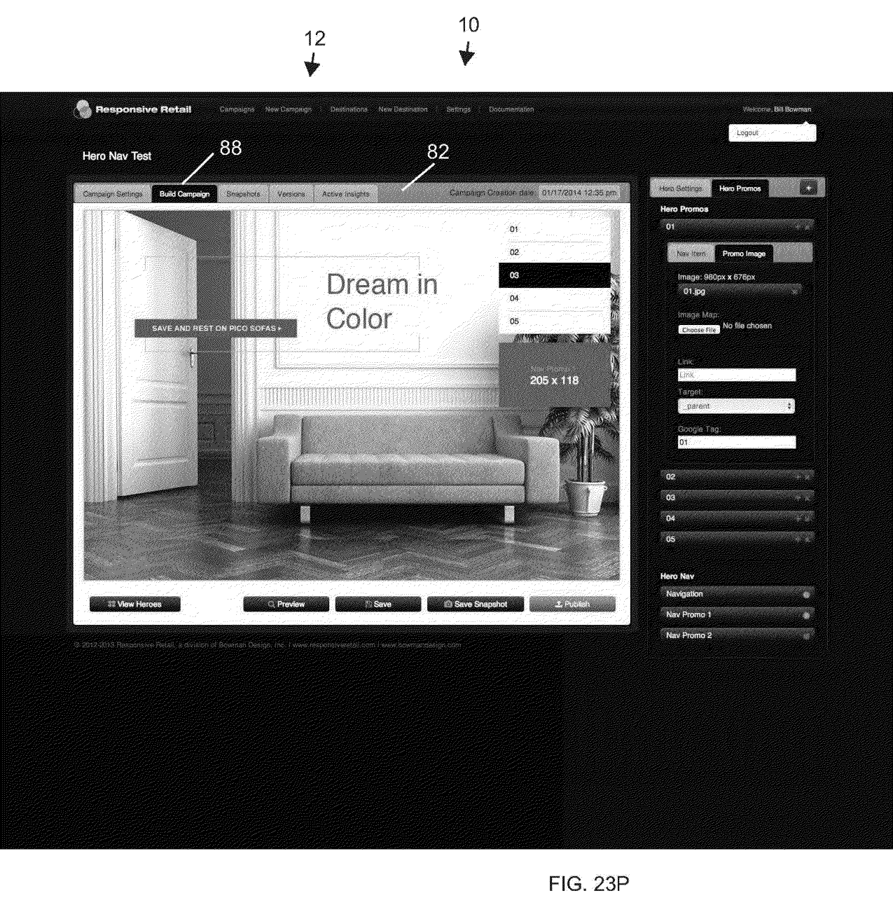

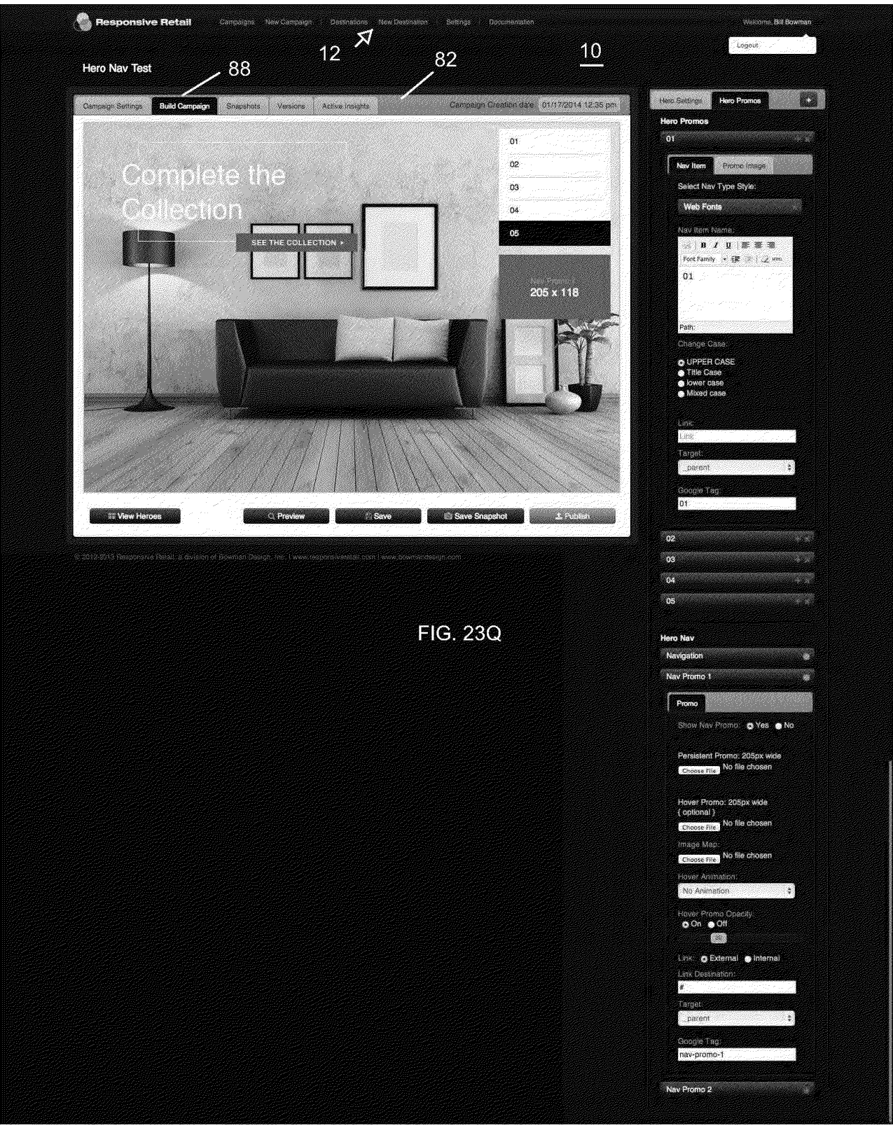

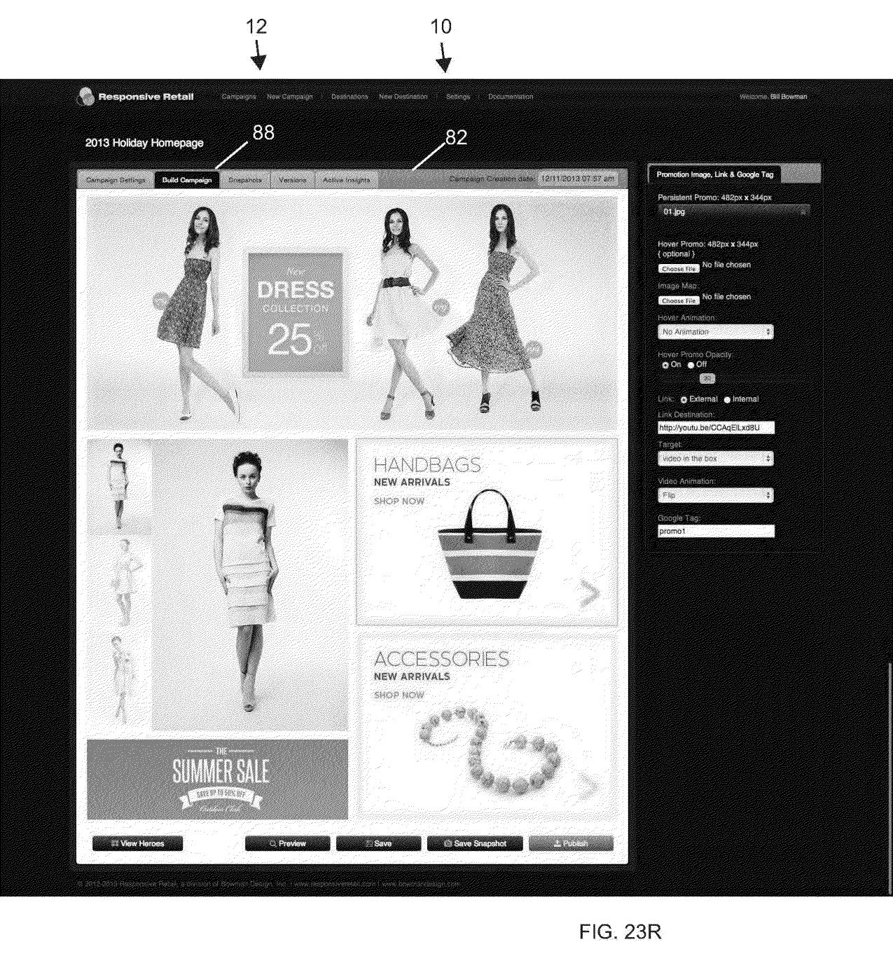

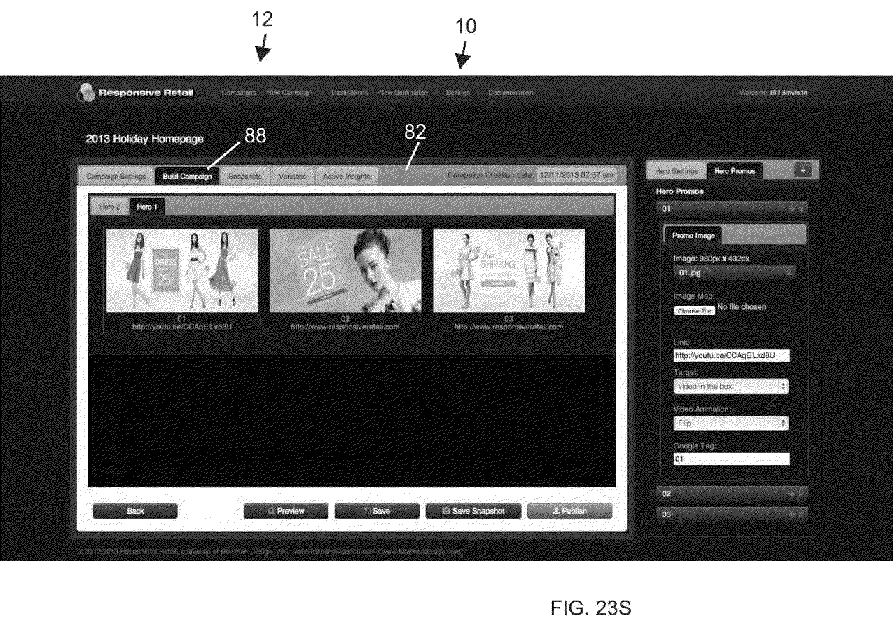

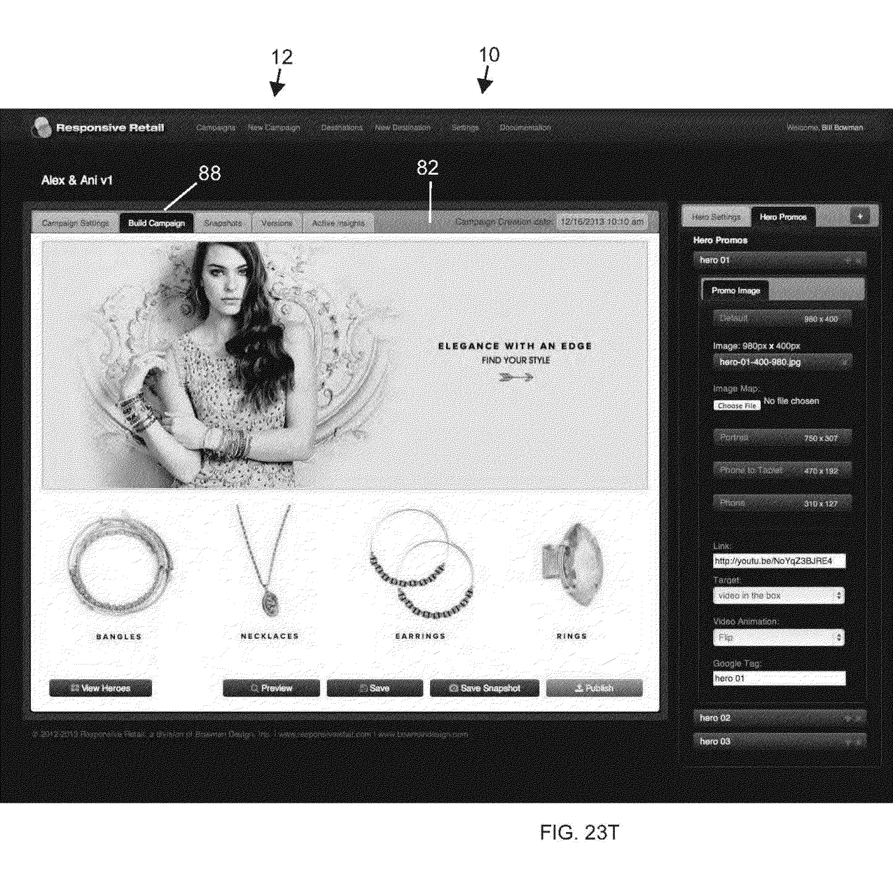

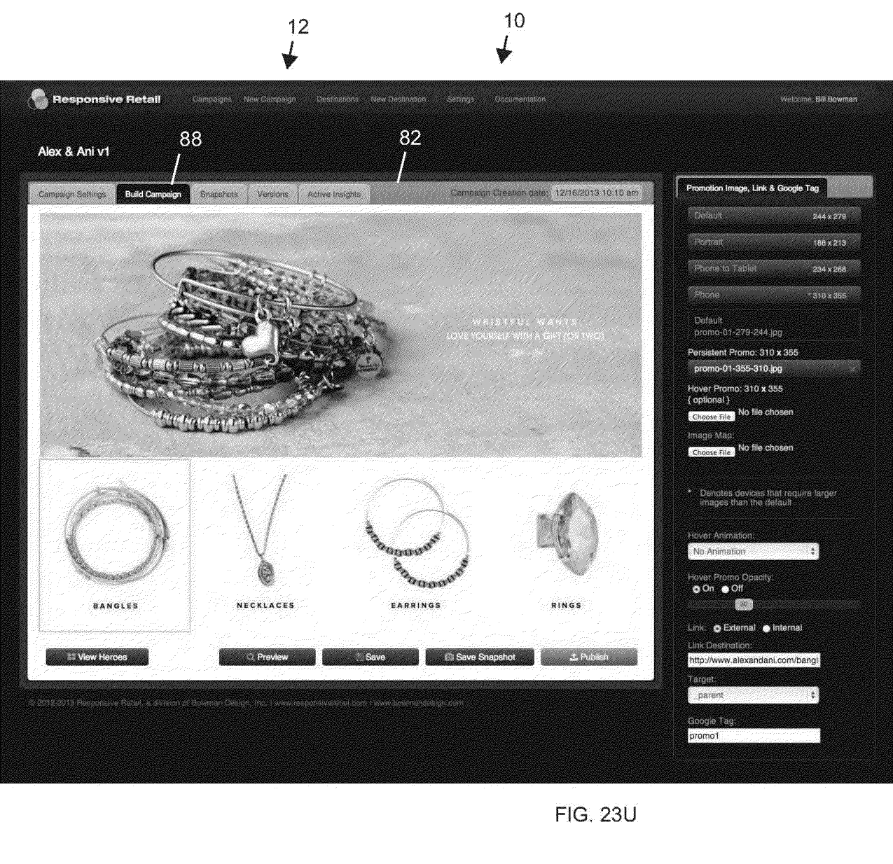

FIGS. 23A through 23U are screenshots of a user interface for the dynamic website Campaign builder 10 showing the Campaign Edit, Build Campaign Screen as selected by the Build Campaign tab 88 in use. On this screen, the user can drag-and-drop image assets from their computer directly to the positions on the Template 82 for immediate upload, placement, and viewing. The Build Campaign tab 88 shows all Template positions and the required width and height of each position. It is thus a Digital Wireframe for the Campaign builder 10.

Users can drag-and-drop multiple images, one after each other to continue to build the number of promotions or slides within a Hero Slider. In the top right hand corner is the date of creation. Depending on if the user clicks a Hero or a Promotion Position, that position is highlighted with a green outline denoting selection, and the right pane tool bar reflects different settings and options for each selected position. If the user has clicked a Hero, the right pane tool bar has two tabs, namely, Hero Settings and Hero Promos, along with a ‘+’ button as an alternative way to add additional Heroes as compared to drag-and-dropping image assets. Under the Hero Settings, the user can select three different types of Heroes, including, Hero Nav, Hero Slider, and Hero Slider with Carousel. Under the Hero Promo, the user can drag-and-drop the Heroes in any order by clicking and moving the Hero badge up or down, above or below other heroes. Within each Hero badge under the Hero Promos tab, are the following settings: Image Size requirements dynamically listed per selected position, Image Upload, Image Map Upload, Link, Target, Video Animation Style and Tag, such as be Google tagging.

For Image Upload, in addition to dragging-and-dropping the image, the user can select ‘Choose File’ and navigate to their desktop to select an image to upload, or the user can drag the image right from their desktop and drop the image on the ‘Choose File’ button. For Image Map Upload, the user can upload any image map and the Campaign builder 10 will parse the image map code into a dynamic image map of links for usage with the associated Hero Promo. For the Link setting, the user can specify the base link for the Hero Promo that the end-user is taken to in response to a click. If the Hero Promo has both a Link and an Image Map, the Image Map Links will lie above the base link.

For Targets, the user can select _blank, _self, _parent, _custom, the video insertion program Video in the Box, and the video insertion program Video Lightbox offered at videolightbox.com. Selecting _blank, opens the linked document in a new window or tab. Selecting _self opens the linked document in the same frame as it was clicked. Selecting _parent opens the linked document in the parent frame, which is the default. Selecting _custom allows the user to apply custom target code. Video in the Box allows the user to place a video, such as a YouTube video, in the box with the following animation options that can occur between the Hero Promo and Video behind the Hero Promo on click of the Hero Promo: No Animation, Fade, and Flip. Video Lightbox allows the user to place a video, such as a YouTube video, that plays in a Lightbox above the Hero Promo on click of the Hero Promo. When the user selects the Video Lightbox target, the following animation placements are available, animating the Lightbox from the selected direction to the center of the screen: Top Left, Top Center, Top Right, Left, Center, Right, Bottom Left, Bottom Center, and Bottom Right. Tagging to an Analytic program, such as by use of the Google Tag input, leverages the custom Event Code to track all click events of the Campaign and Promotions, allowing the user to define how the Link click will be named and forwarded to the Analytics program (i.e. ‘RR Web {2013-12-26 v4}2013-12-30 3:00 AM EST’(what the user names the Google Tag will show up between the { }brackets) along with the RR Web declaration and the date and time.

At the bottom of the screen, beneath the Template Positions, are the following buttons: ‘View Heroes’, ‘Preview’, ‘Save’, ‘Save Snapshots’ and ‘Publish’. When the user clicks the ‘View Heroes’ button, they are taken to the View Heroes screen shown and documented below. The ‘Preview’ button opens the dynamic and live preview popup of the Campaign. The ‘Save’ button saves the Campaign. The ‘Save Snapshots’ button allows the user to save multiple variations of the Campaign with thumbnail preview. The ‘Publish’ button allows the user to publish immediately or schedule a publish time in the future to an iFrame or any number of Destinations disclosed herein; and

Looking more particularly to FIGS. 23A through 23E, screenshots are provided of a user interface for the dynamic website Campaign builder 10 showing the Campaign Edit, Build Campaign Tab 88 with a Hero Slider {HS}selected with settings shown in the right pane tool bar. When the Hero Style is set to Hero Slider, the following HS Settings are shown: ‘Animation’, ‘Navigation’, and ‘Slide Arrows’. Within ‘Animation’, the user can set the Animation Style, Animation Easing, Animation Speed, Slide Duration, Auto Play On or Off and Stop Animation on Hover Yes or No. Animation Styles include Vertical, Horizontal and Fade between Hero Promos. Animation Easing includes swing, easeInQuad, easeOutQuad, easeInOutQuad, easeInCubic, easeOutCubic, easeInOutCubic, easeInQuart, easeOutQuart, easeInOutQuart, easeInSine, easeOutSine, easeInOutSine, easeInExpo, easeOutExpo, easeInOutExpo, easeInQuint, easeOutQuint, easeInOutQuint, easeInCirc, easeOutCirc, easeInOutCirc, easeInElastic, easeOutElastic, easeInOutElastic, easeInBack, easeOutBack, easeInOutBack, easeInBounce, easeOutBounce and easeInOutBounce.

Within ‘Navigation’ there are two tabs: ‘Settings’ and ‘Customize’. In ‘Navigation’ ‘Settings’, the user can set Navigation On or Off or show Thumbnails on Hover. The user can choose Navigation Styles including Circles, Numbers and Squares, and the user can choose Placement, including Horizontal and Vertical options including Top Left, Top Center, Top Right, Bottom Left, Bottom Center, Bottom Right. Still further, the user can choose to Only Show Navigation on Hover, Yes or No. In ‘Navigation’ ‘Customize’ the user can set Navigation Size, Opacity, Shadow X, Y placement and Blur; and Hover Color options for Off, On and Hovers that are set site wide in the Primary Navigation ‘Settings’ section, but can be edited in the HS toolbar. Within ‘Slide Arrows’, there are two tabs, namely, ‘Settings’ and ‘Customize’. In ‘Slide Arrows’ ‘Settings’, the user can set Arrows On or Off. Arrow Styles can be selected including Arrow, Arrow in Circle, Angles, Caret, Chevron, Double Arrow, Hand, Custom 40px, 30px and 20px. Custom Arrow Images allow the use to upload a custom sprite based on, for example, a custom PSD Sprite Template of the Campaign builder 10. An image sprite can be a collection of images put into a single image. The user can also set the Arrow Placement including Top, Middle and Bottom and Only show Arrows on hover. In ‘Slide Arrows’ ‘Customize’, the user can set Arrow Size, Opacity, Shadow X, Y placement and Blur. Arrow Off, On and Hover Color options can be set in the Primary Navigation ‘Settings’ section as disclosed herein.

Looking now more particularly to FIGS. 23G through 23N, screenshots of a user interface for the dynamic website Campaign builder 10 showing the Campaign Edit, Build Campaign Tab 88 with a Hero Slider with Carousel {HSC} selected for the Template 82 with settings shown in the right pane tool bar. The HSC of the Campaign builder 10 dynamically reserves and minuses out from the positions size the area needed for a thumbnail carousel of all Hero Promos Vertically or Horizontally placed per the user's setting. The HSC contains all Hero Settings noted in the HS above in relation to FIGS. 23A through 23E, with the addition of ‘Thumbnails’ and ‘Carousel Arrows’.

In ‘Thumbnails’, the user can select Thumbnail Placement including: Top, Bottom, Left and Right; Thumbnail Opacity On and Off with a slider to select the degree of Opacity; and Thumbnail Interaction, Hover or Click. Within ‘Carousel Arrows’, there are two tabs ‘Settings’ and ‘Customize’. In ‘Carousel Arrows’ ‘Settings’, the user can set Carousel Arrows On or Off and Carousel Arrow Styles including Arrow, Arrow in Circle, Angles, Caret, Chevron, Double Arrow, Hand, Custom 40px, 30px and 20px. Custom Arrows Image allows the use to upload a custom sprite based a custom PSD Sprite Template as discussed above. The user can also set the Carousel Arrow's Placement including: Top, Middle and Bottom and Only show Arrows on hover. In ‘Carousel Slide Arrows’ ‘Customize’, the user can set Arrow Size, Opacity, Shadow X, Y and Blur and Arrow Off, On and Hover Color options set in the Primary Navigation ‘Settings’ section. The HSC option also adds a ‘Thumbnails’ tab next to the Promo Image tab within the Hero Promos tab. Here, the user can upload custom hero promo thumbnails and hover thumbnails.

With further reference to FIGS. 23O through 23Q, screenshots are shown of a user interface for the dynamic website Campaign builder 10 showing the Campaign Edit, Build Campaign Tab 88 selected to display a Template 82 with a Hero Nav {HN} selected with settings shown in the right pane tool bar. The HN right pane toolbar has two tabs, ‘Hero Settings’ and ‘Hero Promos’. The HN ‘Settings’ tab allows the user to select from three different animation styles between each hero nav promo, rendered when the end-user hovers over the navigation, including Vertical, Horizontal and Fade; Nav and Promo Alignment: Left and Right positions the navigation Left or Right; Nav and Promo Margin: On or Off allows the user to set the Top, Right, Bottom and Left Margins; Top and Bottom Nav Padding On and Off can be used to add additional padding to the Top and Bottom Margin. The user can also set the Nav Colors including Background, Nav Hover, Divider, Text and Hover Text. The Nav Colors can also be set in the Primary Navigation ‘Settings’ section. Under the ‘Hero Promo’ tab, the user can drag-and-drop the Hero Promos and/or the Hero Nav and Nav Promos 1 and 2 in any order by clicking and moving the Hero badge up or down, above or below each other.

Within each Hero badge, there are two tabs: ‘Nav Item’ and ‘Promo Image’ as seen in FIG. 23P. Under the ‘Nav Item’ tab, the user can select from the available Type Styles setup under Setting from the primary navigation including: Web Fonts, Google Fonts and Brand Fonts; Once the Type Style is selected, the user they can enter the desired hero navigation text into a text input with text tools and click the ‘Save Icon’ (a floppy disk) when the desired style is set and finished. The user can also change the case, including UPPERCASE, Title Case, lower case and Mixed case, and the user can set the Link, Target and Tag as described above in the ‘Hero Promos’ section.

Under the ‘Promo Image’ tab are the following settings: Image Size requirements dynamically listed per selected position, Image Upload, Image Map Upload, Link, Target, Video Animation Style and Google Tag. For Image Upload, in addition to dragging-and-dropping the image, the user can select ‘Choose File’ and navigate their desktop to select an image to upload, or the user can drag the image right from their desktop and drop the image on the ‘Choose File’ button. For Image Map Upload, the user can upload any image map, and the Campaign builder 10 will parse the image map code into a dynamic image map of links for usage with the associated Hero Promo. For the Link setting, the user can specify the base link for the Hero Promo that the user is taken to in response to a click. If the Hero Promo has both a Link and an Image Map, the Image Map Links will lie above the base link.

For Targets, the user can select _blank, _self, _parent, _custom, or the video insertion programs offered under the marks Video in the Box and Video Lightbox as shown, for instance, in FIG. 23S. Choosing _blank opens the linked document in a new window or tab. Choosing _self opens the linked document in the same frame as it was clicked. Choosing _parent opens the linked document in the parent frame, which is the default. Choosing _custom allows the user to apply custom target code. Choosing Video in the Box allows the user to place a video, such as a YouTube video, in the box with animation options that can occur between the Hero Promo and Video on click of the Hero Promo, such as No Animation, Fade, and Flip. The Video Lightbox option allows the user to place a video that plays in a Lightbox above the Hero Promo on click of the Hero Promo. When the user selects the Video Lightbox target, animation placements are available, animating the Lightbox from the selected direction to the center of the screen: Top Left, Top Center, Top Right, Left, Center, Right, Bottom Left, Bottom Center, and Bottom Right.

The Google Tag input leverages custom Google Event Code to track all click events. The user can define how the Link click will be named and forwarded to Google Analytics (i.e. ‘RR Web {2013-12-26 v4}2013-12-30 3:00 AM EST’). What the user names the Google Tag will show up between the { } brackets along with the RR Web declaration and the date and time.

As shown in FIG. 23Q, for instance, beneath the Hero Promos are the Hero Nav badges. The user can drag-and-drop the vertical order of the Navigation, Nav Promo 1 and Nav Promo 2. The user can turn them On and Off, such as by clicking a gray circle and turning it to green to signify it is on. The Nav Promo 1 and 2 have the same settings as the Hero Promos, with the addition of turning the Promo On or Off, the ability to add a hover image with hover animation options Fade and Flip and Hover Promo Opacity On and Off with a slider to select the Opacity amount. The user can also declare a Link as Internal and External. External links to External sites, and Internal Links provide the user the ability to Link to or Drive a Hero to animate to a specific Hero Promo Slide.

Looking to FIG. 23R, the screenshot of the user interface for the dynamic website Campaign builder 10 shows the Campaign Edit, Build Campaign Tab 88 with ‘Promotion Image, Link & Google Tag’ Tab opened. Single instance Promotions include one image with the option for a second image on end-user hover state image; they are not Heroes or Sliders that contain multiple promotions. When the user clicks on a single instance promotion, this tab is shown in the right pane toolbar and includes the following settings: Image Size requirements dynamically listed per selected position, Image Upload, Image Map Upload, Link, Target, Video Animation Style and Google Tag. For Image Upload, in addition to dragging-and-dropping the image, the user can select ‘Choose File’ and navigate their desktop to select an image to upload, or the user can drag the image right from their desktop and drop the image on the ‘Choose File’ button. For Image Map Upload, the user can upload any image map and the Campaign builder 10 can parse the image map code into a dynamic image map of links for usage with the associated Hero Promo. For the Link setting, the user can specify the base link for the Hero Promo that the user is taken to in response to a click. If the Hero Promo has both a Link and an Image Map, the Image Map Links will lie above the base link.

When the user interface for the dynamic website Campaign builder 10 is set to the Campaign Edit, Build Campaign Tab 88 with the ‘View Heroes’ opened as in FIG. 23S, the user can see all hero promotion slides at once that have been uploaded into the Hero Slider. The user can drag-and-drop the thumbnails of Hero Promos in any desired order. Beneath each Hero are the names and the links for each Hero Promo. If the user clicks on any of the thumbnails, the corresponding right pane tool bar badge opens with all of that Hero Promo's settings. Drag-and-dropping either the thumbnail or the badge in the right pane tool bar allows the user to rearrange the order of the promos and is reflected dynamically in both places. By clicking the ‘Back’ button at the bottom left of the screen, the user is taken back to the active ‘Build Campaign’ tab as discussed herein.

Looking further to FIGS. 23T and 23U, screenshots of a user interface for the dynamic website Campaign builder 10 show the Campaign Edit, Build Campaign Tab 88 with a ‘Responsive Design’ Template 82 selected for Campaign creation. The ‘Responsive Design’ template 82 can include all of the functionality described above. The Build Campaign Tab 88 can additionally include in ‘Responsive Design’ templates 82 the ability to allow the user to upload unique images per Responsive Design Campaign and device. The Campaign builder 10 allows users to upload unique images per each device size. Device sizes include Large Display, Default, Portrait Tablets, Phones to Tablets and Phones. Administrators can set which Devices are available and each Device's width and max width in the Settings/Responsive Design section described in relation to FIG. 18. All device widths can be set to unique widths per customer. When a user selects a Hero or Single Instance Promotion, it is highlighted, such as in green, and the right pane tool bar shows all settings per that promotion as documented above, potentially with the addition of sub-badges for each device image size. This sub-badge includes the same settings as the ‘Hero’ badge described above as well as the ‘Promotion Image, Link & Google Tag’ Tab also described above, but the additional sub-badge empowers the user to edit settings for each device image size individually. On each device sub-badge, the required image size is listed in pixels as W×H. The user can simply click the badge to open it and edit that device's settings.

When uploading a Hero Promo, by default, the user can simply upload the largest device size image and the Media Server of the Campaign builder 10 will construct all other device image sizes automatically. If any of the smaller device image sizes are not in proportion, the Campaign builder 10 alerts the user of the ratio difference, such as by making the device W×H green and bulleted on its badge as in FIG. 23U. The bullet can, for instance, be explained to the user as “* Denotes devices that require larger images than the default”. The Campaign builder 10 allows the user to upload an alternate image that is more readable for smaller devices by deleting the automatically generated image and uploading a new image to the device size. The Campaign builder 10 automatically displays the desired image to the correct size when an end-user browses the Campaign.

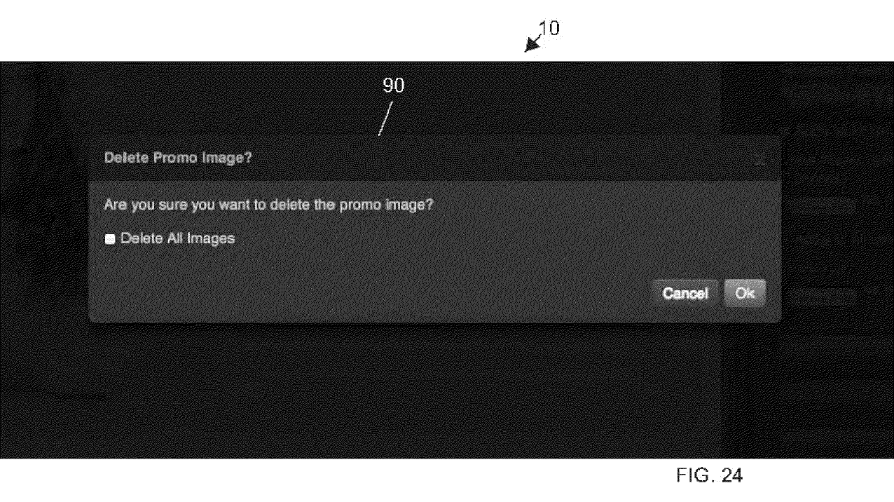

When deleting Hero Promos, users can be greeted with a delete popup 90 as in FIG. 24 asking them if the delete action should be applied to all device size images for that promotion they are deleting or just the promotion they clicked to delete. If the user selects Delete and ‘Apply to All’, all image sizes will be deleted. If they do not select ‘Apply to All’, only the image they clicked to delete, will be deleted.

The user can also change all of the above settings documented for Hero Promos when editing a Single Instance Promotion. In addition, they can also choose to ‘Apply to All’ when uploading or deleting a Promotion and, additionally or alternatively, an associated Hover Image. The Campaign builder 10 it will build all images on upload or delete all images if ‘Apply to All’ is checked.

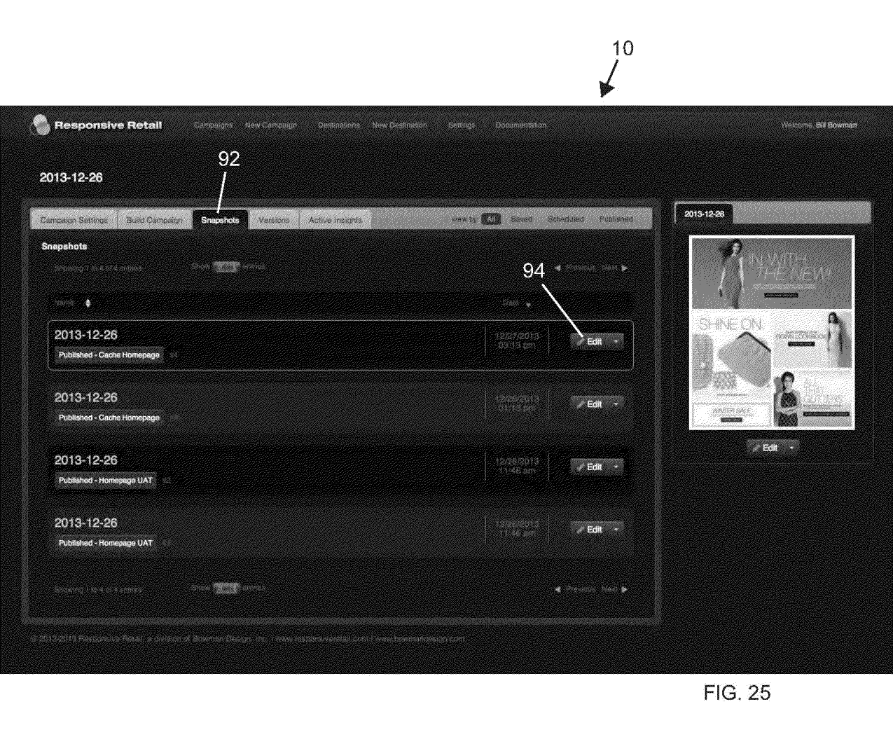

With reference to FIG. 25, a screenshot of a user interface for the dynamic website Campaign builder 10 shows the Campaign Edit, Snapshots Tab 92 selected. On the Snapshots tab 92, the user can see the total number of snapshots above the list of the Snapshots. Snapshots are saved iterations, or variations, of a given Campaign. Users can save unlimited numbers of Campaign Snapshots by clicking ‘Save Snapshot’ on the Build Campaign tab 88. When users publish a Campaign, both a Snapshot and Version are created. The default view can show five snapshots, while the user can select ten snapshots and click Previous or Next to paginate through all snapshots. The Snapshots list shows each Snapshot Name, Badge, Snapshot Number, Date and Time of creation and an ‘Edit’ button 94. The ‘Edit’ button 94 can include the following functionality via dropdown: ‘Edit’, ‘Preview’, ‘Get Code’ (shown if the Snapshot was Published), ‘Publish’, and ‘Delete’. ‘Edit’ restores the snapshot to the Build Campaign tab for further editing. ‘Preview’ allows the user to preview a live dynamic version of both Fixed Width and Responsive Design Campaigns where users can check the accuracy of their set links and targets. The Campaign builder 10 dynamically converts all links in ‘Preview’ to open in another tab from Preview, so the user can verify link accuracy and not leave the application.

When the Campaign is published, links are dynamically restored to the user's set targets. The Campaign builder 10 constantly maintains dual link states, one for Preview and one for Published Campaigns. ‘Get Code’ provides the Campaign builder 10 Destination script, allowing the user to copy and place it into their desired website platform for viewing Campaigns published to it as well as the Destination Link and the View Destination Link button. ‘Publish’ allows the user to publish any Snapshot at any time, including an instant publish or scheduled publish. ‘Delete’ allows the user to delete the Snapshot. To the right of the Snapshot list is a thumbnail of the selected Snapshot that is outlined, such as in green. The thumbnail is also clickable to see a live preview of the Snapshot. Beneath the thumbnail is the same ‘Edit’ button as in the list of Snapshots.

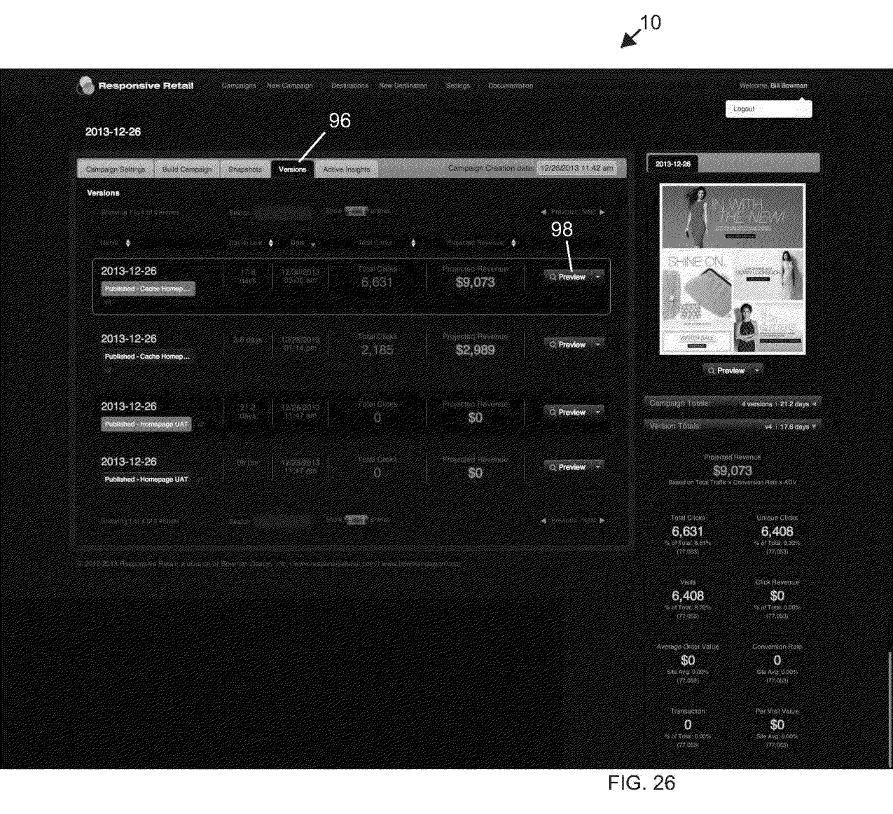

A screenshot of a user interface for the dynamic website Campaign builder 10 showing the Campaign Edit, Versions Tab 96 is shown in FIG. 26. The Versions tab 96 allows the user to quickly see which Campaign Versions are published to which Destinations as well as which Campaign Versions are performing the best by earning the most end-user clicks and by projected revenue. Users can track, sort, and compare Versions without the cost or complexity of A/B split testing. Users can simply sort by the top performing Campaign Versions. Users can quickly see the published status of the Versions by, for instance, an indication in the form of the color of its badge. By way of example, a gray badge could mean that the Campaign is not actively published to a Destination while a green badge can mean that the Campaign is actively and currently published to a Destination. The Versions tab 96 includes the same pagination tools as the Snapshots tab 92, with the additions of ‘Search’. ‘Search’ is predictive and allows the user to start typing what they are looking for, and the Campaign builder 10 will instantly show results. The pagination tools live above and below the Versions list, exactly like the Snapshots tab 92.

Each Version in the list can, for example, include the following: Version Name, Publish status badge, Days Live, Date and Time, Total Clicks and Projected Revenue as well as a ‘Preview’ button 98. Within the ‘Preview’ button 98, a dropdown, shown on hover, contains ‘Preview’, ‘Get Code’, ‘Restore’ and ‘Delete’. ‘Preview’, ‘Get Code’, ‘Delete’ and ‘Restore’ allowing the user to perform the same functions to Versions as previously described above relative to Snapshots. In addition, ‘Restore’ allows the user to restore a previously published Version to an active editable state within the Build Campaign tab, which allows the user to make changes to it, and then publish, save or save a snapshot of the new iteration. When a version is selected, it can be visually indicated, such as by being outlined in green. In the right pane tool bar, the Campaign name is shown in the tab with a clickable preview thumbnail shown along with the same ‘Preview’ dropdown button as in the list and Campaign Totals and Version Totals below it. By default, the most recent Version is selected in the list on load of the Versions tab. As the user hovers over other versions in the list, the visual indication, such as a green outline, remains on the selected Version while the green outline follows the user's mouse hover movements over other Versions in the list.

The user can view any Versions Campaign Totals or Version Totals in the right pane tool bar by clicking the Version in the Versions list. The Campaign builder 10 insights are custom coded, such as in the form of Google Events, and also pushed and tracked into an Analytics program, such as Google Analytics. Projected Revenue is derived by Total clicks multiplied by Conversion Rate multiplied by Average Order Value. While Campaigns totals tabulate all Versions within a single Campaign, Version Totals show only the latest Version's Totals. Campaign and Version Totals shown in the right pane tool bar include the following insights: Projected Revenue, Total Clicks with % of Total and Total, Unique Clicks with % of Total and Total with % of Total and Total, Visits with % of Total and Total, Click Revenue with % of Total and Total, Average Order Value with Site Average and Total, Conversion Rate with Site Average and Total, Transaction with Site Average and Total and Per Visit Value with Site Average and Total. On the right side of the Campaign Totals badge, the user can see the total number of versions in that Campaign and the total days the Campaign was live. On the Version Totals badge, the user can see the Version number, such as in the form of v1, v2, . . . vn, and the total days live for that version only.

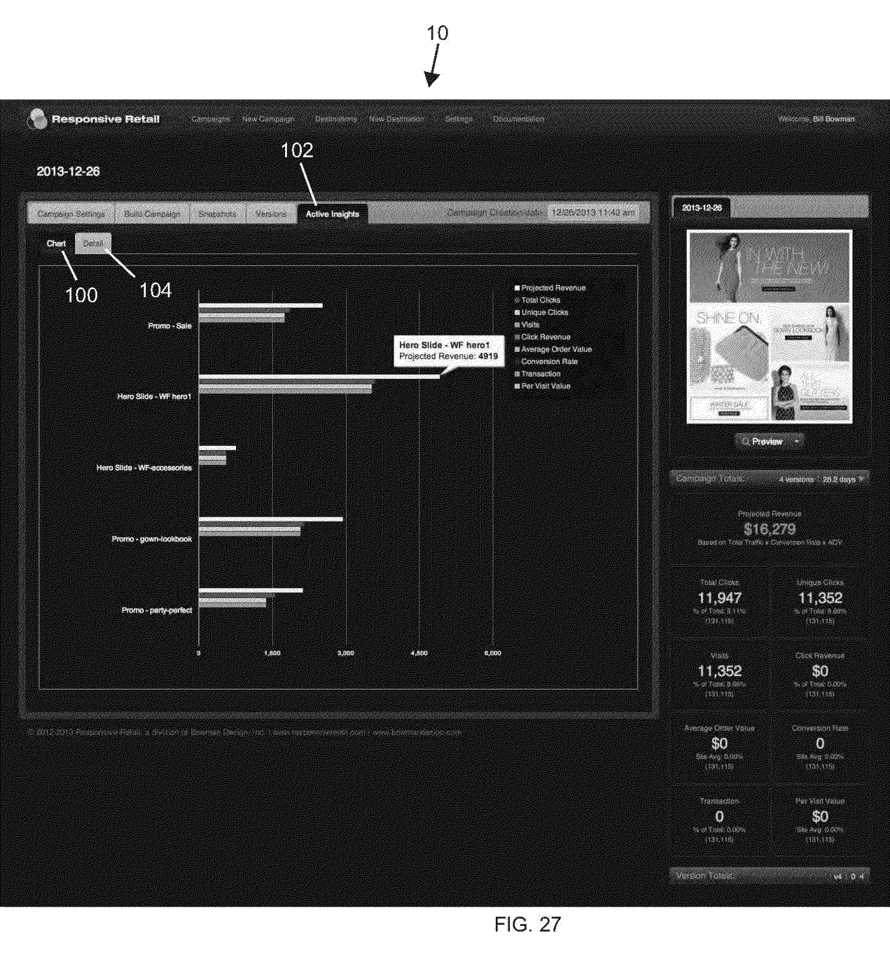

Looking to FIG. 27, one sees a screenshot of a user interface for the dynamic website Campaign builder 10 showing the Campaign Edit, Chart Tab 100 under the Active Insights Tab 102. The Active Insights tab 102 includes two tabs, the Chart Tab 100 and a Detail Tab 104. The Chart tab 100 includes a bar chart of the active Campaign Version's Projected Revenue, Total Clicks, Unique Clicks, Visits, Click Revenue, Average Order Value, Conversion Rate, Transaction and Per Visit Value. The user can hover over the different bars in the chart and the Campaign builder 10 shows the name/Google Tag of the position, the data field, such as Projected Revenue, and total. To the left of the chart, the Campaign builder 10 shows the name of the position derived from the Tag, such as a Google Tab, promotion name the user applied and saved to the Campaign using the Campaign builder 10 interface. Next to the chart is the persistent and clickable Campaign thumbnail preview, the ‘Preview’ button along with the Campaign Totals and Version Totals.

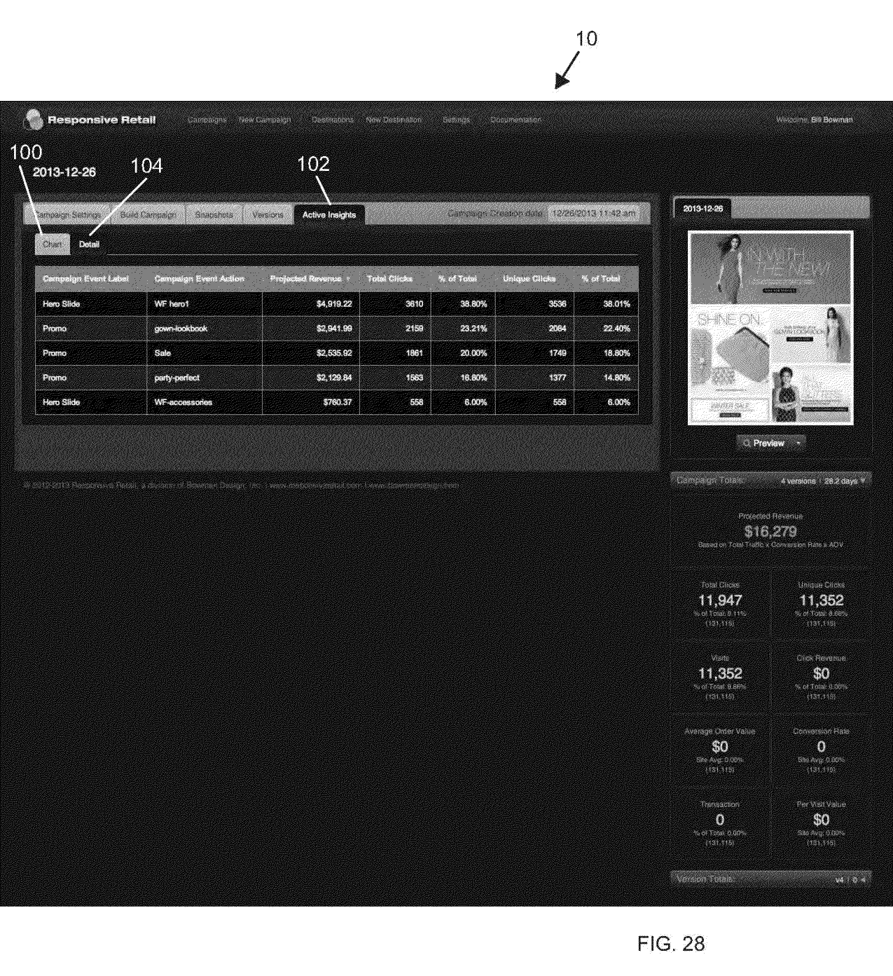

A screenshot of a user interface for the dynamic website Campaign builder 10 showing the Campaign Edit, Detail Tab 104 under the Active Insights Tab 102 is shown in FIG. 28. The Table shows the same data from the chart in FIG. 27, namely, Projected Revenue, Total Clicks, Unique Clicks, Visits, Click Revenue, Average Order Value, Conversion Rate, Transaction, and Per Visit Value as a sortable table. The user can click any header item and sort that associated column by ascending on the first click or descending by the second click while sorting the complete data set in the table is sorted. The Campaign builder 10 shows the name of the position as ‘Campaign Event Action’, which is derived from the Tag promotion name the user applied and saved to the Campaign using the Campaign builder 10 interface. Next to the table is the persistent and clickable Campaign thumbnail preview, the ‘Preview’ button, and the Campaign Totals and Version Totals.

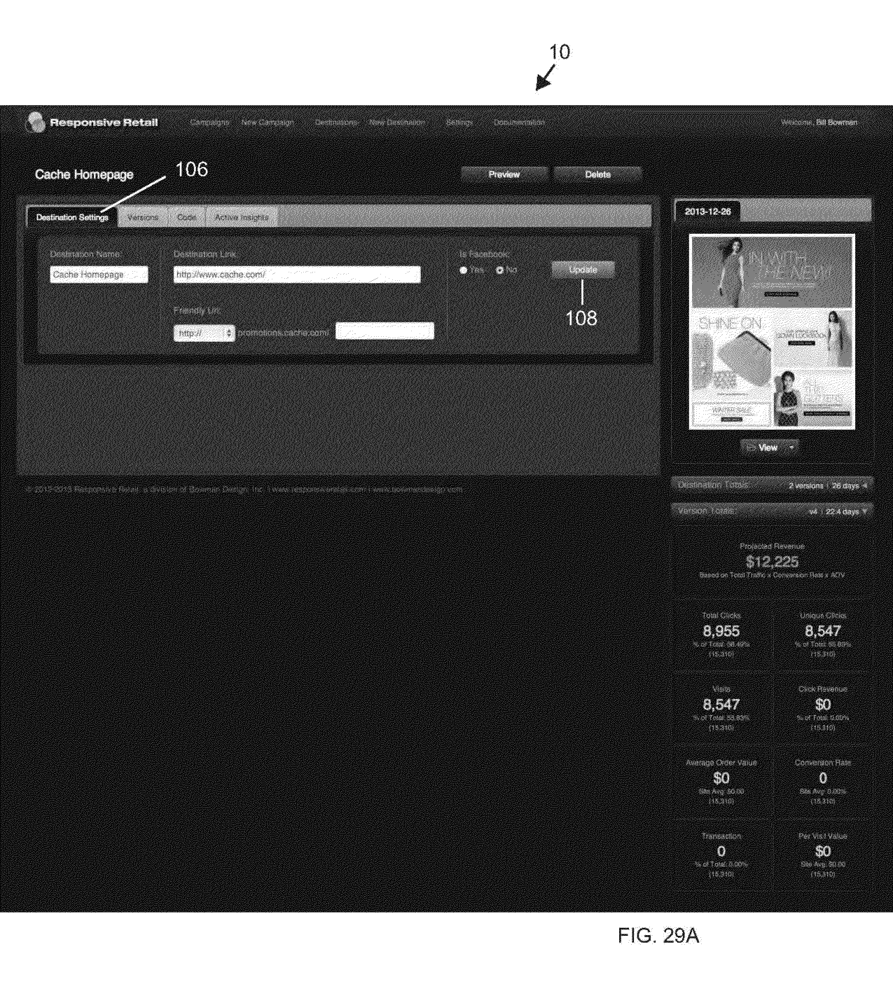

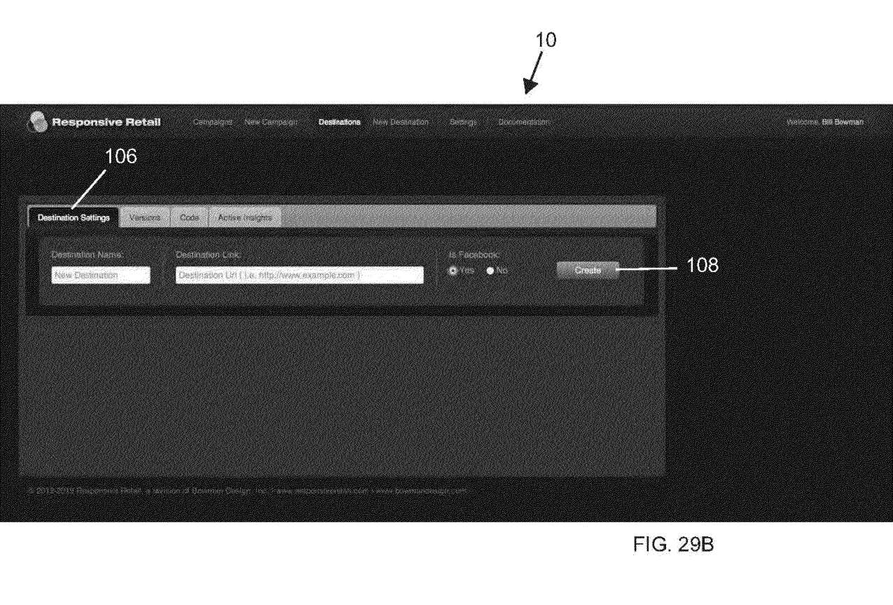

By reference to FIGS. 29A and 29B, one can perceive two screenshots of a user interface for the dynamic website Campaign builder 10 showing the Destinations Settings Tab 106 screen. The user can get to the Destinations Settings tab 106 in two ways, namely by clicking ‘New Destination’ 20 in the primary navigation 12 as shown, for example, in FIG. 3 or by clicking view Destination in the Destination Category on an existing Destination. The Destination Settings Tab 106 allows the user to set the Destinations Name, Destination Link, HTTP or HTTPS Friendly URL and whether the Destination is a social media Destination, such as a Facebook Destination, or not. The Destination Name can be anything the user wants, like Homepage, Category, Landing Page, or any other name. The Destination Link is the URL to which the script produced hereunder is directed within the user's website. A Friendly URL is for a standalone Destination, separate from the user's website. Friendly URLs are considered Microsites. When a user selects ‘Yes’ that the Destination is a Facebook Destination, the Campaign builder 10 writes a unique Destination placement script for Facebook as an HTTPS secure connection. Friendly URLs are not offered if the user selects ‘Yes’ that the Destination is a Facebook campaign.

When creating the Destination for the first time, a ‘Create’ button 108 can be pressed to save the Destination Settings as in FIG. 29B. There is no ‘Preview’ or ‘Delete’ button while creating a Destination. As shown in FIG. 29A, when the user clicks the ‘View’ button of an existing Destination on the Destination Category page, the user can edit the Destination Settings and ‘Preview’ and ‘Delete’ buttons are available to the user. The ‘Create’ button 108 becomes the ‘Update’ button 108 when editing the Destination. If the user is editing or viewing an existing Destination, in the right pane tool bar there is the Destination name, a clickable preview thumbnail, and a ‘View’ button along with Destination Totals and Version Totals shown exactly like Campaign and Version totals explained above. The Destination Totals badge shows the number of versions and the total days live, and the Version Totals show the version number and the total days live of the latest version published to that Destination. Both the Destination Totals and Version Totals include the following insights: Projected Revenue, Total Clicks with % of Total and Total, Unique Clicks with % of Total and Total with % of Total and Total, Visits with % of Total and Total, Click Revenue with % of Total and Total, Average Order Value with Site Average and Total, Conversion Rate with Site Average and Total, Transaction with Site Average and Total and Per Visit Value with Site Average and Total.

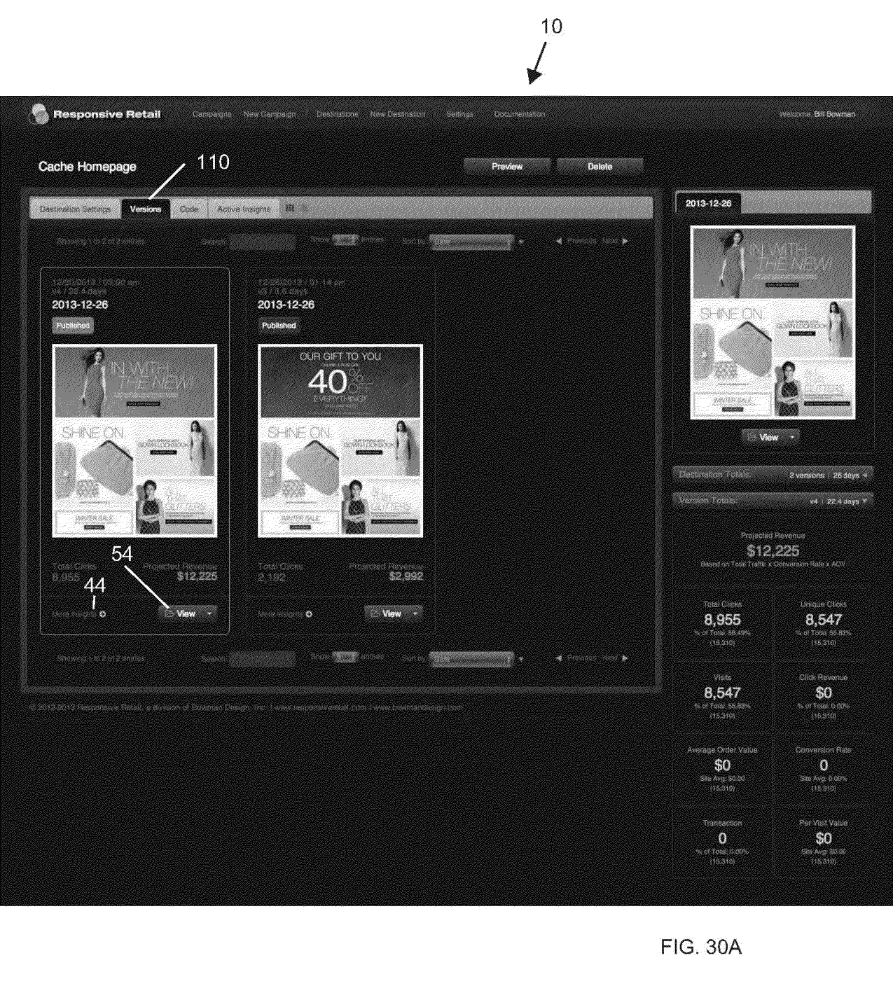

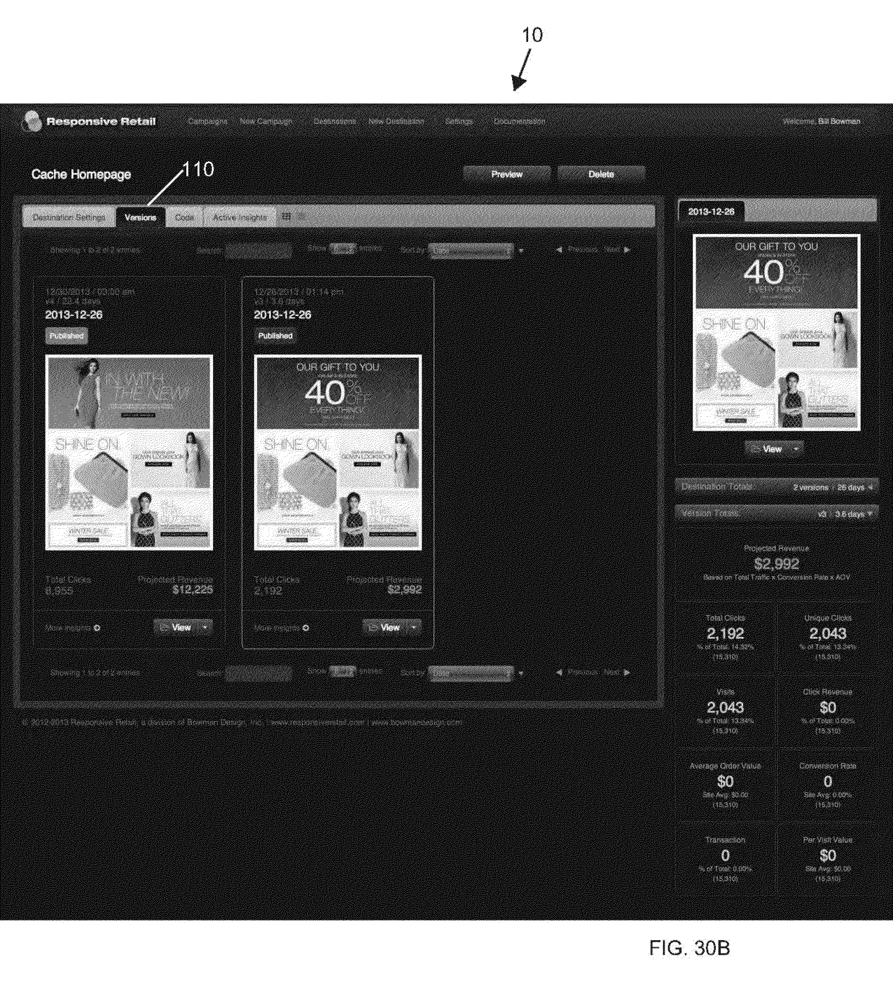

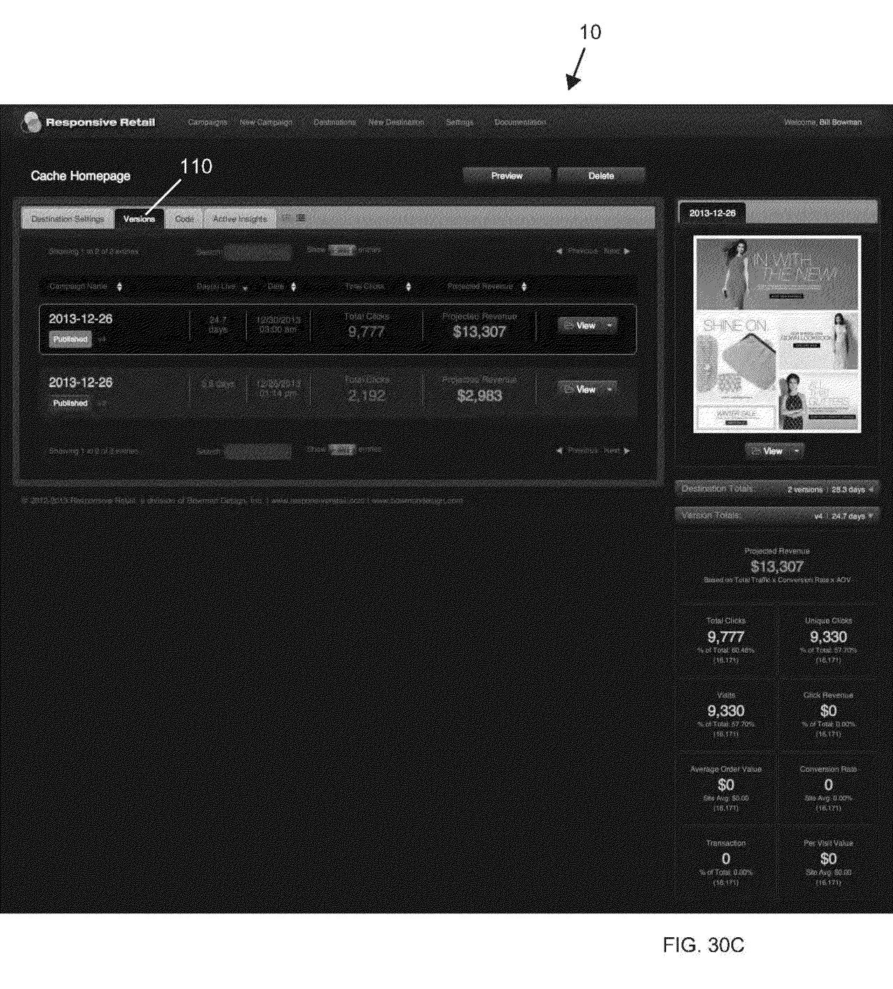

FIG. 30A through 30C comprise screenshots of a user interface for the dynamic website Campaign builder 10 showing the screen operative under the Destinations Versions Tab 110. The Destinations Versions tab 110 screen shows the user all Versions published to that Destination. The Destination Versions tab 110 has a grid view and a list view, with the default view being the grid view. On load of the Versions tab 110, the Versions are sorted by most recently published. Above and below both the grid and list view are the same pagination tool bars including number of versions published to the Destination, Search, Show 3, 6, 18 or All, Sort by Date, Days Live and Campaign Name; as well as Previous and Next pagination through all Campaigns published to the Destination. The grid shows preview thumbnails of each Campaign Version published to the Destination, the date and time it was published, the version number, the number of days live, the Campaign name, and the publish badge status.

As shown in FIG. 30A, for instance, beneath the thumbnail preview shows the Total Clicks and Projected Revenue of that Campaign Version, along with a ‘More Insights’ button 44 and a ‘View’ button 54. The ‘More Insights’ button 44 shows the user additional details in the right pane tool bar about the Campaign Version, including Campaign Version Name, Preview Thumbnail, ‘View’ Button, Destination Totals and Version Totals. The ‘View’ button 54 includes the following dropdown with other button links: ‘View’, ‘Preview’, ‘Get Code’ and ‘Remove. ‘View’ takes the user to the actual Campaign Edit and Build Campaign Tab. ‘Preview’ is a dynamic and live preview of the Campaign. ‘Get Code’ shows the Destination Script, Destination Link and View Destination button. The Destination Script is what the user would copy and paste into their website to publish Campaigns to it. The Destination Link is the link to the placed Destination within the user's website, and the ‘View Destination’ button launches the Destination Link in another tab when clicked by the user. ‘Remove’ removes the Campaign version from the Destination.

If the user removes a Campaign that is actively published to the Destination, the Campaign builder 10 will prompt the user to replace the current active Campaign as described above. Like the Campaign Totals and Version Totals described above, Destination Totals and Versions Totals are the same, only totaling all Versions published to the Destination, in Destination Totals, while Version Totals shows the latest Campaign Version published to that Destination. The Destination Totals badge show the number of version and days live to the right of the badge, and Version Totals shows the version number and the days live to the right of its badge. Clicking either badge expands or contracts the badge. The insights included in both are Projected Revenue, Total Clicks with % of Total and Total, Unique Clicks with % of Total and Total with % of Total and Total, Visits with % of Total and Total, Click Revenue with % of Total and Total, Average Order Value with Site Average and Total, Conversion Rate with Site Average and Total, Transaction with Site Average and Total and Per Visit Value with Site Average and Total.

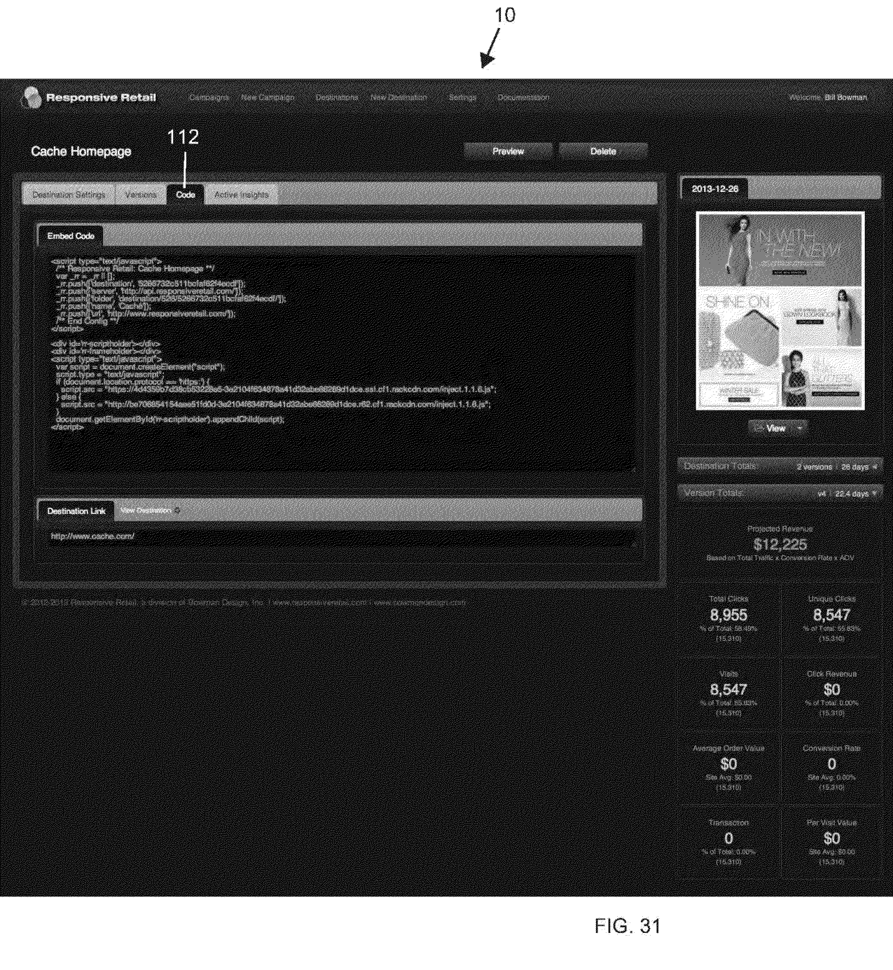

A screenshot of a user interface for the dynamic website Campaign builder 10 showing the screen operative under the Destinations Code Tab 112 is depicted in FIG. 31. The ‘Get Code’ tab shows the Destination Script, Destination Link and View Destination button. The Destination Script is what the user would copy and paste into their website to publish Campaigns to it. The Destination Link is the link to the placed Destination within the user's website, and the ‘View Destination’ button launches the Destination Link in another tab when clicked by the user. The right pane tool bar persists on the Get Code tab 112 showing the latest Campaign published to the Destination, a clicking thumbnail preview showing a dynamic and live preview of the campaign, the ‘View’ button, containing ‘View’, ‘Preview’, ‘Get Code’ and ‘Remove’ functions as well as Destination Totals and Version Totals.

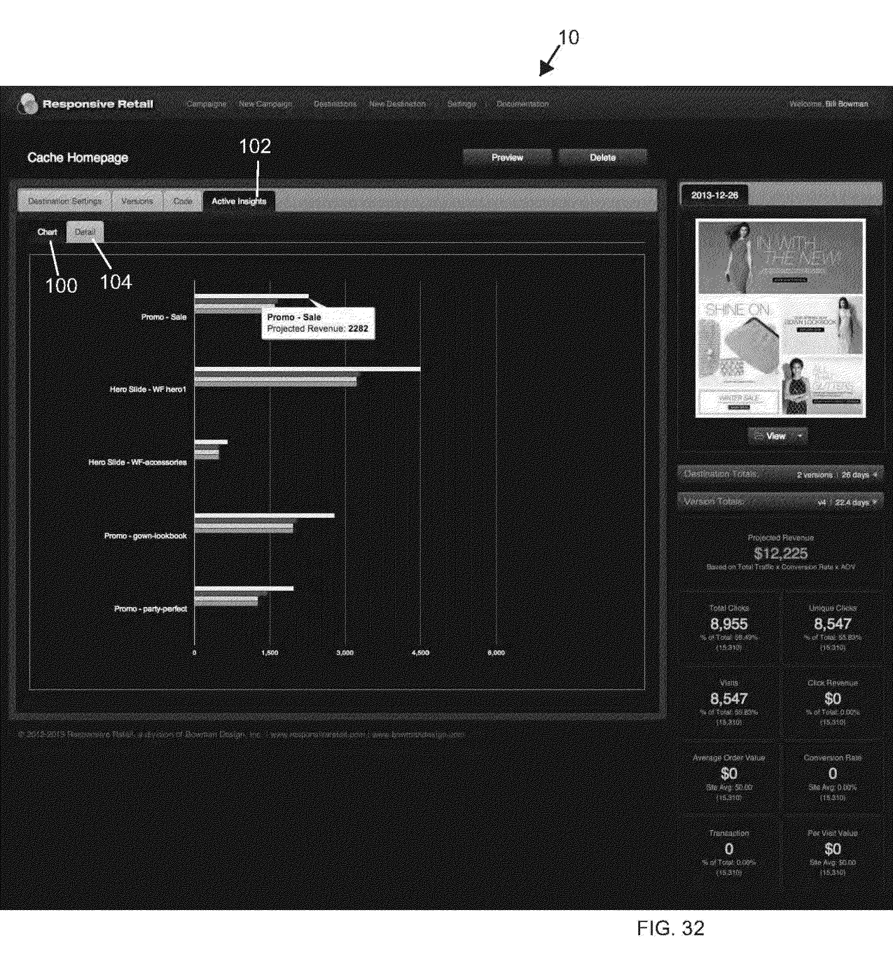

Looking to FIG. 32, a further screenshot of a user interface for the dynamic website Campaign builder 10 showing the Destination's Chart Tab 100 under the Active Insights Tab 102. The Active Insights tab 102 has the Chart Tab 100 and a Detail Tab 104. The Chart tab 100 shows the Destination's actively published Campaign Version in a bar chart, showing Projected Revenue, Total Clicks, Unique Clicks, Visits, Click Revenue, Average Order Value, Conversion Rate, Transaction and Per Visit Value. The user can hover, and the Campaign builder 10 shows the name of the position, the data field, such as Projected Revenue, and total. To the left of the chart, the Campaign builder 10 shows the name of the position derived from the Tag promotion name, such as the Google Tag promotion name, the user applied and saved to the Campaign using the Campaign builder 10 interface. Next to the chart is the persistent and clickable Campaign thumbnail preview, the ‘Preview’ button, and the Campaign Totals and Version Totals.

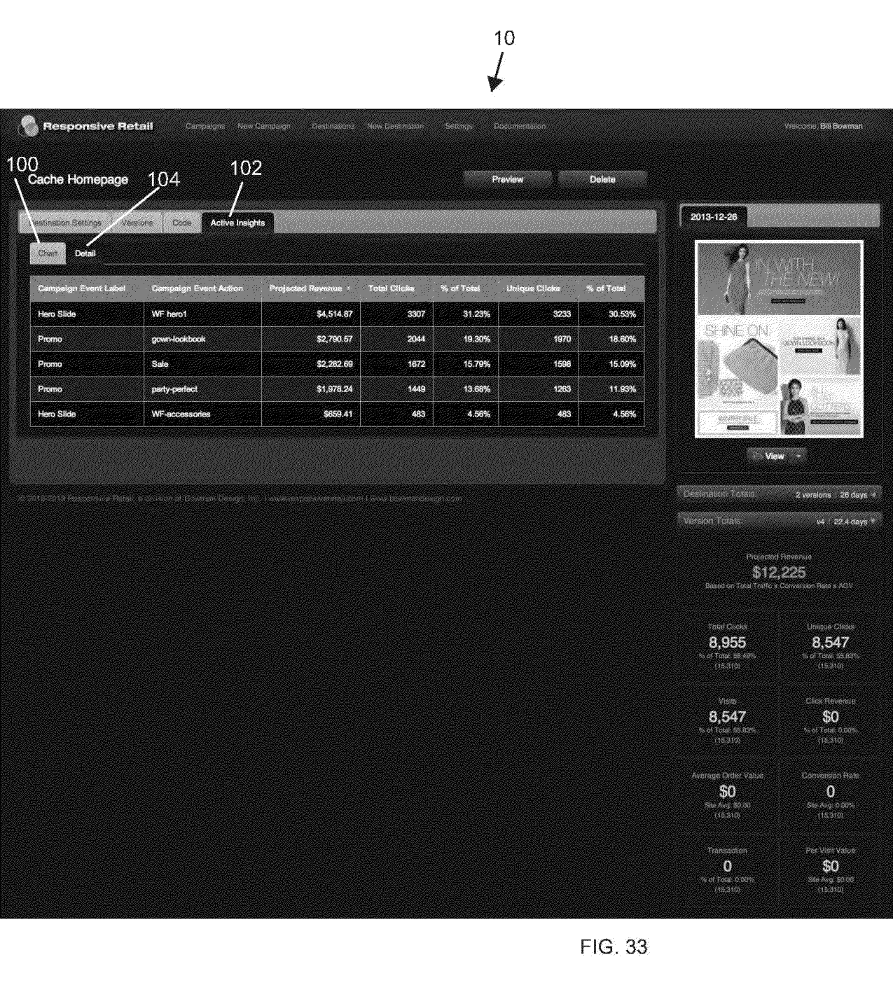

As shown in FIG. 33, the user interface for the dynamic website Campaign builder 10 showing the Destination's, Detail Tab 104 under the Active Insights Tab 102. The Detail Tab 104 provides a Table showing the same data from the chart in FIG. 32, namely, Projected Revenue, Total Clicks, Unique Clicks, Visits, Click Revenue, Average Order Value, Conversion Rate, Transaction, and Per Visit Value as a sortable table. The user can click any header item and sort that associated column by ascending on a first click or descending by a second click while sorting the complete data set in the table. The Campaign builder 10 shows the name of the position as ‘Campaign Event Action’, derived from the Google Tag promotion name the user applied and saved to the Campaign using the Campaign builder 10 interface. Next to the table is the persistent and clickable Campaign thumbnail preview, the ‘Preview’ button, and the Campaign Totals and Version Totals.

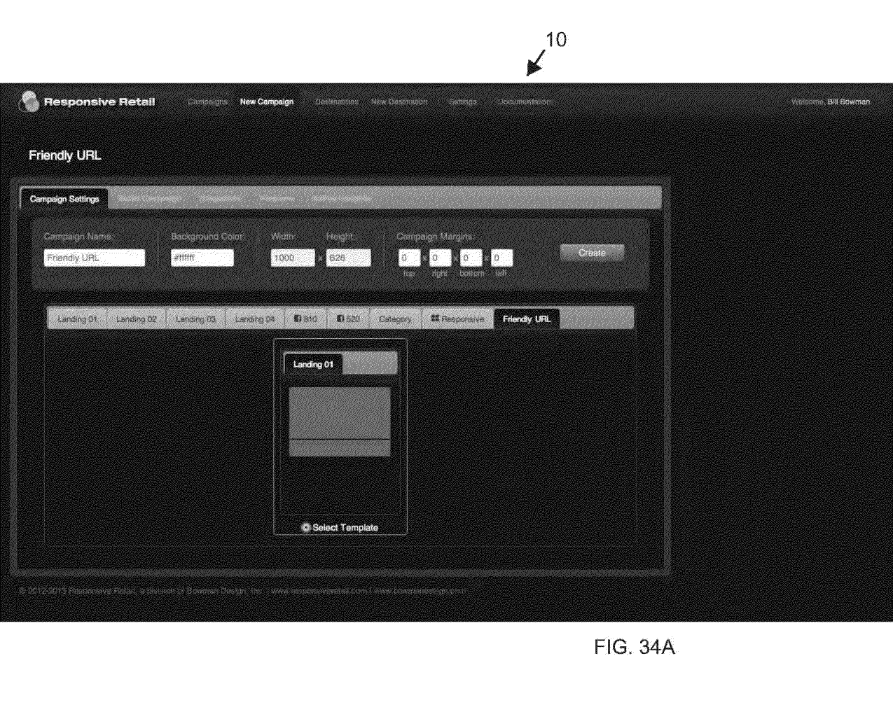

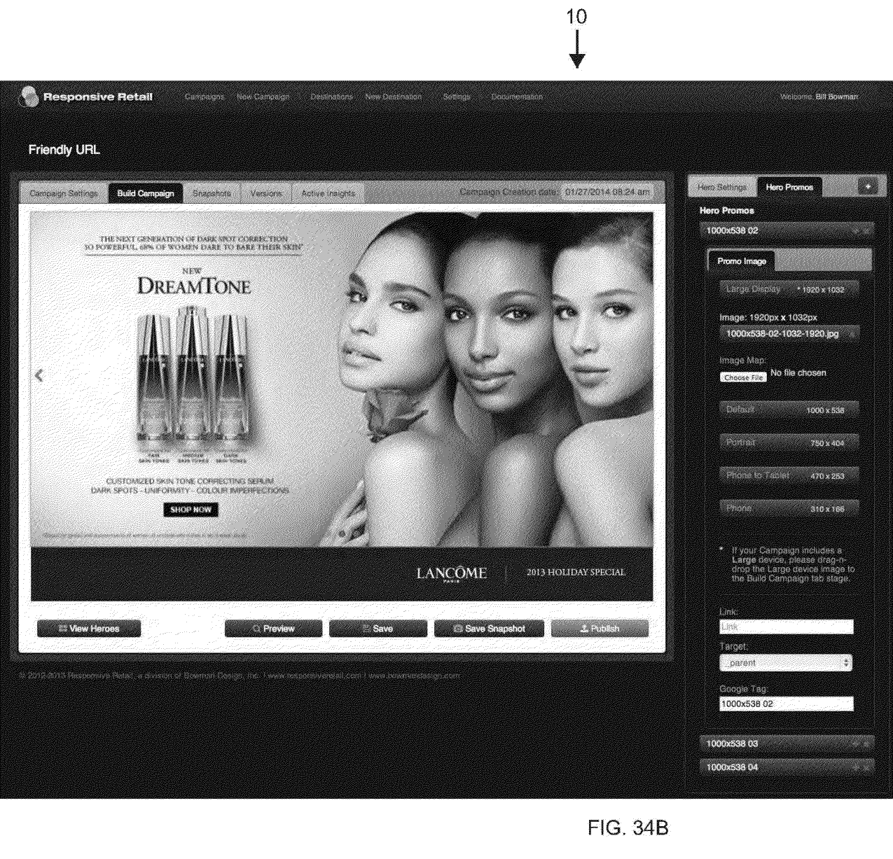

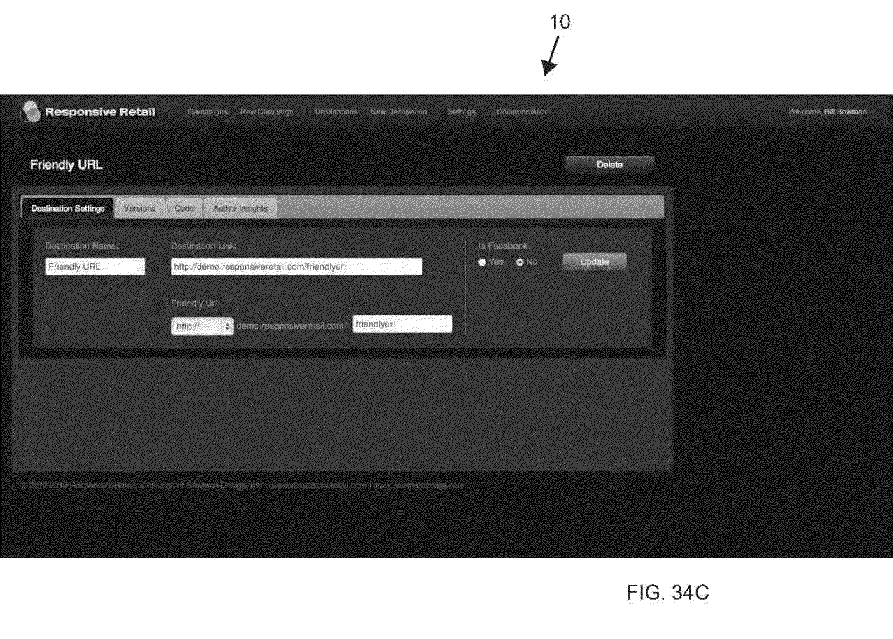

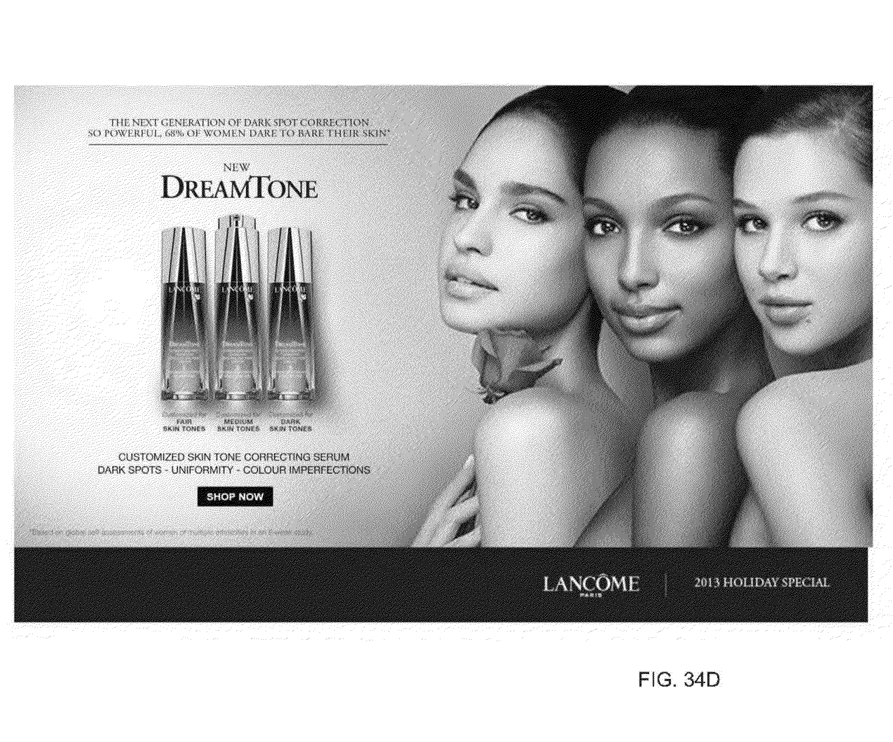

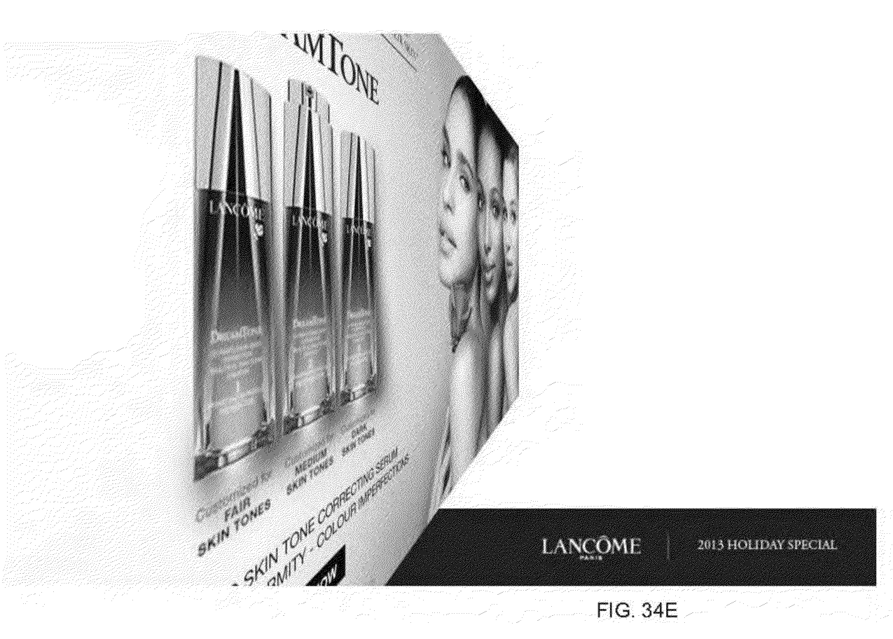

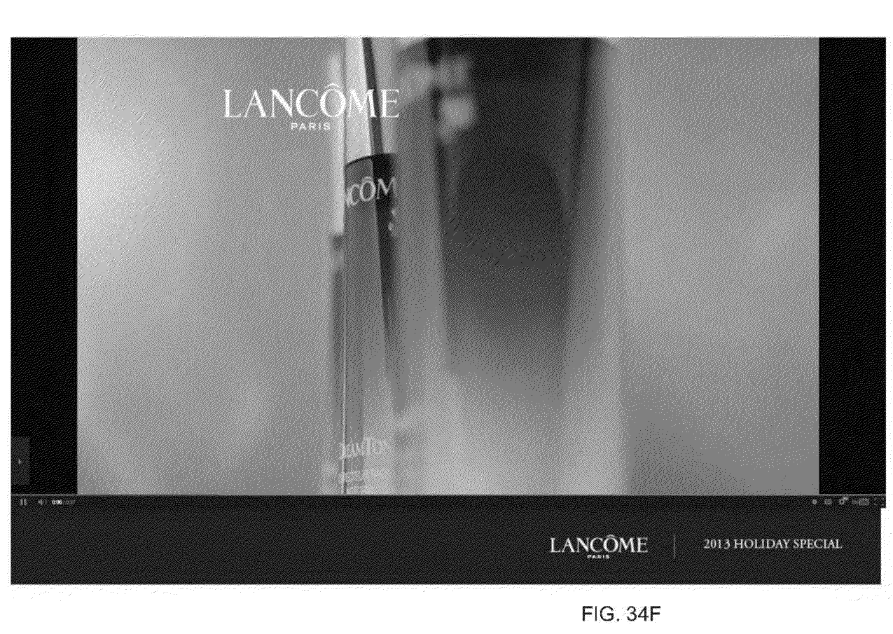

FIGS. 34A through 34F provide screenshots of an application programming user interface and a recipient user interface as would appear on recipient computing devices 19, 21, 23, and 25 for the dynamic website Campaign builder 10 showing a Friendly URL template, Campaign and Destination. A Friendly URL Campaign Destination is a standalone microsite with its own unique URL created by the user. Friendly URLs are Responsive Design templates that include the following device sizes: Large Display, Default, Portrait, Phone to Tablet and Phone. Friendly URLs include all functionality as documented above, including Campaign and Destination tracking end-user insights pushed to an Analytics program as described herein.

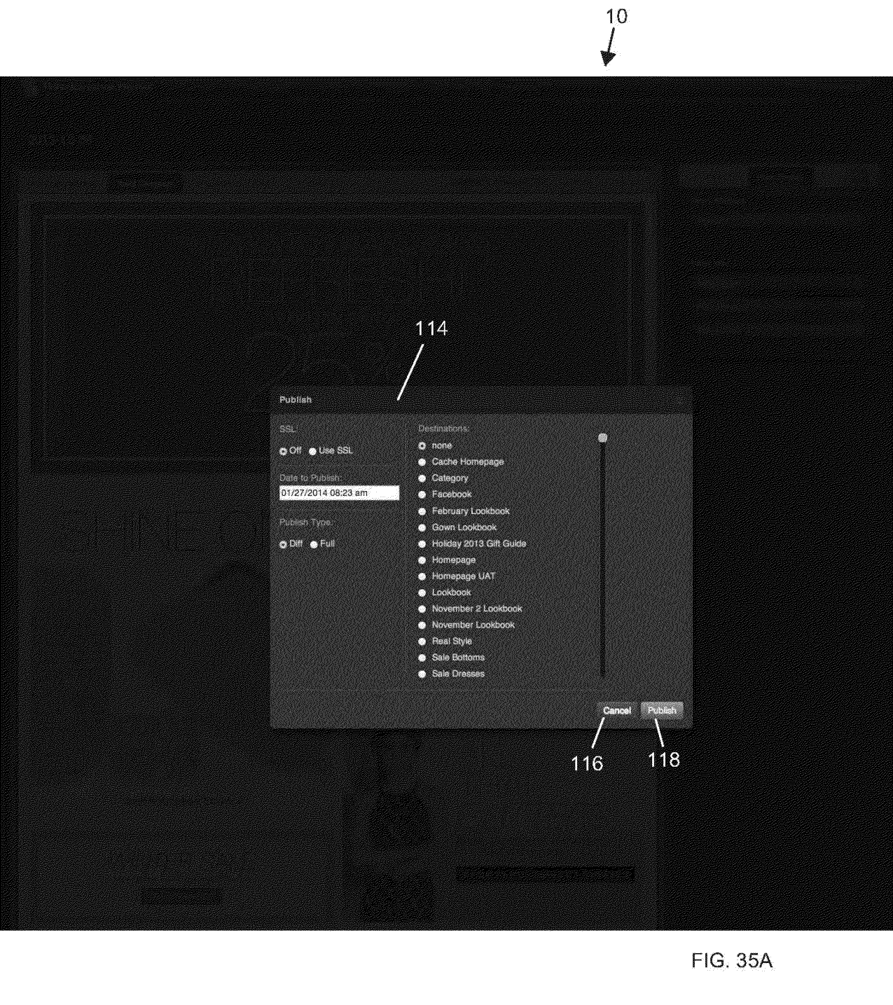

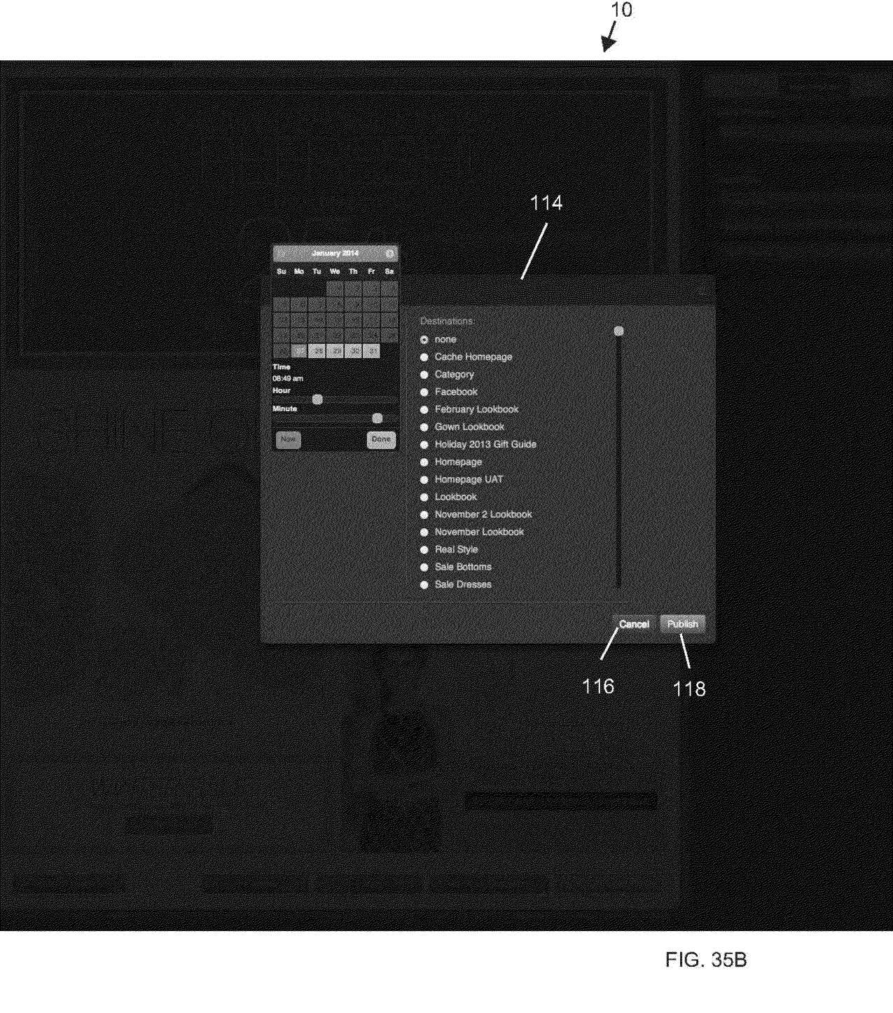

Turning to FIGS. 35A and 35B, one sees screenshots of a user interface for the dynamic website Campaign builder 10 showing the Publish popup 114. The Publish popup 114 is opened whenever the user clicks any ‘Publish’ button from within Campaign builder 10, including in the Campaign Edit tab, Build Campaign tab and the Snapshots tab. Once clicked, it launches and allows the user to Select SSL Off or Use SSL, Select the Publish Date and Time of the Campaign Version, Render a Differential or Full Publish Type and select from a list of available Destinations or ‘None’ for an iFrame. The user can cancel the Publish action by clicking the ‘Cancel’ button 116 or click the ‘Publish’ button 118 to publish the Campaign Version with the selected settings. SSL allows the user to set the Campaign versions URL to a secure HTTPS Campaign or a non-secure standard Campaign version, HTTP. SSL Off is the default on load of the Publish Popup 114.

The Date and Time options are dynamic and when clicked, a Date and Time Calendar and Slider interface is opened. Here the user can schedule the exact time to publish the Version immediately or schedule to publish in the future. The Campaign builder 10 allows for unlimited time publishing of multiple Campaign Snapshots and Versions. The ‘Now’ button selects the current Date and Time, while the Calendar lets the user select a date in the future and the Hour and Minute Sliders allow the user to select any time. ‘Done’ closes the Date and Time interface. Publish Type offers two types of publishing, Differential and Full. A Differential or ‘diff’ publish type is the default. Differential publish only publishes the needed assets, so when a Campaign is being re-published the ‘diff’ publish only uploads new or changed files to the Media Cloud server. It does not upload unchanged base and core files. A ‘Full’ publish forces all files to be re-uploaded, which happens by default for all new Campaigns. The Destinations list allows the user to publish the Campaign Version to any of the available Destinations created by the user. The Destination list also offers a ‘None’ option, which allows the user to publish the Campaign Version to a simple iFrame, changing the Destination Script to a simple iFrame. The vertical Slider to the right of the Destinations list allows the user to scroll through a possibly long list of Destinations.

With certain details and embodiments of the present invention for a dynamic website Campaign builder disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims are employed to protect this invention and define the scope of protection to be afforded to the inventor. Those claims shall be deemed to include equivalent constructions insofar as they do not depart from the spirit and scope of the invention. It must be further noted that a plurality of the following claims may express certain elements as means for performing a specific function, at times without the recital of structure or material. As the law demands, any such claims shall be construed to cover not only the corresponding structure and material expressly described in this specification but also all equivalents thereof.

I claim as deserving the protection of Letters Patent:

1. Dynamic website Campaign builder software for enabling merchandising via the Internet, the Campaign builder software comprising:
an application programming interface for display on programming computing devices with a display screen to permit building of a Campaign by use of the programming computing devices;
at least one Campaign template retained in electronic memory;
an insertion mechanism operative by use of the application programming interface to permit insertion of assets into the Campaign template to create a Campaign;
a saving mechanism operative by use of the application programming interface to permit selective saving of Campaigns in electronic memory;
a publishing mechanism operative by use of the application programming interface to permit selective publication of Campaigns;
a recipient user interface operative on recipient computing devices with display screens wherein the recipient user interface can be displayed on the recipient computing devices to permit viewing and usage of published Campaigns.

2. The Campaign builder software of claim 1 wherein the insertion mechanism comprises a Destination Script.

3. The Campaign builder software of claim 1 wherein the insertion mechanism comprises an inline frame (iFrame).

4. The Campaign builder software of claim 1 wherein at least portions of Campaigns are saved to electronic cloud storage in response to selective saving by operation of the saving mechanism.

5. The Campaign builder software of claim 4 wherein the electronic cloud storage comprises a content delivery network (CDN) Media Cloud Server for rapid content delivery network (CDN) publishing.

6. The Campaign builder software of claim 1 further comprising a linking mechanism operative by use of the application programming interface to permit a linking of Campaigns to an Analytic program for harvesting and analysis of user interaction and Ecommerce data.

7. The Campaign builder software of claim 6 further comprising an insights mechanism operative by use of the application programming interface to permit review, analysis, and action upon the user interaction and Ecommerce data.

8. The Campaign builder software of claim 6 wherein the user interaction and Ecommerce data comprises Total Clicks and Projected Revenue.

9. The Campaign builder software of claim 8 wherein the user interaction and Ecommerce data further comprises Total Clicks with % of Total and Total, Unique Clicks with % of Total and Total with % of Total and Total, Visits with % of Total and Total, Click Revenue with % of Total and Total, Average Order Value with Site Average and Total, and Conversion Rate with Site Average and Total.

10. The Campaign builder software of claim 1 wherein the publishing mechanism permits users to select from immediate publication or time-delayed publication.

11. The Campaign builder software of claim 1 further comprising a destination selection mechanism that is operative by use of the application programming interface to permit a selection of destinations for Campaigns wherein possible destinations include home pages, landing pages, and social media site tabs.

12. The Campaign builder software of claim 1 wherein a plurality of Campaign templates are retained in electronic memory.

13. The Campaign builder software of claim 12 wherein the Campaign templates comprise JavaScript Object Notation (JSON) files that declare position placements, width and height, and whether the template is a fixed width or a responsive design template.

14. The Campaign builder software of claim 12 wherein the publishing mechanism permits Campaign templates to publish selectively as fixed width or responsive design campaigns wherein the responsive design campaigns permit content management of unique images per size of recipient computer device.

15. The Campaign builder software of claim 14 wherein the responsive design campaigns permit content management of unique images per size of recipient computer device chosen from the group consisting of large displays, default displays, portrait tablets, phones to tablets, and phones.

16. The Campaign builder software of claim 12 wherein the Campaign templates have Positions of retained assets comprising Heroes with Hero sliders and Promotions without sliders.

17. The Campaign builder software of claim 12 wherein the Campaign templates have digital wireframe technology that dynamically defines sizes within the Campaign template.

18. The Campaign builder software of claim 17 wherein the insertion mechanism includes insertion options for images, image maps, links, and videos.

19. The Campaign builder software of claim 1 wherein the saving mechanism permits selective saving of multiple Snapshots of Campaigns and multiple Versions of Campaigns.

20. The Campaign builder software of claim 1 wherein a plurality of Campaign templates are retained in electronic memory and wherein Campaign templates can be selectively previewed.

21. The Campaign builder software of claim 20 wherein each Campaign template provides a visual indication of whether the Campaign template has been published.

22. The Campaign builder software of claim 21 further comprising a code retrieval mechanism for each published Campaign template.
